(19) United States
(12) Patent Application Publication
(10) Pub. No.: US 2014/0058812 A1
(43) Pub. Date: Feb. 27, 2014

(54) SYSTEM AND METHOD FOR INTERACTIVE MOBILE ADS

(71) Applicant: Augme Technologies, Inc., New York, NY (US)

(72) Inventors: Douglas F. Bender, Scotts Valley, CA (US); Mark D. Baker, Marietta, GA (US); Joshua S. Paugh, Tucson, AZ (US); Nathaniel T. Bradley, Tucson, AZ (US); Jim G. Crawford, Fall City, WA (US)

(73) Assignee: Augme Technologies, Inc., New York, NY (US)

(21) Appl. No.: 13/969,750

(22) Filed: Aug. 19, 2013

Related U.S. Application Data
(60) Provisional application No. 61/684,451, filed on Aug. 17, 2012.

(51) Int. Cl. G06Q 30/02

(52) U.S. Cl. CPC G06Q 30/0209; G06Q 30/0267
USPC 705/14.12

(57) ABSTRACT

Methods and systems are provided herein for an interactive mobile advertisement, which incentivizes the user to interact with the advertisement. The interactive mobile advertisement may have a game-like format suitable for mobile platforms. The interactive mobile advertisement has a game-like format wherein a user is prompted to find a specified object within the advertisement/game environment. The specified object may be a special coupon or promotion offered by the advertiser. The object is hidden within the game and the user is prompted to find it.

### CROSS-REFERENCE TO RELATED APPLICATIONS

The present application claims priority to U.S. Provisional Application Ser. No. 61/684,451, filed Aug. 17, 2012, which is hereby incorporated in its entirety by reference.

The present invention is related to co-pending, commonly assigned U.S. Patent Application Publication No. US 2011/0264527A (the '527 Published Application), which is hereby incorporated in its entirety by reference.

The present invention is related to co-pending, commonly assigned U.S. patent application Ser. No. 13/763,450, filed Feb. 8, 2013, which is hereby incorporated in its entirety by reference.

The present invention is related to co-pending, commonly assigned U.S. patent application Ser. No. 13/790,786, filed Mar. 8, 2013, which is hereby incorporated in its entirety by reference.

### BACKGROUND OF THE INVENTION

The present invention relates generally to systems and methods for sending messages or information to a user and more specifically, the present invention relates to sending messages or information to a user in an interactive mobile advertisement environment.

2-D environments are the computer-based generation of digital images—mostly from two-dimensional models (such as 2D geometric models, text, and digital images). Virtual reality is a computer-simulated environment that can simulate physical presence in places in the real world, as well as in imaginary worlds. Most current virtual reality environments are primarily visual experiences, displayed either on a computer screen or through special stereoscopic displays, but some simulations include additional sensory information, such as sound through speakers or headphones. Some advanced, haptic systems now include tactile information, generally known as force feedback, in medical and gaming applications.

The simplest form of virtual reality is a 3-D image that can be explored interactively at a personal computer, televisions, or digital device, usually by manipulating keys or the mouse so that the content of the image moves in some direction or zooms in or out. More sophisticated efforts involve such approaches as wrap-around display screens, actual rooms augmented with wearable computers, and haptics devices that let you feel the display images.

Virtual reality can be divided into: (1) The simulation of a real environment for training and education; and (2) the development of an imagined environment for a game or interactive story. Popular products for creating virtual reality effects on personal computers include Bryce, Extreme 3D, Ray Dream Studio, trueSpace, 3D Studio MAX, and Visual Reality. The Virtual Reality Modelling Language (VRML) allows the creator to specify images and the rules for their display and interaction using textual language statements.

Augmented reality (AR) is a live, direct or indirect, view of a physical, real-world environment whose elements are augmented by computer-generated sensory input such as sound, video, graphics or GPS data. It is related to a more general concept called mediated reality, in which a view of reality is modified (possibly even diminished rather than augmented) by a computer. As a result, the technology functions by enhancing one's current perception of reality.

Most mobile advertisements do not effectively incentivize users to interact with the advertisement. In most advertisement instances, mobile or not, the viewer simply ignores the ad. The present invention attempts to overcome these problems.

### SUMMARY OF THE INVENTION

Methods and systems are provided herein for an interactive mobile advertisement, which incentivizes the user to interact with the advertisement. The interactive mobile advertisement may have a game-like format suitable for mobile platforms.

In one embodiment, the interactive mobile advertisement has a game-like format wherein a user is prompted to find a specified object within the advertisement/game environment. In one embodiment, the specified object may be a special coupon or promotion offered by the advertiser. The object is hidden within the game and the user is prompted to find it.

In an alternative embodiment, the specified object unlocks a “badge” or other signifier that may be shared on a social network, such as Twitter, Facebook, LinkedIn, and/or the like.

In another embodiment, the interactive mobile advertisement has a game-like format which comprises multiple levels. In some embodiments, each successive level progresses in difficulty. The addition of levels to the interactive mobile advertisement may incentivize users to commit additional time to interaction with the advertisement, increasing the effectiveness of the advertisement. One example, without limitation, of a game-like format having levels is a dungeon-crawler type game, wherein each additional level is longer and/or harder than the previous level. In another example, without limitation, the game-like format having levels may be a trivia game, wherein each additional level or round prompts the user to respond to a more difficult question.

As an example of one embodiment of the interactive mobile advertisement having levels, completion of a first level could unlock a badge to be shared on a social network, completion of a second level could unlock a promotional code or coupon for free shipping or a free sample of a product from the advertiser, and completion of a third level could unlock a promotional code or coupon for a percentage off of the user's next purchase from the advertiser, and/or the like. Alternative progressions of the unlocked “rewards” or “achievements” is anticipated by this invention, and are within the scope of this disclosure. Similarly, different numbers of completed levels may be required to unlock any of the rewards or achievements for the user. Generally, any tiered incentive system may be implemented.

In one embodiment, a plurality of rewards may be delivered to the user, based upon the number of levels completed by the user.

Alternatively, the interactive mobile advertisement may incorporate a competition aspect, resulting in an enhanced reward or achievement to one or more users who have the “best” outcomes from “playing” the advertisement. This could be implemented by having users submit their results at the conclusion of the “game,” along with their contact information, and maintaining a high score list of submitted results. At the end of a specified period (such as an hour, day, week, month, and/or the like), one or more of the top results may be selected to receive an enhanced reward or achievement. The enhanced reward or achievement may be a promotion or coupon having a greater value than those offered for generally interacting with the advertisement, or could be promotions or coupons beyond the scope of those from general interaction (such as gift cards, promotional credit vouchers, etc.). Alternatively, the enhanced achievement could be a “badge” sharable via social networks that highlights a user's accomplishments, such as having the high score of the day, week, month, etc.

In one embodiment, the methods and systems utilize a game emulator to reduce the memory needed for secondary downloads during interaction by a user with the interactive mobile advertisement.

In one embodiment, the interactive mobile advertisement may be incorporated into a web page viewed by the user via a digital device, mobile or not. In another embodiment, the interactive mobile advertisement may be incorporated into other content that is delivered to the user, such as an email, a text message, an instant message, a multimedia message, etc.

The methods and systems allow users to interact with the interactive mobile advertisement environment, and receive information from the environment. The advertisement environment can be a 3-D environment, a 3-D virtual reality environment, or a 2-D environment. In a preferred embodiment, the environment is compatible with a mobile communication device. A user can interact with the advertisement environment using their mobile communication device, and then receive promotions or coupons after interacting with the advertisement, or “game”. The interaction is communicated to a data repository or server, which acts upon the interaction, and returns a reply response to the user's mobile communication device. In an alternative embodiment, the interactive advertisement is compatible with a non-mobile communication device, such as a desktop computer or a laptop computer, rather than a mobile device such as a smartphone, tablet, etc.

In some embodiments, the interaction is coupled with a variety of other information prior to communication to a data repository. This information may include, without limitation, a user ID, a hardware ID, a geocode, a timestamp, a subject code, a source code, a content code, and/or an advertisement environment code. A user ID may uniquely identify the user within the data repository, and relate to a user-created profile within the repository. The user's digital device may also provide a hardware ID, which would identify the capabilities and nature of the digital device to the repository. The digital device may further be capable of generating or connecting a geocode with the interaction. The geocode could be based upon location information collected from a variety of sources. The digital device could include a GPS system, capable of outputting the user's current and/or past physical location. Alternatively, in some embodiments where the digital device is a smartphone, a connected wireless network may allow triangulation of the user's current and/or past location(s). Similarly a timestamp may be associated with interaction. Code components may also be connected to the interaction, providing a subject code supplying context for the interaction, a source code indicating where the interaction was located, and/or a content code indicating any particular response that the user desires. An environment code may also be attached to the interaction, indicating the type of advertisement environment, which may impact the response generated by the data repository.

The interaction is then communicated to a data repository. The data repository receives and processes the interaction. In some embodiments, the data repository is a code triggered information server (“CTIS”) database. The CTIS database may, depending on the particular implementation of the embodiments, communicate with a third party provider's server or database. Through processing, the repository interprets the interaction and compares it against the database. After analysis and comparison, the repository generates a response that addresses the interaction. This response is then communicated from the repository to the user's digital device. The response is then available for utilization by the user.

There exist numerous methods through which data may be communicated between the user's digital device and the data repository. In some embodiments, communication is achieved through the Short Messaging Service (“SMS”) protocol. Alternatively, without limitation, communication could be achieved by Multimedia Messaging Service (“MMS”) protocol, instant messaging, web browser based messaging, email, Enhanced Messaging System (“EMS”), TCP/IP, WAP, and/or the like. The communication protocol employed will depend on the particular elements and purposes of the relevant embodiments.

As used herein the term “artifact” is intended to include, without limitation, products, activities, services, print, visual, electronic or audible media, barcodes, brand names, product configurations, including, for example, packaging or container configurations, shapes or color combinations for products (e.g., pharmaceutical capsule color coding or pill shapes), video, body movements or gestures, olfactory scents, haptic or tactile stimuli, sound stimuli, and gustatory or taste stimuli.

### BRIEF DESCRIPTION OF THE DRAWINGS

The accompanying appendices and/or drawings illustrate various non-limiting, example, inventive aspects in accordance with the present disclosure:

FIG. 1a shows a combined logic and data flow block diagram illustrating a general overview of one embodiment of a Code Triggered Information Server (CTIS) for implementing interactive advertisement environments; FIGS. 1b-c show combined logic and data flow block diagrams illustrating a general overview of embodiments of a Code Triggered Information Server (CTIS) for processing code scans and providing interactive advertisement environments to a user;

FIG. 2 shows a particular, exemplary embodiment of the GCSI/CTIS, wherein a game-like interactive advertisement environment (hidden object type) is presented to the user, and a reward coupon is sent to the user upon successful interaction with the game-like environment;

FIG. 3A shows user trajectories through a network of 3^{rd} party provider zones, and FIG. 3B shows user/avatar trajectories through a 3-D VR environment and 3^{rd} party provider zones;

FIG. 4 shows an embodiment of the web interface for user registration;

FIGS. 5a-c show three types of 2D barcodes that may be employed within the CTIS and logic flow for code enhancement in one embodiment of CTIS operation; FIG. 5d shows an implementation of logic flow for customized repair and/or decoding of obscure or ambiguous scanned codes;

FIG. 6a shows an illustration of one embodiment of the Outcome Message data structure; FIG. 6b shows an illustration of one embodiment of the Scan Message data structure;

FIGS. 7a-b shows an illustration of one embodiment of a user profile data structure and an implementation of a user profile user interface in one embodiment of GCSI/CTIS operation

FIG. 8a shows an illustration of one embodiment of the Information Base (Reward) data structure; FIG. 8b shows an illustration of one embodiment of the Information Base (Environment) data structure;

FIG. 9 shows a logic flow diagram of one embodiment of the user profile query heuristic, for selecting rewards;

FIG. 10 shows an exemplary histogram of 3^{rd} party provider zone breaches;

FIGS. 11a-d show some embodiments of systems for selecting non-triggered ad environments to serve to users;

FIGS. 12a-b show examples of coupons provided by the CTIS;

FIG. 13 shows a computer systemization of the CTIS;

FIG. 14 shows an implementation of a user interface manifesting GCSI/CTIS functionality on a portable electronic device in one embodiment of GCSI/CTIS operation;

FIG. 15 shows an implementation of a user interface manifesting GCSI/CTIS functionality on digital paper in one embodiment of GCSI/CTIS operation;

FIG. 16 shows an implementation of a user interface manifesting GCSI functionality on a digital billboard in one embodiment of GCSI/CTIS operation;

FIG. 17 shows a computer systemization of the GCSI/CTIS;

FIG. 18 shows an implementation of a user interface manifesting GCSI/CTIS functionality on a portable electronic device in one embodiment of GCSI/CTIS operation;

FIGS. 19a-e show aspects of implementations of JagTag encoding and codes in some embodiments of GCSI/CTIS operation;

FIG. 20 shows an implementation of a user interface manifesting GCSI/CTIS functionality on a portable communication device in one embodiment of GCSI/CTIS operation;

FIG. 21a is a block diagram illustrating a CTIS configured to assign users having similar interests and situation information into dynamic groups according to an embodiment; and FIG. 21b is a block diagram illustrating a CTIS configured to identify profile elements that are related to specific content according to an embodiment.

### DETAILED DESCRIPTION OF THE INVENTION

### Definitions & Terminology

### Servers, Computers, Clients, Networks, Routers

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

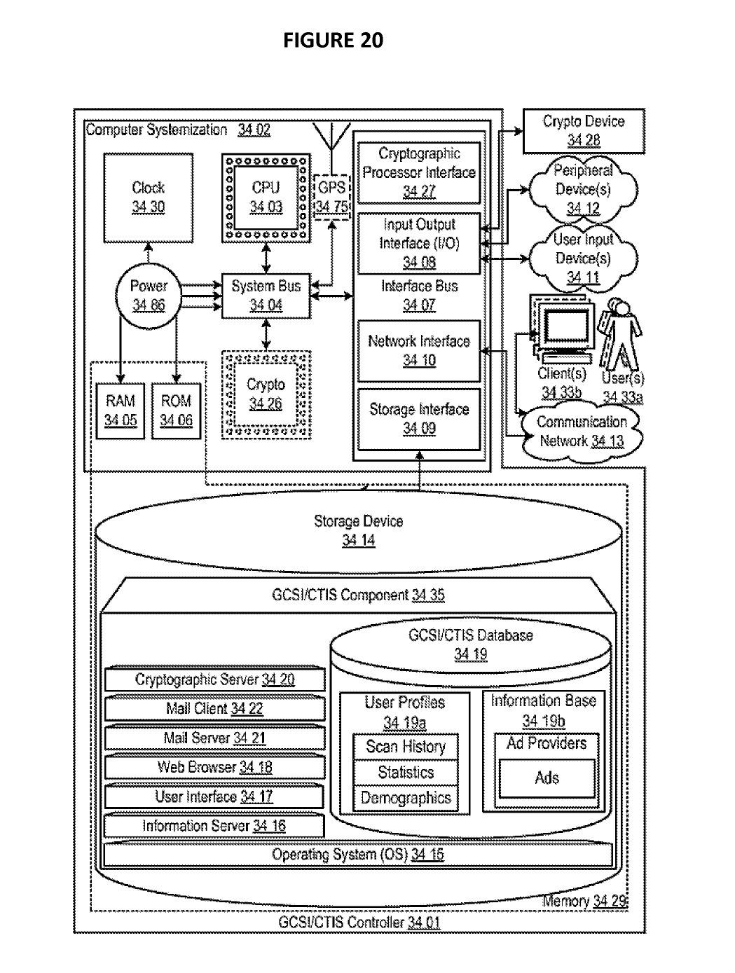

In one embodiment, the code triggered information server controller 3401 may be connected to and/or communicate with entities such as, but not limited to: one or more users from user input devices 3411; peripheral devices 3412; a cryptographic processor device 3428; and/or a communications network 3413, as shown in FIG. 20.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The code triggered information server controller 3401 may be based on common computer systems that may comprise, but are not limited to, components such as: a computer systemization 3402 connected to memory 3429.

### Computer Systemization

A computer systemization 3402 may comprise a clock 3430, central processing unit (CPU) 3403, a read only memory (ROM) 3406, a random access memory (RAM) 3405, and/or an interface bus 3407, and most frequently, although not necessarily, are all interconnected and/or communicating through a system bus 3404, as shown in FIG. 20. Optionally, the computer systemization may be connected to an internal power source 3486. Optionally, a cryptographic processor 3426 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the code triggered information server controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

### Power Source

The power source 3486 may be of any standard form for powering small electronic circuit board devices such as the following power cells: alkaline, lithium hydride, lithium ion, lithium polymer, nickel cadmium, solar cells, and/or the like, as shown in FIG. 20. Other types of AC or DC power sources may be used as well. In the case of solar cells, in one embodiment, the case provides an aperture through which the solar cell may capture photonic energy. The power cell 2486 is connected to at least one of the interconnected subsequent components of the code triggered information server thereby providing an electric current to all subsequent components. In one example, the power source 3486 is connected to the system bus component 3404. In an alternative embodiment, an outside power source 3486 is provided through a connection across the I/O 3408 interface. For example, a USB and/or IEEE 1394 connection carries both data and power across the connection and is therefore a suitable source of power.

### Interface Adapters

Interface bus(ses) 3407 may accept, connect, and/or communicate to a number of interface adapters, conventionally although not necessarily in the form of adapter cards, such as but not limited to: input output interfaces (I/O) 3408, storage interfaces 3409, network interfaces 3410, and/or the like, as shown in FIG. 20. Optionally, cryptographic processor interfaces 3427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 3409 may accept, communicate, and/or connect to a number of storage devices such as, but not limited to: storage devices 3414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 3410 may accept, communicate, and/or connect to a communications network 3413. Through a communications network 2413, the code triggered information server controller is accessible through remote clients 3433b (e.g., computers with web browsers) by users 3433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 3410 may be used to engage with various communications network types 3413. For example, multiple network interfaces may be employed to allow for the communication over broadcast, multicast, and/or unicast networks.

Input Output interfaces (I/O) 3408 may accept, communicate, and/or connect to user input devices 3411, peripheral devices 3412, cryptographic processor devices 3428, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 3411 may be card readers, dongles, finger print readers, gloves, graphics tablets, joysticks, keyboards, mouse (mice), remote controls, retina readers, trackballs, trackpads, and/or the like.

Peripheral devices 3412 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the code triggered information server controller may be embodied as an embedded, dedicated, and/or monitor-less (i.e., headless) device, wherein access would be provided over a network interface connection.

Cryptographic units such as, but not limited to, microcontrollers, processors 3426, interfaces 3427, and/or devices 3428 may be attached, and/or communicate with the code triggered information server controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

### Memory

Generally, any mechanization and/or embodiment allowing a processor to affect the storage and/or retrieval of information is regarded as memory 3429, as shown in FIG. 20. However, memory is a fungible technology and resource, thus, any number of memory embodiments may be employed in lieu of or in concert with one another. It is to be understood that the code triggered information server controller and/or a computer systemization may employ various forms of memory 3429. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 3429 will include ROM 2406, RAM 2405, and a storage device 3414. A storage device 3414 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

### Component Collection

The memory 3429 may contain a collection of program and/or database components and/or data such as, but not limited to: operating system component(s) 3415 (operating system); information server component(s) 3416 (information server); user interface component(s) 3417 (user interface); Web browser component(s) 3418 (Web browser); database(s) 3419; mail server component(s) 3421; mail client component(s) 3422; cryptographic server component(s) 3420 (cryptographic server); the code triggered information server component(s) 3435; and/or the like (i.e., collectively a component collection), as shown in FIG. 20. These components may be stored and accessed from the storage devices and/or from storage devices accessible through an interface bus. Although non-conventional program components such as those in the component collection, typically, are stored in a local storage device 3414, they may also be loaded and/or stored in memory such as: peripheral devices, RAM, remote storage facilities through a communications network, ROM, various forms of memory, and/or the like.

### Operating System

The operating system component 3415 is an executable program component facilitating the operation of the code triggered information server controller, as shown in FIG. 20. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the code triggered information server controller to communicate with other entities through a communications network 2413. Various communication protocols may be used by the code triggered information server system controller as a subcarrier transport mechanism for interaction, such as, but not limited to: multicast, TCP/IP, UDP, unicast, and/or the like.

The operating system component 3015 may also be a mobile operating system, mobile OS, such as iOS (Apple), ANDROID, WINDOWS PHONE (Microsoft), WINDOWS PHONE 7 (Microsoft), BLACKBERRY OS (RIM), WebOS (Hewlett-Packard), MEEGO or SYMBIAN, for example. The mobile OS may be a manufacture-built proprietary operating system, a third party proprietary, or an open source operating system. Mobile OS's are employed on a wide variety of mobile devices useful with the embodiments disclosed herein, such as smartphones and tablet computers, and the like.

### Information Server

An information server component 3416 is a stored program component that is executed by a CPU, as shown in FIG. 20. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the code triggered information server controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the code triggered information server database 3419, operating systems, other program components, user interfaces, Web browsers, and/or the like.

Access to the code triggered information server database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the code triggered information server. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the code triggered information server as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua or Lion, Microsoft's Windows XP, Windows 7 or Unix's X-Windows provide a baseline and means of accessing and displaying information graphically to users. Mobile OS's, discussed above, also typically employ GUIs, but may also be text-based, and provide user interfaces to mobile devices.

A user interface component 3017, whether on a desktop or laptop computing device or a mobile device, is a stored program component that is executed by a CPU, as shown in FIG. 20. The user interface may be a conventional graphic user interface as provided by, with, and/or atop operating systems and/or operating environments such as those operating systems discussed above, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 3418 is a stored program component that is executed by a CPU, as shown in FIG. 20. The Web browser may be a conventional hypertext viewing application such as Microsoft Internet Explorer or Netscape Navigator. Secure Web browsing may be supplied with 128-bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the code triggered information server enabled nodes. The combined application may be nugatory on systems employing standard Web browsers.

### Mail Server

A mail server component 3421 is a stored program component that is executed by a CPU 3403, as shown in FIG. 20. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the code triggered information server.

Access to the code triggered information server mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 3422 is a stored program component that is executed by a CPU 2403 or a web-based mail client, as shown in FIG. 20. The mail client may be a conventional mail viewing application such as Apple Mail, Microsoft Entourage, Microsoft Outlook, Microsoft Outlook Express, Mozilla Thunderbird, Gmail, Hotmail and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 3420 is a stored program component that is executed by a CPU 3403, cryptographic processor 3426, cryptographic processor interface 3427, cryptographic processor device 3428, and/or the like, as shown in FIG. 20. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the code triggered information server may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the code triggered information server component to engage in secure transactions if so desired. The cryptographic component facilitates the secure accessing of resources on the code triggered information server and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Code Triggered Information Server Database

The code triggered information server database component 3419 may be embodied in a database and its stored data, as shown in FIG. 20. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the code triggered information server database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the code triggered information server database is implemented as a data-structure, the use of the code triggered information server database 3419 may be integrated into another component such as the code triggered information server component 3435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 3419 includes several tables 3419a,b. A user profile table 3419a includes fields such as, but not limited to: a user ID, name, email address, address, demographic profile, hardware ID, scan history record, scan statistics, and/or the like. The user profile table may support and/or track multiple entity accounts on a code triggered information server. An Information Base table 3419b includes fields such as, but not limited to: 3^{rd} party provider ID, 3^{rd} party ID, 3^{rd} party preference content, preference labels, geographic tags, temporal tags, subject tags, preference ratings, preference statistics, and/or the like.

In one embodiment, the code triggered information server database may interact with other database systems. For example, employing a distributed database system, queries and data access by OLBS modules may treat the combination of the code triggered information server database, an integrated data security layer database as a single database entity.

In one embodiment, user programs may contain various user interface primitives, which may serve to update the code triggered information server. Also, various accounts may require custom database tables depending upon the environments and the types of clients the code triggered information server may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 3419a,b. The code triggered information server may be configured to keep track of various settings, inputs, and parameters via database controllers.

The code triggered information server database may communicate to and/or with other components in a component collection, including itself, and/or facilities of the like. Most frequently, the code triggered information server database communicates with the code triggered information server component, other program components, and/or the like. The database may contain, retain, and provide information regarding other nodes and data.

### The Code Triggered Information Server

The code triggered information server component 3435 is a stored program component that is executed by a CPU, as shown in FIG. 20. The code triggered information server affects accessing, obtaining and the provision of information, preferences, services, transactions, and/or the like across various communications networks.

The code triggered information server component enables the identification, generation, and aggregation of Outcome Messages and Rewards Messages.

The code triggered information server component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the code triggered information server employs a cryptographic server to encrypt and decrypt communications. The code triggered information server component may communicate to and/or with other components in a component collection, including itself, and/or facilities of the like. Most frequently, the code triggered information server component communicates with the code triggered information server database, operating systems, other program components, and/or the like. The code triggered information server may contain, communicate, generate, obtain, and/or provide program component, system, user, and/or data communications, requests, preferences, and/or responses.

### Distributed Code Triggered Information Server

The structure and/or operation of any of the code triggered information server node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the code triggered information server controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

### Code Triggered Information Server Controller

FIG. 20 of the present disclosure illustrates inventive aspects of a code triggered information server controller 3401 in a block diagram. In this embodiment, the code triggered information server controller 3401 may serve to aggregate, process, store, search, serve, identify, instruct, generate, match, and/or update Outcome Messages, Scan Messages, Rewards Messages, Environment Messages, Scans, Environments, Rewards, Games, Outcomes, badges, coupons, promotions, user profiles, and/or other related data.

### Outcome and Rewards Messages

Methods and systems are provided herein for an interactive mobile advertisement, which incentivizes the user to interact with the advertisement. The interactive mobile advertisement may have a game-like format suitable for mobile platforms.

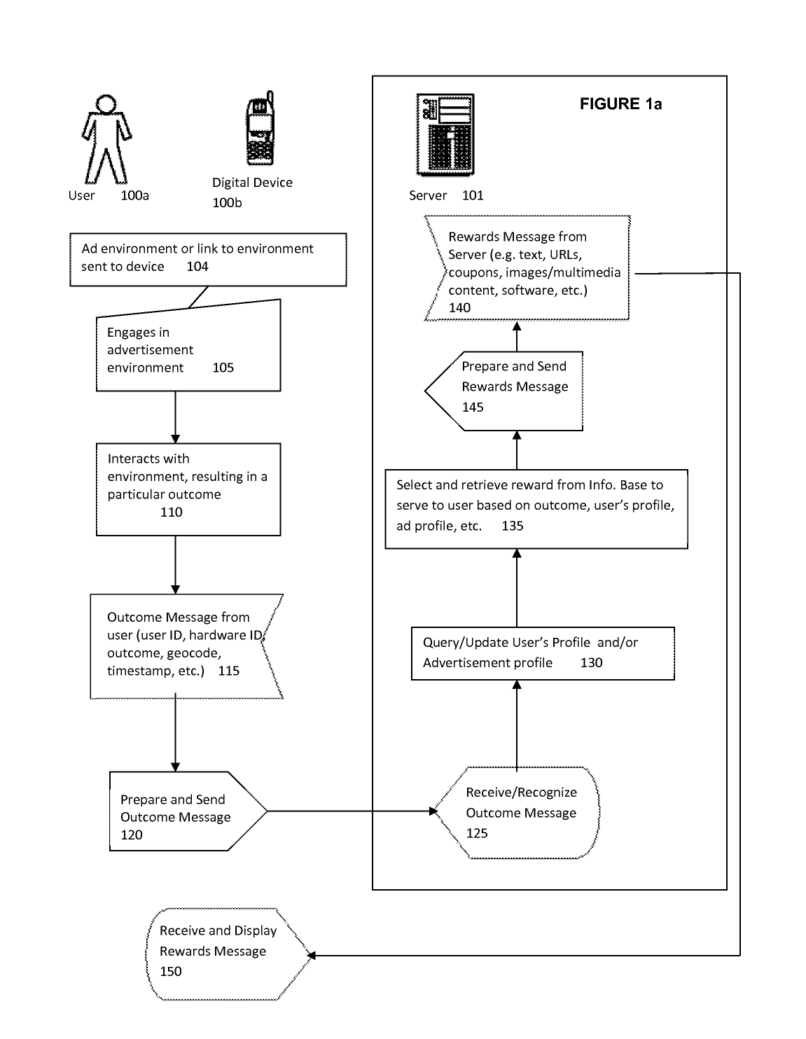

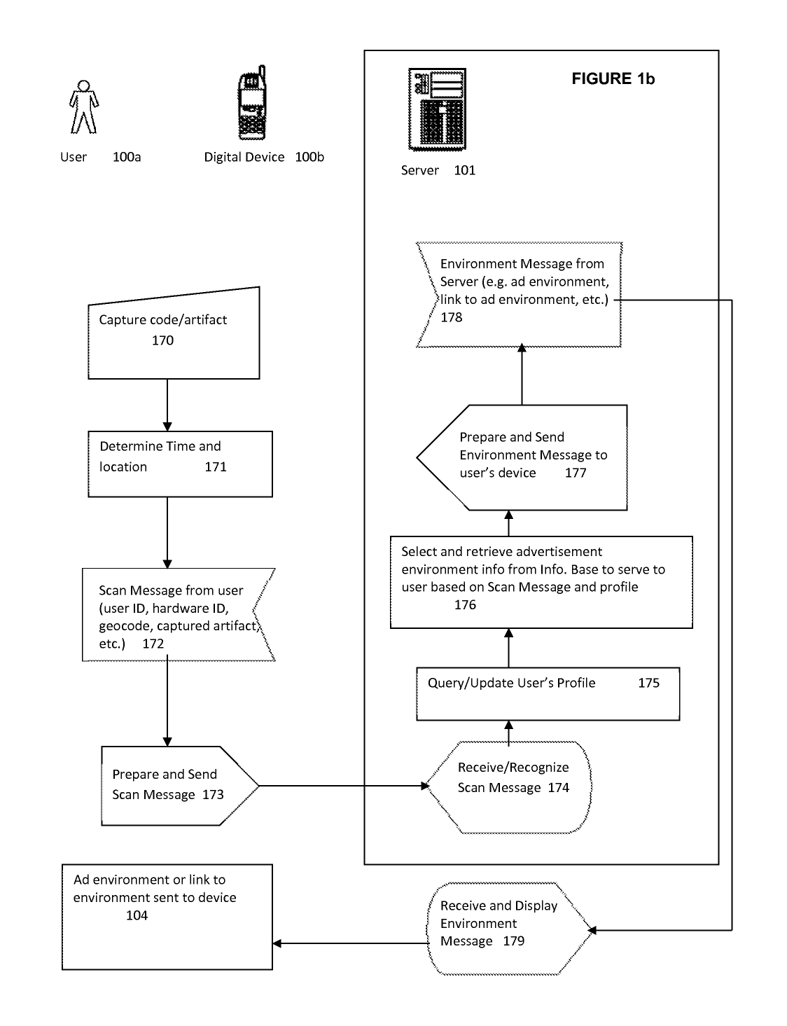

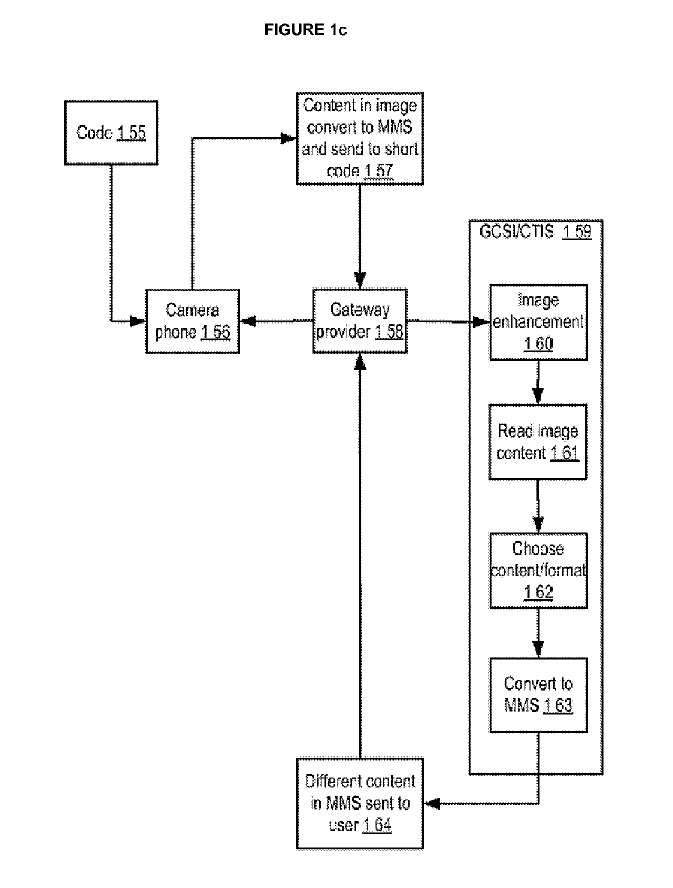

In one embodiment, a code triggered information server (“CTIS”) employs two basic actors: (i) a user (100a) capable of receiving, viewing, and interacting with an interactive mobile advertisement, capturing, transmitting, and receiving data, and displaying information; and (ii) a server (101) capable of communicating with the user and/or 3^{rd} party providers, storing/updating user profiles, and selecting information to serve to the user, as shown in FIG. 1a. In addition to the two basic actors, the CTIS enables the creation of two types of transactional articles: i) Outcome Messages (115) and ii) Rewards Messages (145). Outcome Messages 115 can send to the server data related to the user, the user's interaction with an interactive mobile advertisement, other activity of the user, or a product or service of interest to the user. The CTIS provides context-specific Rewards Messages in response to Outcome Messages, which are prepared in response to the interaction of the user with an advertisement, in order to supply information and/or rewards to the user. The CTIS generates Rewards Messages by processing Outcome Message content with advertisement profile information, outcome recordation databases (such as high score tables comparing the top results of a plurality users), and/or user profile information. The user profile may contain basic profiling data as well as a history of Outcome Messages supplied by a given user. As such, Rewards Messages are transactional articles that heighten a 3^{rd} party provider's opportunity to supply relevant and targeted advertising and/or coupons/promotions to the user that is both context and user specific. Without loss of generality, we will heretofore refer to the rewards and/or coupons/promotions as Rewards Messages. The CTIS may also elect to send context and user-specific Rewards Messages based solely on the user profile, without the user having recently registered activity interest, if it is determined from the user's profile, particularly the history of Outcome Messages, that a particular Reward is appropriate. The Rewards Message may include a SMS response, a URL to a mobile site, a coupon, and/a multi-media clip, a discount code, and/or the like, as further detailed below. The user may engage directly in an interactive mobile advertisement environment, where the advertisement environment may be any 2-D, 3-D, or 3-D VR environment to express interest, or the user may express interest on a system that is coupled to a 2-D, 3-D, or 3-D VR environment, or user may engage in a 2-D, 3-D, or 3-D VR environment on a digital device to express interest.

The Rewards message may be enabled by a mobile payment system. The mobile payment system may be Premium SMS based transactional payments, Direct Mobile Billing, Mobile web payments (WAP), or Contactless NFC (Near Field Communication). SMS based transactional payments are when the user sends a payment request via an SMS text message or an USSD to a short code and a premium charge is applied to their phone bill or their online wallet. The merchant involved is informed of the payment success and can then release the paid for goods. A Multimedia Messaging Service can also deliver barcodes which can then be scanned for confirmation of payment by a merchant. This is used as an electronic ticket for access to cinemas and events or to collect hard goods. Mobile web payments may use Direct operator billing, credit card, eWallets, SmartWallet, or online wallets. “Digital wallet” is also increasingly being used to describe mobile phones, especially smartphones, that store an individual's credentials and utilize wireless technologies such as near field communication (NFC) to carry out financial transactions. Online wallets include PayPal, Amazon Payments and Google Checkout also has mobile options. Digital wallet (also known as an e-wallet). NFC employs a special mobile phone equipped with a smartcard that is waved near a reader module. Most transactions do not require authentication, but some require authentication using PIN, before transaction is completed. The payment could be deducted from a pre-paid account or charged to a mobile or bank account directly. NFC may be employed by Google Wallet, Visa DPS, and the like.

Advertisement environments may be delivered to the user based on captured data, as more fully described below in relation to FIGS. 1b-c. The data captured may be single mode or multi-modal data, and may consist, for example of any sensory-type input, e.g., visual, auditory, olfactory, haptics or gustatory. Visual inputs may consist of image capture, pattern recognition, text recognition, bar codes, such as UPC or QR codes, hand gestures, or the like. Auditory inputs may consist of music, sound recognition, sound pattern recognition, spoken word recognition, or the like. Olfactory inputs may consist of inputs from artificial noses, such as that described by Stitzel, S. E., et al. in Artificial Noses, Ann. Rev. Biomed. Eng. Vol. 13, 1-25 (August 2011) or in U.S. Pat. No. 7,261,857, gas chromatographs or other instruments for detecting the presence of airborne elements. Tactile inputs may consist of data acquired by virtue of surface roughness measurements, such as by atomic force microscopy, by a tactile-sensing system such as that described by Decherchi, S., et al., IEEE Transactions on Robotics, 27(3), 635-639, June, 2011, or by tactile sensors as described in U.S. Pat. No. 7,823,467, each of which is expressly incorporated by reference. Finally, gustatory, or the taste inputs, may be obtained by employing a taste sensor, such as that described in U.S. Pat. No. 7,858,036 or the taste sensor data system described in U.S. Patent Application Publication No. 20040107053, each of which is expressly incorporated by reference. Thus, the data capture device 100b may be any device suitable for capturing sensory data from an artifact in which the user has interest and communicating captured sensory data to a computing device or server.

In one embodiment, the data capture device 100b may be in the proximity contact with the product of interest, such as Near Field Communications (NFC), Radio Frequency Identification (RFID), Bluetooth, Infrared, Wireless communication, Automatic Identification and Data Capture (AIDC), and other short range communications and the like. AIDC refers to the methods of automatically identifying objects, collecting data about them, and entering that data directly into computer systems (i.e. without human involvement). Technologies typically considered as part of AIDC include bar codes, Radio Frequency Identification (RFID), biometrics, magnetic stripes, Optical Character Recognition (OCR), smart cards, and voice recognition. AIDC is the process or means of obtaining external data, particularly through analysis of images, sounds or videos. To capture data, a transducer is employed which converts the actual image or a sound into a digital file. The file is then stored and at a later time it can be analyzed by a computer, or compared with other files in a database to verify identity or to provide authorization to enter a secured system. Capturing of data can be done in various ways; the best method depends on application. AIDC also refers to the methods of recognizing objects, getting information about them and entering that data or feeding it directly into computer systems without any human involvement. Automatic identification and data capture technologies include barcodes, RFID, bokodes, OCR, magnetic stripes, smart cards and biometrics (like iris and facial recognition system).

### SMS

In one implementation, the Outcome Message and/or data from the ad environment may be sent to the server (101) by a Short Messaging Service (SMS) protocol. In other implementations, a wide variety of other communication protocols may be employed for the Outcome Message, including but not limited to: Multimedia Messaging Service (MMS), instant messaging, web browser based messaging, email, Enhanced Messaging System (EMS), TCP/IP, WAP, and/or the like. Similarly, the Rewards Message may be sent from the server to the user's digital device by a SMS protocol, or in other implementations a wide variety of other communications protocols.

### Ad Interaction General Overview

FIG. 1a illustrates a combined logic and dataflow block diagram of a general embodiment of providing targeted and contextual information and/or rewards to the user related to an interactive mobile advertisement environment. Here, a user (100a) employs a digital device (100b), to which an interactive advertisement environment (or a link to such an environment) has been provided (104). The user engages in the interactive mobile advertisement environment (105). The user then interacts with the ad environment, resulting in a particular outcome from the user's interaction with the ad environment (110). An Outcome Message is composed and sent (120) from the digital device to the server (101), via the digital device's data connection. The Outcome Message may include, without limitation, the outcome, a user ID, a hardware ID, a geocode, a timestamp, an ad environment ID, an ad ID, a subject code, a source code, a content code, and/or the like. The server receives/recognizes the Outcome Message (125), and queries a database of user profiles (130) based on the supplied user ID to update the appropriate user profile with the content of the current Outcome Message and to determine what, if any, information in the user profile may be relevant to the preparation of the current Rewards Message (135). In one embodiment, the user can supply a list of interests to be considered in addition to those culled from their Outcome history. The server selects the appropriate reward content to include in the Rewards Message (135). The reward content may comprise a contextual coupon (either a link or a downloadable artifact), a promotional offer or code, a gift card, a promotional voucher, a badge or other signifier that is capable of being shared on a social network (such as Twitter, Facebook, LinkedIn, etc.), and/or the like. The Rewards Message or reward content may be stored either on the media company or a 3^{rd} party server. The server then prepares and sends the Rewards Message (145), which may include a coupon for activation by the user, but could, without limitation, include text, URLs to mobile sites where the item of interest is featured, video clips of the item of interest, other multimedia content, software, downloadable artifacts, a contextual coupon (either a link or a downloadable artifact), a promotional offer or code, a gift card, a promotional voucher, a badge or other signifier that is capable of being shared on a social network (such as Twitter, Facebook, LinkedIn, etc.), and/or the like (140). The Rewards Message is received and displayed (or other appropriate action is taken) by the user's digital device (150).

In another embodiment, the interactive ad environment may have a game-like format. The game-like format may be suitable for mobile platforms, such as cell phones, smartphones, PDAs, and/or the like. The game-like format may be any game format as is known to one having ordinary skill in the art, but particular, non-limiting examples include: a hidden object game (i.e., “Where's Waldo?”), wherein the user locates a hidden object within the game environment; a trivia game, wherein the user answers a question; a dungeon crawler game, wherein the user completes a level, task, or other goal; a racing game, wherein the user competes against a time standard or computer opponents; and/or the like.

In another embodiment, the interactive mobile advertisement has a game-like format which comprises multiple levels. In some embodiments, each successive level progresses in difficulty. The addition of levels to the interactive mobile advertisement may incentivize users to commit additional time to interaction with the advertisement, increasing the effectiveness of the advertisement. One example, without limitation, of a game-like format having levels is a dungeon-crawler type game, wherein each additional level is longer and/or harder than the previous level. In another example, without limitation, the game-like format having levels may be a trivia game, wherein each additional level or round prompts the user to respond to a more difficult question.

In an example of one embodiment of the interactive mobile advertisement having levels, completion of a first level could unlock a badge to be shared on a social network, completion of a second level could unlock a promotional code or coupon for free shipping or a free sample of a product from the advertiser, and completion of a third level could unlock a promotional code or coupon for a percentage off of the user's next purchase from the advertiser, and/or the like. Alternative progressions of the unlocked “rewards” or “achievements” is anticipated by this invention, and are within the scope of this disclosure. Similarly, different numbers of completed levels may be required to unlock any of the rewards or achievements for the user. Generally, any tiered incentive system may be implemented within the scope of this disclosure.

In one embodiment, a plurality of rewards may be delivered to the user, based upon the number of levels or other tasks completed by the user. Alternatively, the outcome (e.g., score) of a user may be utilized to determine the level of reward provided to the user, such as through outcome tiers (e.g., one star, two star, three star, etc.).

Alternatively, the interactive mobile advertisement may incorporate a competition aspect, resulting in an enhanced reward or achievement to one or more users who have the “best” outcomes from “playing” the advertisement. This could be implemented by having users submit their results at the conclusion of the “game,” along with their contact information, and maintaining a high score list of submitted results. At the end of a specified period (such as an hour, day, week, month, and/or the like), one or more of the top results may be selected to receive an enhanced reward or achievement. The enhanced reward or achievement may be a promotion or coupon having a greater value than those offered for generally interacting with the advertisement, or could be promotions or coupons beyond the scope of those from general interaction (such as gift cards, promotional credit vouchers, etc.). Alternatively, the enhanced achievement could be a “badge” sharable via social networks that highlights a user's accomplishments, such as having the high score of the day, week, month, etc.

In one embodiment, the methods and systems may utilize a game emulator to reduce the memory needed for secondary downloads during interaction by a user with the interactive mobile advertisement.

A video game console emulator is a program that allows a personal computer or video game console (cross-console emulation) to emulate a different video game console's behavior. Emulators are most often used to play older video games on personal computers and video game consoles, but they are also used to play games translated into other languages or to modify (or hack) existing games. Emulators are also a useful tool in the development process of homebrewed demos and new games for older systems. Code and data of a game are typically supplied to the emulator by means of a ROM file (a copy of the data contained on a game cartridge) or a disc image (for systems that use optical media). Specialized adapters such as the Retrode allow emulators to directly access the data on game cartridges without the need to copy it into a ROM image first. Due to the demand to play old games on modern systems, consoles have begun incorporating emulation technology. The most famous of these is Nintendo's Virtual Console. Present on all Nintendo console releases, the Virtual Console uses software emulation to allow the purchasing and playing of games for old systems on modern hardware. The Virtual Console has a large collection of games spanning a wide variety of consoles, which are free from emulation accuracy issues that plague unofficial emulators. Due to differences in hardware, the Xbox 360 is not natively backwards compatible with original Xbox games. However, Microsoft includes backwards compatibility with popular titles through an emulator. The PlayStation 3 uses physical PlayStation hardware to play original PlayStation titles. In US 60 GB models original PS2 graphics and CPU hardware are present to run PS2 titles; however the PAL and later US models removed the PS2 CPU, replacing it with software emulation working alongside the video hardware to achieve partial hardware/software emulation. Backwards compatibility with PS2 titles was completely removed along with the PS2 graphics chip, and eventually released PS2 titles with software emulation on the PlayStation Store.

Commercial developers have also used emulation as a means to repackage and reissue older games on newer consoles in retail releases. For example, Sega has created several collections of Sonic the Hedgehog games. Before the Virtual Console, Nintendo also used this tactic, such as Game Boy Advance re-releases of NES titles in the Classic NES Series.

Emulators may include, but are not limited to the following: 3DOplay, Stella, z26, MESS, Commodore's CCS64, VICE, Dreamcast's Chankast, nullDC, Game Boy's VisualBoyAdvance, Game Boy Color's VisualBoyAdvance, Game Boy Advance's VisualBoyAdvance, BoycottAdvance, GameCube's Dolphin, Nintendo 64's Project64, 1964, UltraHLE, Nemu64, sixtyforce, Nintendo DS's DeSmuME, iDeaS, dasShiny, NES's VisuaNES, FCEUX, Nestopia, Neo Geo's NeoPop, PlayStation's ePSXe, pSX, PCSX, PlayStation 2's PCSX2, PlayStation Portable's PPSSPP, PCSP, Jpcsp, Sega Saturn's yabause, Satourne, SNES's ZSNES, Snes9X, and Wii's Dolphin.

In one embodiment, the interactive mobile advertisement may be incorporated into a web page viewed by the user via a digital device, mobile or not. In another embodiment, the interactive mobile advertisement may be incorporated into other content that is delivered to the user, such as an email, a text message, an instant message, a multimedia message, etc.

### “Registering” Interest (Scanning)

In one embodiment, users of the CTIS scan codes to register interest in a potential interactive advertisement environment and the CTIS acts as a portal for consumers to access advertisement environments supplemental to the context in which the codes are found. Users may scan codes found in media publications, on billboards or signs, on consumer products or packages, on websites or television screens, within 2-D, 3-D, or 3-D virtual worlds, and/or the like. In doing so, the users may identify themselves via an identification code specific to the digital device and service account with which the scan is made. At the same time, the scanned code can be recorded, as well as the time of day and user location; such information may form the basis of consumer profiles that may be saved by the CTIS. As these scans are indicative of interest in various subjects, goods, and/or services, they may serve as a basis for an individual customer tracking system. As such, advertisers or 3^{rd} party providers can finely tune and efficiently tailor their efforts towards achieving maximum return on the advertising expenditure.

Alternatively, users may engage directly in a 3-D environment on a computer, digital device, television, and the like. Various digital devices are now equipped with 3-D capabilities to display 3-D images. Alternatively, users may register their interest within a 3-D VR environment with an avatar or the like. The user may click or engage an artifact or product of interest. For example, a player in The Sims Online who frequently acquires new furniture for his/her virtual apartment and has a stated interest in modern art may be served advertisements for an actual furniture store that sells modern furniture and is near the user's geographic location following one such virtual furniture acquisition. In another example, a user in Second Life that likes modern clothing for his/her character may be presented with Ads on virtual billboards from advertisers of virtual in-game clothing stores that are nearby the user's virtual position (or offer a virtual transportation link that will instantly move the user's avatar to the virtual in-game store).

Alternatively, users may express interest for a product or artifact on a system that coupled to a 3-D VR environment. For example, a user may register interest in a product or artifact on a social network site that is coupled to a 3-D VR environment. The 3-D VR environment may then receive the product or artifact of interest from the User to prepare an interactive advertisement for presentation to the user, from which an Outcome Message can be generated and then the Rewards Message sent from the CTIS to the user.

The user registering interest by artifacts capable of being capture include, among other things, 3D barcodes that are have regions of differing heights, with the regions, their patterns and their relative heights being representative of data. In accordance with one embodiment, the three dimensional nature of artifacts, including barcodes, may be used advantageously for allowing sight or hearing impaired individuals to capture data from artifacts with 3D codes, whether 3D barcodes per se, or other 3D surfaces capable of acting as data sources, and have that data captured, processed and provided to such individuals in a form that makes the information encoded by the 3D data more available to the user. In one particular embodiment, sight impaired individuals often employ their haptic senses to, for example, read using braille, to scan products to identify container shapes or features or the like. These skills are, of course, learned and require considerable effort on the part of the individual. The embodiments disclosed herein may be used with sight impaired individuals to capture sensory data otherwise unavailable or difficult to access to such individuals and convert the sensory data into a usable form, e.g., sounds. Similarly, in accordance with another embodiment, a hearing impaired individual may use the embodiments disclosed herein to capture audible sensory data, e.g., music, street sounds, warning sounds or the like, and covert such unavailable or difficult to access sensory data in a form, e.g., visual, that renders such audible sensory data more available and meaningful to a hearing impaired individual. In this manner, the embodiments disclosed herein may be employed to simply capture and convert data existent in one sensory form to another sensory form that is more useful or available to a user having a particular disability or impairment.

### Ad Environment Provision Via Code Triggered Information Server Basic Overview

Code scanning and responses are more fully discussed in co-pending, commonly assigned U.S. Patent Application Publication No. US 2011/0264527A (the '527 Published Application), which is hereby incorporated in its entirety by reference.

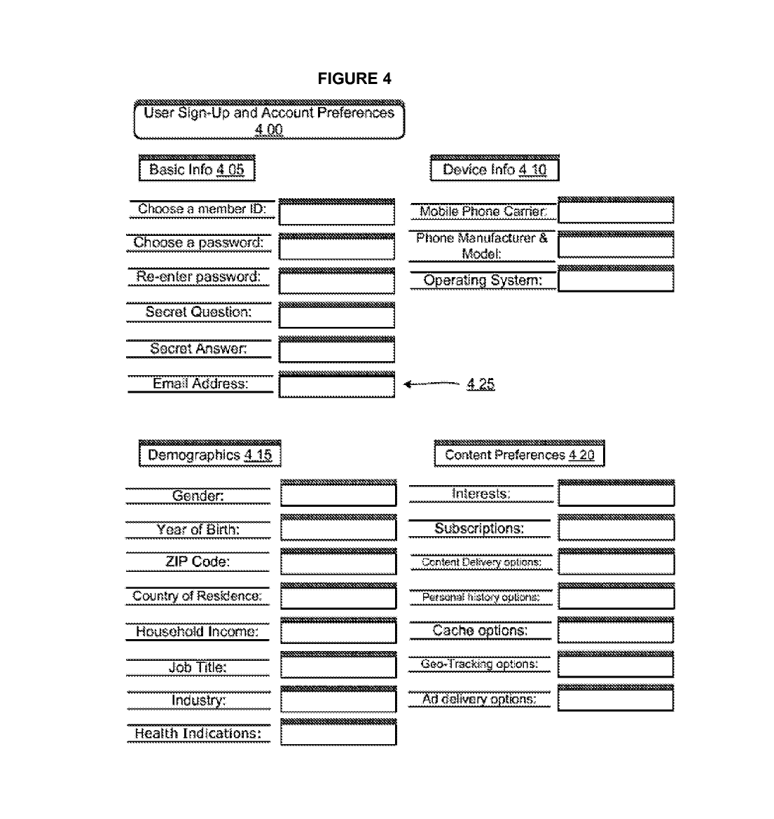

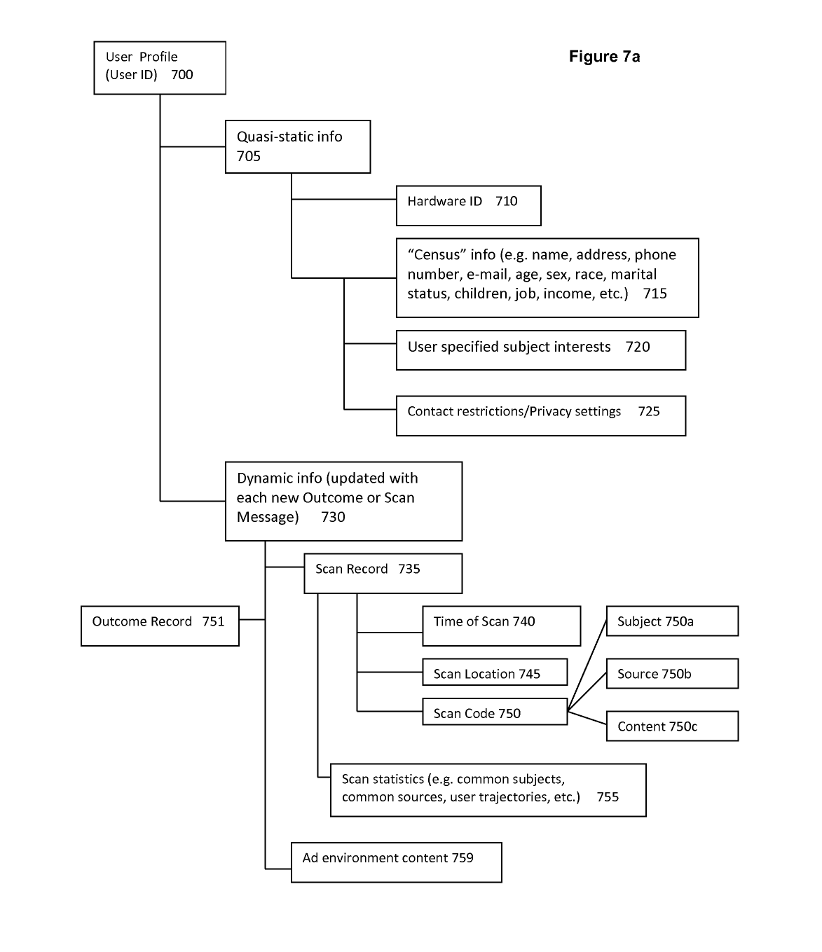

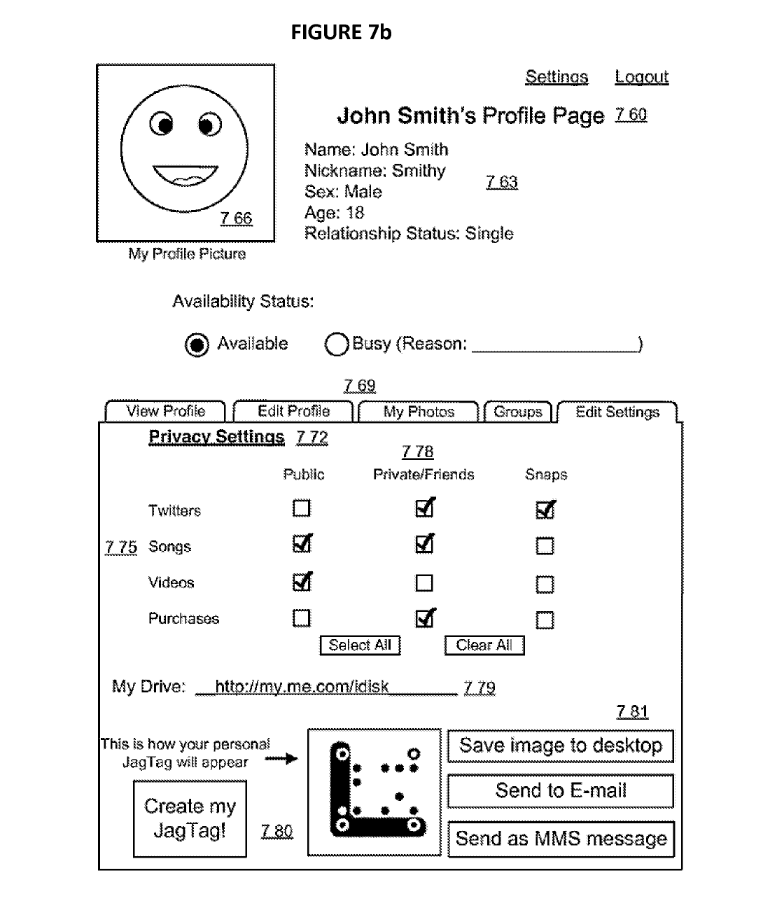

FIG. 1b shows a combined logic and data flow block diagram illustrating a general overview of the provision of ad environments via the CTIS to users, in one embodiment. The CTIS may be configured so that a user (100a) may capture a digital code (170) with a capture device (100b), as for example by using a cell phone camera to register a 2-D, 3-D, or 3-D VR image by a scan and/or take a picture of a barcode, 2d code, 3D code, matrix code, data matrix, QR code, NFC, or other such symbology. An example of a mobile device and software capable of such code capture is the Nokia 6600 cellular telephone equipped with ConnexTo software. Alternatively, the CTIS may be triggered by the user selecting an internet link (such as on an internet enabled mobile device), by making decisions within a virtual world (such as a massively multiplayer online game), and/or the like. Without loss of generality, all such forms of interest-registering CTIS triggering will be referred to as “code scanning” The time and location (as determined by GPS, GPRS, or other such geo-positioning technologies) of the mobile device are determined (171), and a Scan Message (172) is generated containing a user identification (ID), a hardware ID that identifies the type of mobile device being used, a geocode (location of the device), a timestamp, and the scanned code (see FIG. 4 and discussion of Scan Message below). Within virtual worlds, the geocode and timestamp may be virtual world geographic and temporal information. Additional user-input information may also be supplied at this point. The Scan Message is packaged and sent (173) to a server (101) that receives and recognizes it (174). The user's profile, specific to the supplied user ID, is updated with the new Scan Message (i.e., it is added as a transaction to their profile transaction history) and queried (175) for information to use in the preparation of an Environment Message (177) that is also based on the content of the current Scan Message. The user's profile may be the profile of the physical user him/herself, and/or the profile of the user's virtual avatar in a 3-D VR environment. The server selects (176) the ad environment content (see FIG. 7a) of the Environment Message (178) from an Information Base and sends it to the user's mobile display device, which displays the pertinent content to the user (179). Once the ad environment or a link to the ad environment is sent to the user's digital device (104), the user may interact with the ad environment as described above in relation to FIG. 1a.

### MMS

In one implementation, the Scan Message and/or scanned code may be sent to the server (101) by a Multimedia Messaging Service (MMS) protocol. In other implementations, a wide variety of other communication protocols may be employed, including but not limited to: Short Messaging Service (SMS), instant messaging, web browser based messaging, email, Enhanced Messaging System (EMS), TCP/IP, WAP, and/or the like.

### Short Code

In one implementation, the server (101) may be addressed by a short code, short numbers, Common Short Code (CSC), and/or the like for sending the Scan Message, Outcome Message, and/or scanned code. For example, a short code may appear alongside a code in a print publication, and a user may be informed that the scanned code should be sent to the indicated short code number in order to retrieve an Environment Message, Reward Message, advertisement, reward, ad environment, coupon, and/or the like. In other implementations, other addressing means may be employed, such as an ordinary telephone number, an email address, a universal resource locater (URL), and/or the like. In another implementation, the short code and/or other server address may be encoded within part of the code itself. When the user scans the code with his or her mobile device, the code may be partially decoded by the client device to extract the address and automatically send the rest of the code thereto.

### Scanning

FIG. 1c shows a combined logic and data flow diagram of an implementation of presenting an interactive mobile advertisement to a user in one embodiment of CTIS operation. A code (155) is scanned by a user's camera phone (156), and the resulting image content is converted to an MMS format to be sent via short code (157) through a gateway provider (158) to the CTIS (159) server. Alternatively, the user may interact directly in a 3D or 3D VR environment via an avatar to select product or service that includes the code (155), or the user may register a 2D or 3D image that includes the code (155). At the server, the 2-D, 3-D, or 3-D VR image information may be enhanced, manipulated, and/or otherwise processed (160) so as to aid in determining the appropriate advertisement to serve to the user in response. After enhancement, the image content is read (161) and the advertisement and environment format for the appropriate response is determined (162). Either an advertisement environment or a link to an advertisement environment is formed in MMS format (163) and is sent (164) back to a gateway provider (158) to be served to the user's camera phone (156).

In an alternative implementation, the scanned code may be directly decoded on the client mobile device instead of on the server. The decoded content may then be converted to MMS format and sent via short code to the server in order to retrieve the appropriate advertisement environment associated with the code. That advertisement environment may be returned from the server to the client mobile device by means of an MMS protocol as well.

### CTIS Server

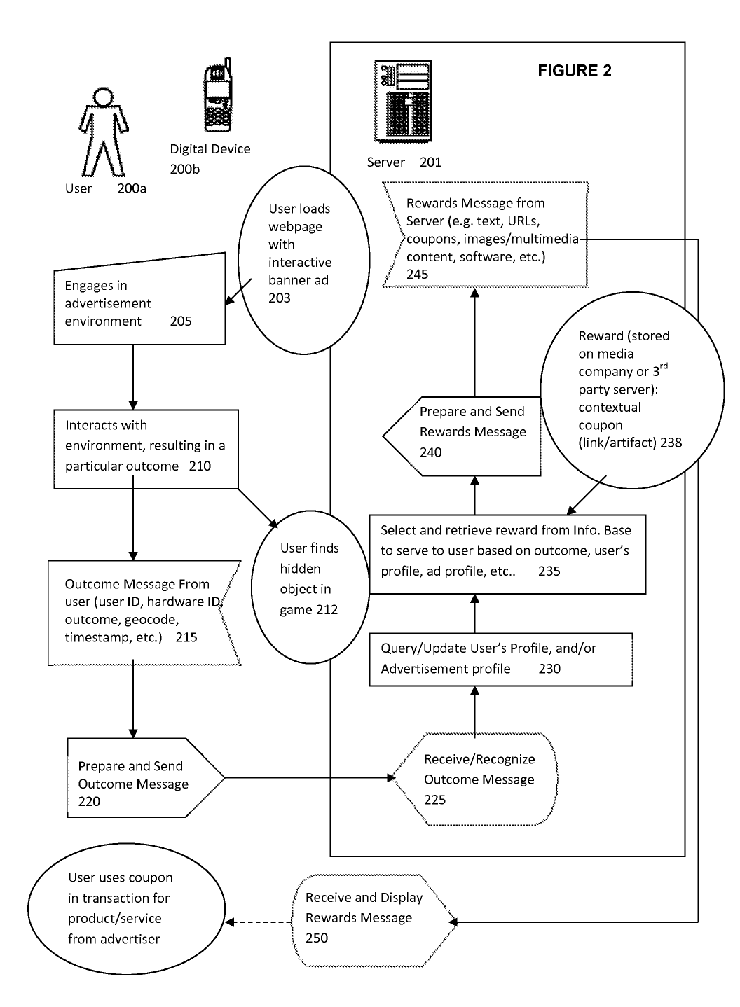

For illustration, FIG. 2 is a particular, exemplary embodiment: providing targeted and contextual information and/or rewards to the user related to a game-environment wherein the user is prompted to find a hidden object within the environment to receive a reward. Here, a user (200a) employs a digital device (200b) to engage in an interactive mobile advertisement environment (205), such as by loading a webpage that includes the interactive ad environment via a banner ad on the webpage (203). The user then interacts with the ad environment, playing the game and finding the hidden object, resulting in a particular outcome from the user's interaction with the ad/game environment (210). An Outcome Message is composed and sent (220) from the digital device to the server (201), via the digital device's data connection. The Outcome Message may include, without limitation, the outcome, a user ID, a hardware ID, a geocode, a timestamp, an ad environment ID, an ad ID, a subject code, a source code, a content code, and/or the like. The server receives/recognizes the Outcome Message (225), and queries a database of user profiles (230) based on the supplied user ID to update the appropriate user profile with the content of the current Outcome Message and to determine what, if any, information in the user profile may be relevant to the preparation of the current Rewards Message (235). In one embodiment, the user can supply a list of interests to be considered in addition to those culled from their Outcome history. The server selects the appropriate reward content to include in the Rewards Message, comprised in the exemplary embodiment of a contextual coupon (either a link or a downloadable artifact) (238). The Rewards Message or reward content may be stored either on the media company or a 3^{rd} party server. The server then prepares and sends the Rewards Message (240), which here includes a coupon for activation by the user, but could, without limitation, include text, URLs to mobile sites where the item of interest is featured, video clips of the item of interest, other multimedia content, software, downloadable artifacts, and/or the like (245). The Rewards Message is received and displayed (or other appropriate action is taken) by the user's digital device (250). Here, the user may then use the contextual coupon in a transaction for a product or service from the advertiser who sponsored the advertisement (251). The coupon may be an electronic coupon or a coupon that is employed with a mobile payment system, such as Google Wallet and the like. In an alternative embodiment, user actions and responses take place in a 3-D VR environment. In the 3-D VR environment embodiment, the Rewards Message may also include reward content relevant to the physical location of the user, depending on the advertisement in the 3-D VR environment.

### Space-Time Trajectories—No Scan

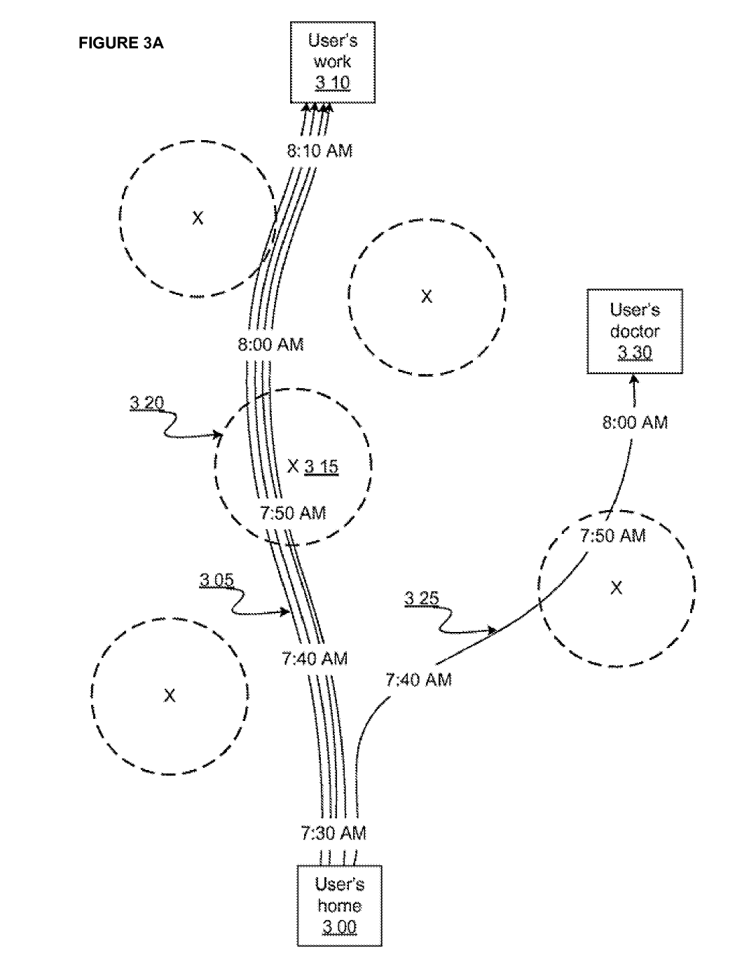

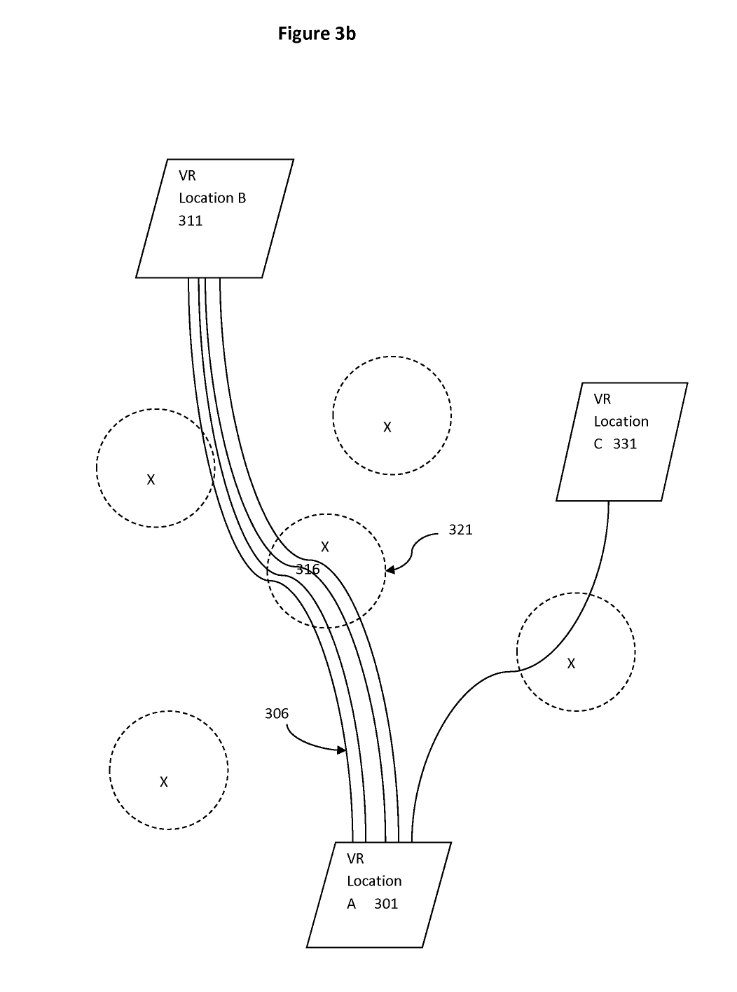

In one embodiment, the CTIS can provide interactive advertisement environments to the user based on the collected knowledge of user space-time trajectories contained in the user profile, without the need for any initiating code scan. This embodiment is best illustrated by example, as drawn in FIG. 3A. Here, a user rides a bus from home (300) to work (310) on four of the last five days, and takes a different bus to his doctor's office (330) on the remaining day. The space-time trajectories for the four work trips (305) and the one doctor trip (325) are determined by codes that the user scans with his cell phone from a newspaper during the bus rides. In this example, the user is assumed to scan a code every ten minutes starting at 7:30 AM until the destination is reached, and the geographic location of each scan is indicated by the position of the timestamp along each trajectory. In one embodiment, tracking occurs without scanning, simply by having the device send geocodes and timestamps by itself Along the way to his destinations, the user passes a number of 3^{rd} party providers (marked with X's) with advertisement content in the CTIS Information Base, with dotted circles indicating the locus of points that are a distance of two miles from each provider. One Ad provider in particular (315), a gourmet coffee shop, is within two miles (320) of the user's space-time trajectory at 7:50 AM in four of the last five days. The user's profile also lists “coffee” as an interest, both based on user specifications during registration and on the user's scan record. Consequently, on the sixth day, the server supplies the user with an interactive advertisement for the coffee shop (315) at 7:45 AM, through which the user can obtain a reward for playing a game.

In one embodiment, the CTIS can provide interactive advertisements to the user based on the collected knowledge of user's virtual space-time trajectories contained in the user profile (or avatar), without the need for any initiating code scan. This embodiment is best illustrated by example, as drawn in FIG. 3b. Here a user's avatar in a 3-D or 3-D VR environment has travelled from VR location A (301) to VR location B (311) on four of the last five sessions in the environment, and took a different route from VR location A (301) to VR location C (331) in the fifth session. The trajectories are determined by logs of the avatar's virtual geographic and temporal location, and/or the avatar's interactions with virtual artifacts. When the avatar breaches certain 3^{rd} party provider zones, the CTIS server provides an advertisement environment to the user for an appropriate ad of the 3^{rd} party or Ad provider.

### Code Triggered Information Server (CTIS) Detailed Overview

### User and Reward or Ad Provider Participation

The CTIS may be enabled by the participation of Reward or Ad 3^{rd} party providers and users. In one embodiment, Reward or Ad providers supply Rewards or Ads for storage on the CTIS server. In an alternative embodiment, the Rewards or Ads are stored on third party servers that are referenced by the CTIS server. The user experience may be enhanced by the incorporation of personal preferences and demographic information to optimize the targeting of Reward or Ad content. Consequently, one embodiment would incorporate a user registration procedure. Users may register for the CTIS via the internet, telephone, postal mail, and/or the like. If a particular embodiment of the CTIS requires client software for the user to install, this could be supplied upon successful user registration. FIG. 4 shows an exemplary embodiment of a user registration interface 400, wherein a user can input Basic Info 405 (e.g., member ID, password, secret question/answer, e-mail address, etc.), Device Info 410 (e.g., mobile phone carrier, phone manufacturer & model, operating system, etc.), Demographics 415 (e.g., gender, year of birth, zip code, country of residence, household income, job title, industry, etc.), and Content Preferences 420 (e.g., interests, subscriptions, content delivery options, personal history options, cache options, geo-tracking options, Reward or Ad delivery options, etc.) in a plurality of fields 425. In an alternative embodiment, a basic user identification packet (e.g., a “cookie”) is sent with a user's first code scan, thus establishing a basic user profile that can be filled in with greater detail at a later time. In virtual world embodiments, the user information may alternatively be built around the user's virtual avatar, which may or may not differ from the physical user.

### Code Capture

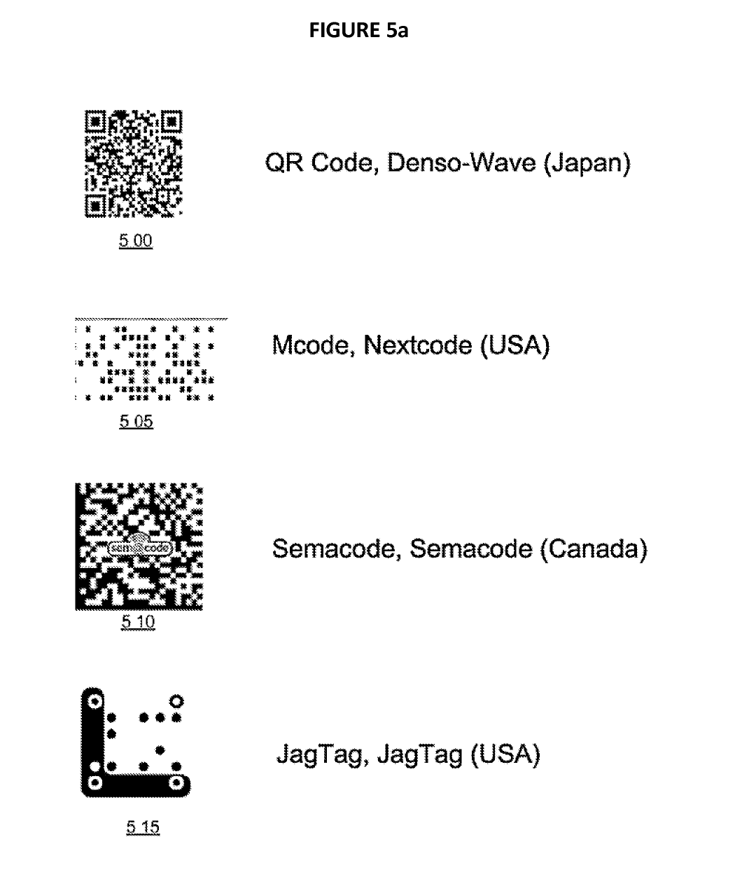

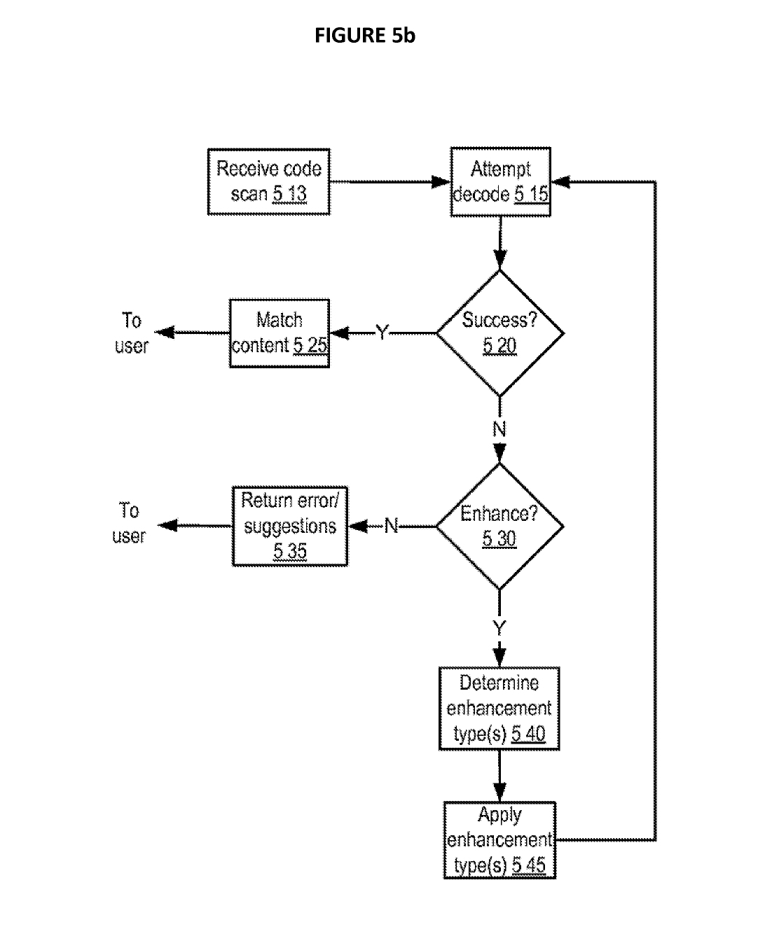

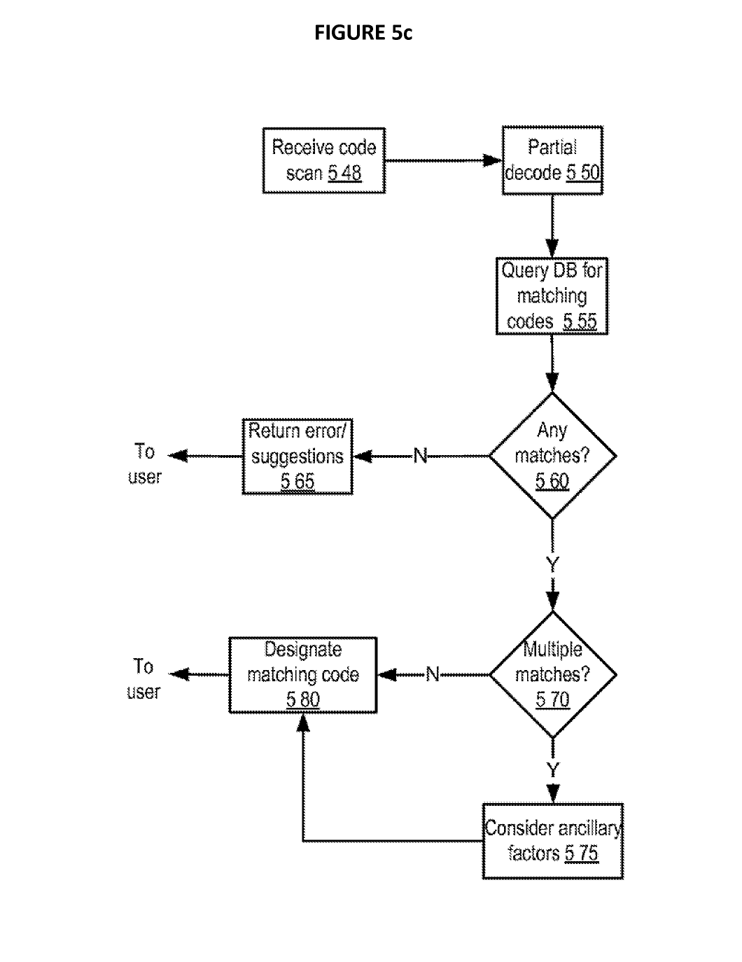

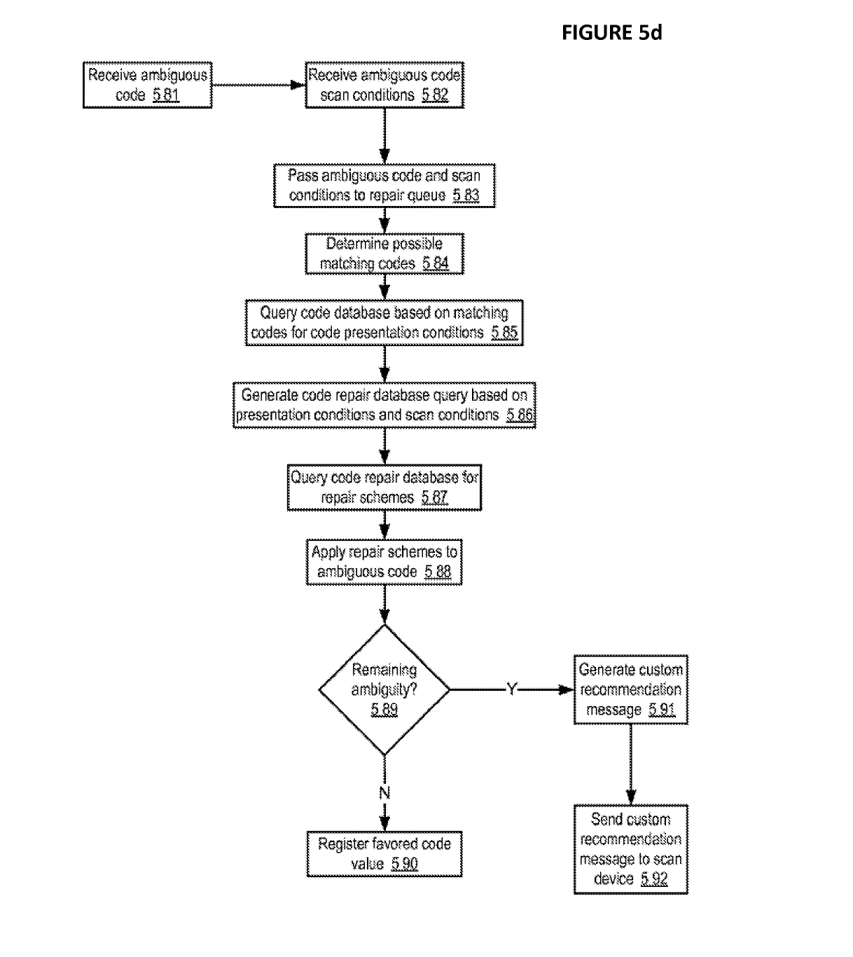

Scannable codes may be found in a variety of locations, including but not limited to newspaper and magazine articles, signs and billboards, flyers, store locations and kiosks, consumer products, packages, clothing, stickers, websites, software displays, television broadcasts, virtual worlds, and/or the like. The nature of the code and associated method with which the code can be scanned will depend to some extent on where the code is found, but among the possible types of codes are standard barcodes (e.g., UPC, EAN, Code 128, etc.), 2D matrix codes (e.g., QR code, Semacode, Data Glyphs, mCodes, etc.), user-input codes (e.g., text messages), RFID tags, NFC tags, pure images (e.g., an image of a sign to be analyzed by optical character recognition), website links, software inputs, and/or the like. These codes may be located on any medium (e.g., on newspapers, magazines, books, video content, computer screens, embedded in objects (e.g., RFID tags on clothes, etc.), and/or the like). In virtual worlds, the “code” may be the virtual artifact/object within the 3-D VR environment. One embodiment employs 2D matrix codes, examples of which are provided in FIG. 5a, due to their large data capacity, ease of scanning, and resilience to damage or error. These examples include QR codes 500, Mcodes 505, Semacodes 510, and/or the like.

### Code Enhancement

In scanning a code, the code image may not always be recorded faithfully and/or in an ideal and/or suitable condition for decoding and/or matching to associated content. Consequently, the CTIS may be configured to enhance and/or otherwise process a code image in order to better recognize the code. FIGS. 5b-c show implementations of logic flow for processing and/or managing non-ideal code scans in embodiments of CTIS operation. In FIG. 5b, a scanned code is received at the CTIS server (513) and a first attempt is made to decode a received code scan (515). In one implementation, a received code scan may take the form of a bitmap image and/or a compressed bitmap image. If the decoding is successful (520), then the code is matched to associated content (525) that is ultimately destined to be served to a user. Otherwise, a determination is made as to whether enhancement should be applied to the scanned code (530). If not, then an error message and/or suggestions on how to improve the quality of the scanned code may be returned to the user (535). The CTIS may decide not to apply enhancement, for example, if enhancement has already been applied unsuccessfully to the same image before or if the quality of the image is so poor as to be clearly beyond improvement. If enhancement is to be applied, then the CTIS determines the appropriate enhancement type (540) based, for example, on the quality and character of the scanned code image and subsequently applies the enhancement (545), after which a new attempt is made to decode the scanned code.

In some implementations, multiple enhancement processes may be applied against a scanned code and the results compared in order to determine the encoded content. Prior to enhancement, the image may be downsized if necessary for speed of processing in applying multiple enhancements against the image. Image quality may also be increased if necessary in order to more successfully apply enhancements. For code images having extraneous information and/or noise, an enhancement process may be applied to remove all extraneous information, despeckle, and/or the like. For code images having shades of gray and/or shadows obscuring the encoded content, an enhancement process may be applied to manipulate the contrast and/or brightness of the image in order to create a pure black and white image for cleaner decoding. For code images that are tilted and/or not taken flat in a plane, an enhancement process may be applied to tilt the plane of the code to create a flat plane to aid in successful decoding. For code images that are rotated or skewed, an enhancement process may be applied to de-rotate, deskew, and/or otherwise recreate proper rectangular pixel groupings that can be decoded. For code images that are taken out of focus, an enhancement process may be applied to sharpen the image into recognizable pixel groupings. Additionally, the CTIS may apply edge recognition processes to the code image to create a set of potential code images that can be processed and compared to records in a code database.

### Partial Decoding

In some cases in which full decoding of a scanned code image is impossible, a partial decoding may be accomplished and serving of content achieved on that basis. A partial decoding may, for example, result in a probabilistic code match without ever successfully decoding the complete code. FIG. 5c shows an implementation of logic flow for partial decoding in one embodiment of CTIS operation. A scanned code image is received (548), partially decoded (550), and the partially decoded content used to query a code database to find matching codes (555). A determination is made if any matches exist (560) and, if not, then the CTIS may return an error message to the user and/or make suggestions about how to improve the image of the scanned code (565). If a match is found, however, then a determination is made as to whether there are multiple matches (570). If so, then the CTIS may consider ancillary factors (575) in attempting to isolate a single code as the most likely match to the received code. Such ancillary factors may include, but are not limited to: the incoming phone number, the carrier, the time of day, current code traffic, the source of the code, the context of the code, the user ID, the hardware ID, the user behavioral history, the user location, the current 3-D VR environment, and/or the like. In considering ancillary factors, the CTIS is thus capable of predicting the true code based on knowledge of the user scanning the code, the context of the code, ambient factors, and/or the like. Once a unique code has been identified, this is designated as the matching code (580) and the CTIS proceeds with determining the appropriate associated content to serve to the user.

In an illustrative example of partial decoding, a given matrix code may encode the string ABC123. In multiple processes, it may be determined that the code contains A_{—}1_{—}3 (where the blanks represent unknown values), _C1_, and AB_. Through these multiple processes, the CTIS system now knows that the code contains ABC1_{—}3 and may check this against codes in a code database to determine how many matches exist. If it finds two matching codes (e.g., ABC 123 and ABC143), it may consider ancillary factors. For example, ABC123 may correspond to an advertisement for a new action movie while ABC143 corresponds to a coupon for women's cosmetics. If the user supplying the code is determined, based on a supplied user ID, to be a man with a history of scanning movie-related codes, then the CTIS system may infer that ABC123 is the matching code and serve the corresponding content. In one implementation, the CTIS server may further supply a confirmation request for partially matched codes, requesting the user to affirm or deny that the supplied content is, in fact, the content that he or she was seeking.

### Outcome Message Data Structure (115)

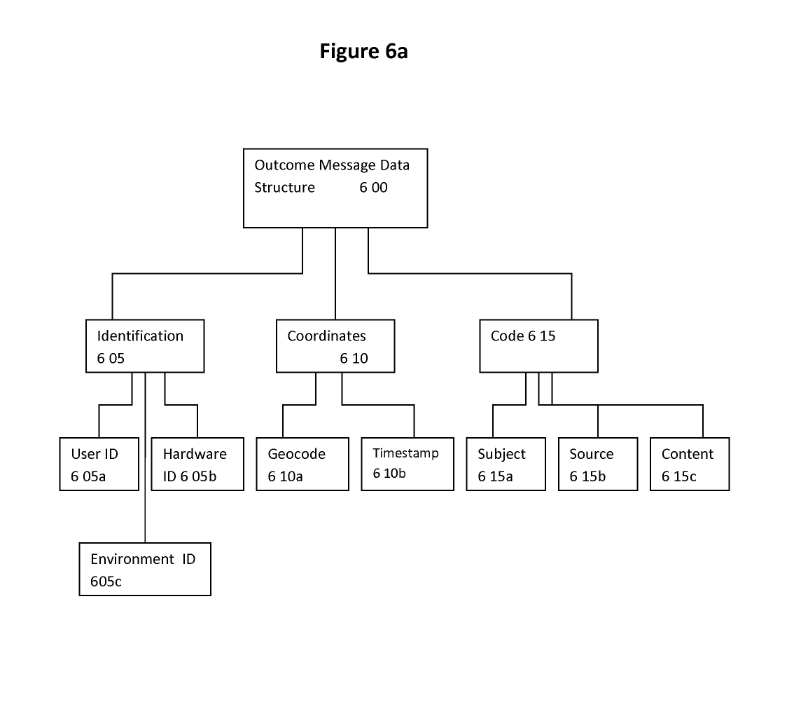

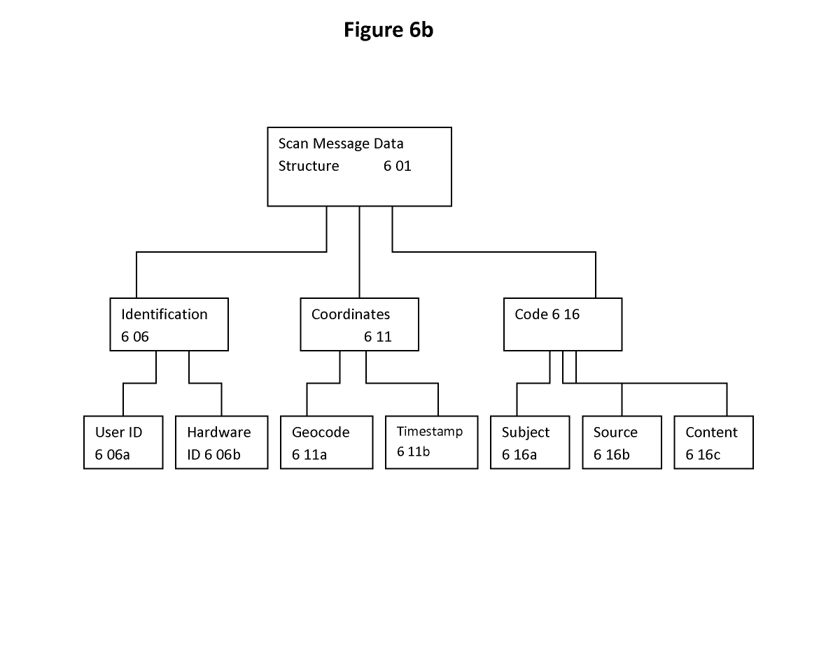

The Outcome Message (600) is, itself, a novel data structure. In one embodiment that is illustrated in FIG. 6a, it contains an identification field (605) comprising a unique user ID (605a), a hardware ID (605b), and an environment ID (605c), each automatically supplied by the device used to interact with and transmit the outcome of the ad environment; a coordinate field (610) comprising the location geocode (610a) (e.g., GPS coordinate, latitude and longitude, city and state, etc.) and timestamp (610b) of the user's interaction with the ad environment; and a code field (615) supplying the specific content of the ad environment, which may include a subject code (615a) for the ad context, a source code (615b) indicating where the ad was located, and a content code (615c) indicating the specific information, if any, to be supplied in response to the outcome of that environment. In 3-D VR environment embodiments, the location geocode and/or timestamp may be virtual world geographic and/or temporal information.

### Scan Message Data Structure (172)

The Scan Message (601) is, itself, a novel data structure. In one embodiment that is illustrated in FIG. 6b, it contains an identification field (606) comprising a unique user ID (606a) and a hardware ID (606b), both automatically supplied by the device used to scan and transmit the scanned code; a coordinate field (611) comprising the location geocode (611a) (e.g., GPS coordinate, latitude and longitude, city and state, etc.) and timestamp (611b) of the scan; and a code field (616) supplying the specific content of the scanned code, which may include a subject code (616a) for the code context, a source code (616b) indicating where the code was located, and a content code (616c) indicating the specific information, if any, to be supplied in response to a scan of that code. In 3-D VR environment embodiments, the location geocode and/or timestamp may be virtual world geographic and/or temporal information.

In one embodiment, the XML for the Scan Message takes the following form:

<Scan_Message>
<ID>
<User ID> 012345 </User ID>
<Hardware ID> Nokia 660 </Hardware ID>
</ID>
<Coordinates>
<Geocode> GPS 40 46.516 −73 57.98 </Geocode>
<Timestamp> 08/21/2006 13:45:28 </Timestamp>
</Coordinates>
<Code>
<Subject> entertainment; movies; comedy </Subject>
<Source> New York Times </Source>
<Content> Showtimes for latest popular comedy movie </Content>
</Code>
</Scan_Message>

### Data Transmission

In one embodiment, sending and receiving the Outcome Message, Scan Message, Environment Message, and Reward Message will employ standard data transmission techniques to ensure successful transmission and to preserve data integrity (e.g., TCP/IP, 1xEV-DO, etc.). This is relevant for the Scan Message, which will contain the coded information scanned by the user. Such techniques may include but are not limited to the use of standard transmission protocols, “handshaking,” data compression, data encryption, and/or error correction.

### User Profile Structure (130)

The content of the user profile generated by the CTIS is itself a novel data structure. In one embodiment illustrated in FIG. 7a, the profile (700), which is uniquely specified by the user ID, will contain a category of quasi-static user information (705) that is generally fixed over time and one of dynamic user information (730) that is updated with each successive Scan Message that the user submits. The user profile may exist along the 3-D VR environment or coupled to the 3-D VR environment. The quasi-static info (the “quasi” qualifier indicates that this information may be updated, for example if a user changes their mobile device, however it does not change with each successive code scan) may include a hardware ID (710); “census” info (715) such as name, address, phone number, e-mail address, age, sex, race, marital status, number and age of children, job title, annual income, etc.; subjects of interest specified by the user (720); and information regarding allowed methods to contact the user (725). In one embodiment, this information could be supplied by the user when registering for the CTIS service as, for example, on a website. The dynamic info in the profile may include a scan record (735), comprising the time (740), location (745), and scan code (750) (including subject (750a), source (750b) and content (750c)); an Outcome Record (751), comprising stored/submitted outcomes for interactions with ad environments by the user; the Ad environment content (759); and statistics related to the scan or capture history (755). Such statistics may include but are not limited to the most popular scan subjects, most popular scan sources, user space-time trajectories, avatar space-time trajectories, etc. In one embodiment, the profile contains a series of identifying codes distilled from the profile content (e.g., demographic category code based on census info, subject codes, source codes, etc.) that can be compared with similar codes in the Scan Message to determine the appropriate ad environment content to include in the Environment Message. In an alternative embodiment, the profile contains identifying keywords or “tags” based on the profile content that can be compared with similar tags in the Scan Message to determine the appropriate content to include in the Environment Message. In both cases, the identifying labels for the user profiles may be input by CTIS administrators or automatically generated by an appropriate computer algorithm such as stripping header labels from Environment Messages or Ad descriptions (e.g., for example, stripping the header tags from an HTML ad).

In one embodiment, the XML for the User Profile may take the following form:

<User>
<Quasi-static info>
<User_ID>123-45-6789</User_ID>
<Hardware ID> Nokia 660 </Hardware ID>
<Census info> John Smith; 123 Maple Dr., Smalltown, CA 92676;
(123)456-7890; jsmith@email.com; 55 years; male; white; married;
2 children; etc.
</Census info>
<Interests> camping; fishing; classic cars; movies; etc. </Interests>
<Contact restrictions> Weekdays 8 AM - 7 PM only </Contact
restrictions>
</Quasi-static info>
<Dynamic info>
<Scan record>
<Scan_#1>
<Time> 08/21/2006 13:45:28 </Time>
<Geocode> GPS 40 46.516 −73 57.98 </Geocode>
<Code>
<Subject> entertainment; movies; comedy </Subject>
<Source> New York Times </Source>
<Content> Showtimes for latest popular comedy movie </Content>
</Code>
</Scan_#1>
<Scan_#2>
etc...
</Scan_#2>
etc...
</Scan record>
<Scan statistics>
<Popular subjects> entertainment; cars; travel; etc. </Popular
subjects>
<Popular sources> New York Times; Car and Driver; CNN.com;
etc. <Popular sources>
<Trajectories> Data files listing time and geocode coordinates,
computed average trajectories, likely locatons, etc. </Trajectories>
etc...
</Scan statistics>
</Dynamic info>
<Code>
<Subject> entertainment; movies; comedy </Subject>
<Source> New York Times </Source>
<Content> Showtimes for latest popular comedy movie </Content>
</Code>
</User>

In one embodiment, data accumulated in a plurality of user profiles may be analyzed to extract information about codes that are scanned, or to extract information about rewards from submitted outcomes. For example, the frequency with which a particular code is scanned may be extracted from user profiles and parsed by geographic, temporal, and/or demographic criteria to yield code profiling information. This information may be stored in a code and/or SMS profile. In an alternative embodiment, the code/Ad profile may be constructed and/or updated by the CTIS immediately upon the receipt of a Scan Message rather than being extracted from user profiles. In outcome analysis embodiments, the user's outcome(s) may be compared or ranked against the outcomes of a plurality of other users, such as in a high score table. This analysis can influence the reward content that is delivered to the user, such as by providing enhanced rewards for being in the top outcomes for a specified period (e.g., hour, day, week, etc.).

### Information Base

### Rewards, and Labels—Searching

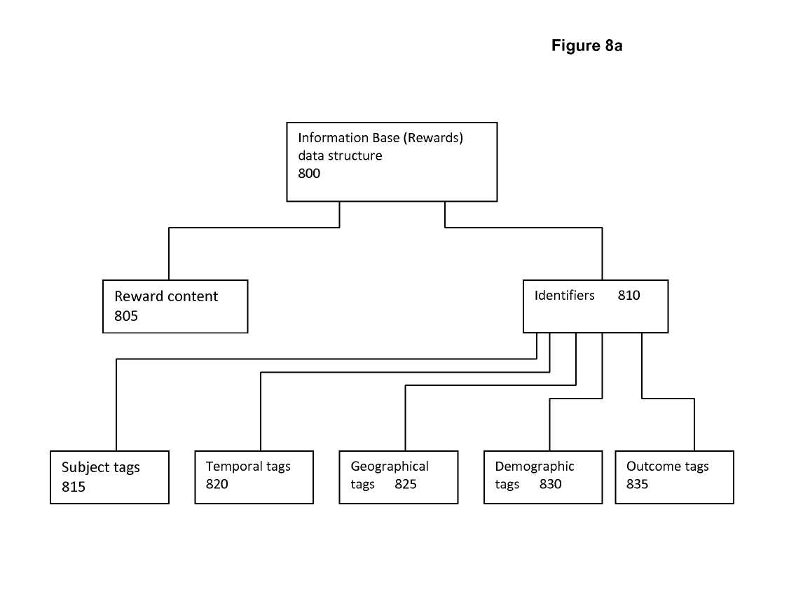

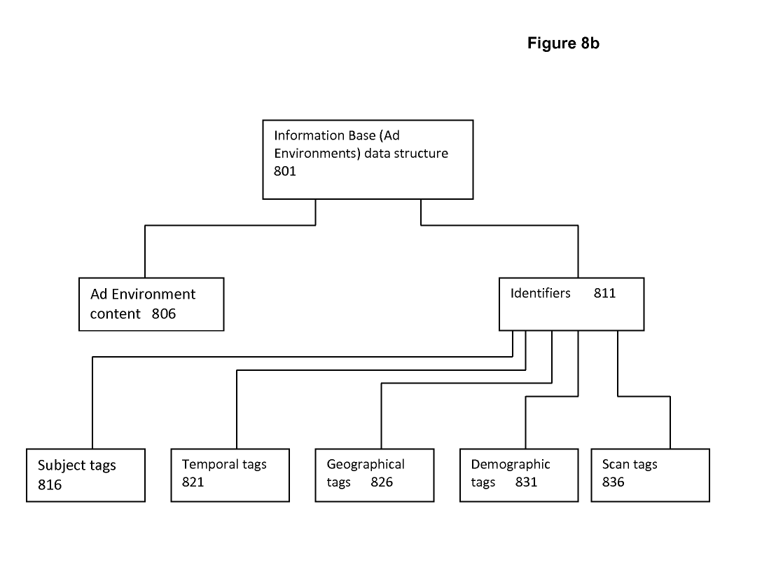

The Information Base contains the content that may be included in the Reply/SMS Message or Reply/SMS Message or Ad sent to the user and may be stored on the CTIS central server or on third party servers accessed by the CTIS. In one embodiment, each Reply/SMS message or Reply/SMS Message or Ad is associated with searchable labels. The Reply/SMS Message or Ad content together with its labels, collectively referred to here as an Ad, forms a novel data structure. In one embodiment illustrated in FIG. 8a, the Reward Message (800) is comprised of the specific Reward content (805) (e.g., coupons, promotions, offers, badges, signifiers, gift cards, promotional credits, vouchers, text, images, video, etc.) and a set of identifiers (810) including subject tags (815), information characterizing the temporal character of the Reward based on which the Reward Message may be triggered (820) (e.g., 6 to 10 AM for a breakfast Ad), information characterizing the geographic specificity of the Reward based on which the Reward Message may be triggered (825), demographic specificity of the Reward (830) (e.g., a Reward for family vacations), and the hardware requirements of the Reward Message (835) (e.g., hardware IDs of devices capable of displaying the content of a particular Reward). In one embodiment, the Reward Message would also contain information identifying the source in which the Reward Message is to appear. In another embodiment, the Reward Message would also contain code/Reward profile data, describing the history and/or statistics of scans related to the Reward.

In one embodiment, the XML for a Reward message may be in the following form:

< Reward message>
< Reward message_ID>123</ Reward message_ID>
< Reward message content>
coupons, promotions, offers, badges, signifiers, gift cards, promotional
credits, vouchers, text, images, video, etc.
</Reward message content>
<Identifiers>
<Subject> hidden object game </Subject>
<Temporal> 08/21/2006; 12:00:00 to 14:00:00 </Temporal>
<Geographic> Smalltown, CA 92676 </Geographic>
<Demographic> 17 years and older </Demographic>
<Hardware> video display, touch screen </Hardware>
</Identifiers>
</ Reward message>

### Static Content and Dynamic Content in Reply

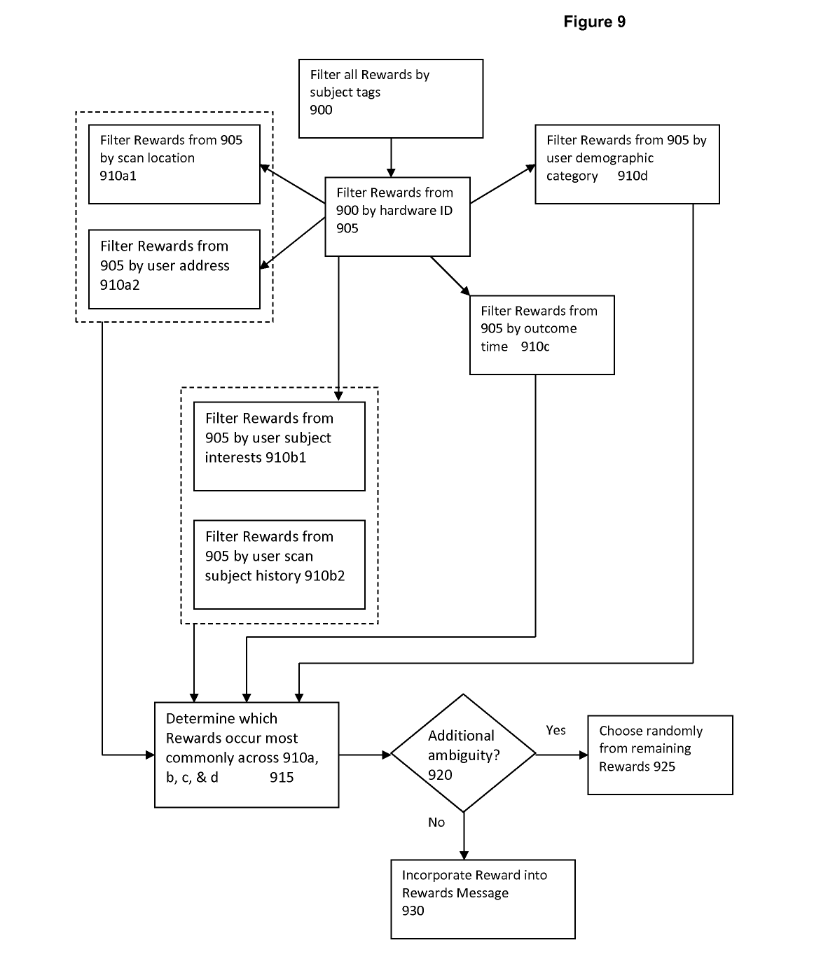

The CTIS queries the user profile to determine which Reward Message to include from the Information Base in the Reward Message in order to tailor those Reward Messages to the user's profile characteristics, interests, and trajectories. In one embodiment, an outcome will yield two components in the Reward Message content: i) static content that is the same for every user who has the outcome, and ii) dynamic content that depends on the context of the user and the user profile. The static content (i) is determined from the outcome, while the dynamic content (ii) is determined by a combination of the outcome and the user profile, requiring a dynamic content generation heuristic to combine their respective influences. While a variety of such heuristic are possible and contemplated as being within the scope of this disclosure, and the specific heuristic employed in a given realization will likely depend on the precise application and intention, we discuss one embodiment of this heuristic here for illustrative purposes with reference to FIG. 9. An example of one embodiment of heuristic useful with the embodiments disclosed herein is found in commonly owned U.S. Published Application No. US20110264527A, which is hereby incorporated by reference. Some other possible methods may include alternative ordering of filters, addition or removal of filters, weighted filtering, complex conditional trees, and/or the like. In one embodiment, the outcome and user profile is labeled with keywords or “tags” that identify the subject content of each. In an alternative embodiment, the outcome, user profile, and Reward Message are labeled with identifying codes. In either case, the heuristic exhibited in FIG. 9 first filters all Rewards in the Information Base by the subject code or tag of the outcome (900). The Rewards from 900 are filtered by the hardware ID (905) to ensure that the Reward content can be successfully acquired and displayed by the user. The hardware ID encompasses 3-D and 3-D VR capabilities. The Rewards from 905 are filtered into separate categories by scan location (910a1), user address (910a2), user specified subject interests (910b1), user scan subject history (910b2), outcome time (910c), or user demographic category (910d). Rewards in each of these filtered categories are compared to determine which occur most commonly across 910a, b, c, & d (915). The server determines if 915 has yielded a single Reward (920), and if so, it incorporates the Reward content into the Rewards Message (930). Otherwise, it chooses one Reward at random from the remaining Rewards (925) for incorporation in the Rewards Message. It must be emphasized again that this is but a single, specific embodiment of the user profile query heuristic intended for illustrative purposes. The heuristic is highly flexible and can be finely tuned for the specific application at hand. Some other possible methods may include alternative ordering of filters, addition or removal of filters, weighted filtering, complex conditional trees, and/or the like.

### Relevance Rating

In one embodiment, the user may respond to the Rewards Message with a relevance rating. This rating may then be stored in the user profile and/or employed to refine the criteria for tailoring future Rewards Messages to that user.

In one embodiment, the Rewards would not be filtered by hardware ID at 905. Rather, when a final Reward has been selected for inclusion in the Rewards Message following filtration under the other relevant criteria, the server will determine whether that Reward is properly formatted for the device specified by the hardware ID. If so, then the Reward will be included in the Rewards Message as is. Otherwise, it will be converted into the required format appropriate to the user's mobile device. For example, if the selected Reward contains color images but the server determines that the user's hardware device is an early model BlackBerry that only accommodates monochromatic text, the server will implement a peripheral application to strip the text content from the Reward and incorporate only that in the Rewards Message.

### Non-Triggered Environment Messages or Ad Serving

Though Environment Messages served by the CTIS are determined by codes scanned at some time in the past, it is possible for the CTIS to serve Environment messages without any immediately contiguous, causal code scan. A general illustration of this capability was given above in FIG. 3A, where each 3^{rd} party provider has specific geographic locations of operation. These are assumed to be stores/restaurants for the present purposes of illustration in this disclosure, but they may have different character for different embodiments and applications, including but not limited to kiosks, signs and billboards, offices, hospitals, real estate, shelters, emergency service providers, traffic monitors, individuals, websites, virtual world locations, and/or the like. A chosen distance surrounding each 3^{rd} party provider location defines a “provider zone,” where the metric by which “distance” is gauged may be generalized in the case of cyberspace/virtual world locations. A provider zone breach occurs when a user scans a code within a provider zone. This may be regardless of the content of the scanned code, for in this example the goal is to record the user's space-time position. In an alternative embodiment, a provider zone breach can be registered even if a user does not scan a code within the provider zone, if the CTIS can infer a breach from two or more code scans outside the provider zone through interpolation. When such a provider zone breach occurs, a special note may be incorporated into the user profile, such as in the Scan statistics module (755), indicating the time and the particular Environment Message or Ad provider.

In an alternative implementation, the CTIS may be configured to automatically query a user position without scanned codes. For example, a user's mobile device may be configured to periodically register its GPS location with the CTIS system. In another implementation, the CTIS may be able to continuously monitor the position of a client mobile device based on the cell site or tower to which the device is communicatively coupled. Cell site based user location may also be registered when a user scans a code.

Alternatively, a user employing an avatar in a 3-D VR environment could receive the message or coupon just be interacting with a product or service in a “virtual provider zone”, and not necessarily requesting or scanning info on the product or service, as shown in FIG. 3B.

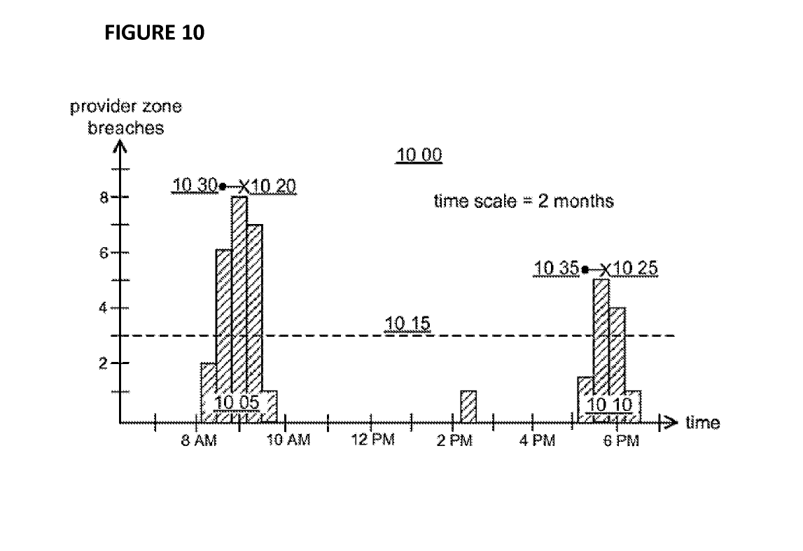

From an accumulated record of these breaches, data of the form of FIG. 10 can be determined. FIG. 10 shows a histogram (1000) of provider zone breaches in 20 minute intervals for a particular user over a chosen time scale, which we will take to be two months in this example. In one embodiment, such histograms will correspond to breaches of specific Ad Environment provider locations; while in an alternative embodiment, they will correspond to breaches of any of a plurality of locations corresponding to a specific Environment Message or Ad Environment provider; while in still another embodiment, they will correspond to breaches of different locations of related but different Environment Message or Ad Environment providers, chosen to target a specific collective user demographic. In this exemplary histogram, the significant provider zone breaches (those exceeding the threshold) are clustered around two times: one approximately centered at 9 AM (1005), and the other at 6 PM (1010). This may represent, for example, a user scanning codes as he passes the same Environment Message or Ad Environment provider location while riding a bus to and from work. In one embodiment, a threshold breach level (1015), indicated in FIG. 10 by a horizontal dotted line, is specified such that all breaches below this threshold number are ignored. This threshold level should be specified with respect to the time scale of the histogram; in the present example, the threshold is 3 breaches per two month period. The average peak times (1020, 1025) of the breach clusters that exceed this threshold are computed (marked by X's in FIG. 9), and a time is chosen prior to those averages (1030, 1035) to serve an appropriate Environment Message or Ad Environment to the user. In one embodiment, provider zone breaches could be sorted by scan subject, so that a histogram of the form of FIG. 10 could be constructed for a specific category of scans in order to further tailor the supplied Environment Message or Ad Environment content.

### Trajectories in Cyberspace-Time

In another embodiment, the system may be generalized to analyze trajectories in “cyberspace-time.” In this embodiment, a record of trajectories is kept of the user's activity on the world wide web as browsed, for example, on the user's internet enabled mobile device. A generalized concept of “distance” may be incorporated, for example reflecting an average number of links needed to get from one website to another. Provider locations become websites in this embodiment, and a zone breach may be registered when the user is a specified number of links away from the provider's website. Then, just as before, the CTIS can anticipate user cyberspace-time trajectories and supply Ad Environments, coupons, pop-ups, etc. related to websites that the user is approaching. For example, the CTIS may track that a user visits web site A at 9:00 AM and web site B at 9:20 AM every day. The CTIS may then provide Ad Environments to website A at 8:50 AM and to website B at 9:10 that are targeted to that user. In an alternative embodiment, the CTIS may provide this targeting information to existing Ad Environment serving systems, which in turn may use the targeting information for timely placement of ad environments. The aggregation of such targeting information, in particular, may be useful to advertisers and website owners. For example, reports may be run on user profiles sorted by location (e.g., websites) and time of visit. This information may be supplied, along with user profile IDs, which may then be used by the advertising servers and/or websites to pre-cache Environment Messages or Ad Environments that are relevant to the users' interest just prior to their anticipated visits to the website. As such, the CTIS works in conjunction with certain websites to supply user-specific Environment Messages or Ad Environments on those sites. As a result, the content of the user profile within the CTIS may be used to select Environment Messages or Ad Environments that the user browses using their mobile device. In an alternative embodiment, web-based Environment Messages or Ad Environments may be specific to the trajectories of users in geographic space-time, since that information is included in the user profile. For example, if a user is known to be passing by a coffee shop at a specific location and time every day (e.g., a coffee shop on 123 Main Street, NY, N.Y. at 9:00 AM), and is also know to visit a specific website at that time (e.g., at 9:00 AM the user visits website C reading the daily news on their walk to work), then the system may provide the user with Environment Messages or Ad Environments directly to their PDA or embedded in website C (because it was pre-loaded as already discussed) for the coffee shop. As such, the CTIS provides a mechanism to provide geographically relevant Environment Messages or Ad Environments to traditional websites. In yet another embodiment, the total content of the websites browsed by a user on their mobile device may be modified by the content of the user profile within the CTIS. For example, a news website may select articles for a user that are specific to the user profile, including their interests, demographics, current time and location, etc.

### Virtual Space

In another embodiment, the CTIS may analyze the user trajectories in “virtual worlds” or “synthetic realities” and serve Environment Messages or Ad Environments accordingly. An example of a virtual world is a massively multiplayer online game, such as The Sims Online, EverQuest, World of Warcraft, Second Life, and/or the like. In such a virtual environment, a code scan may be comprised of a particular user action or decision such as initiating or completing a game mission, clicking on an icon or other digital image, saving a game, etc. In such virtual worlds, geographies and virtual locations may be used in employing trajectories. The history of user activity within the virtual world may then be incorporated into the user profile and used by the CTIS to serve Environment Messages or Ad Environments within the context of the virtual world or elsewhere. For example, in games like Second Life, virtual televisions, billboards, kiosks, clothing, etc. may be used as advertising delivery mechanisms.

### Selecting Environment Messages or Ad Environments

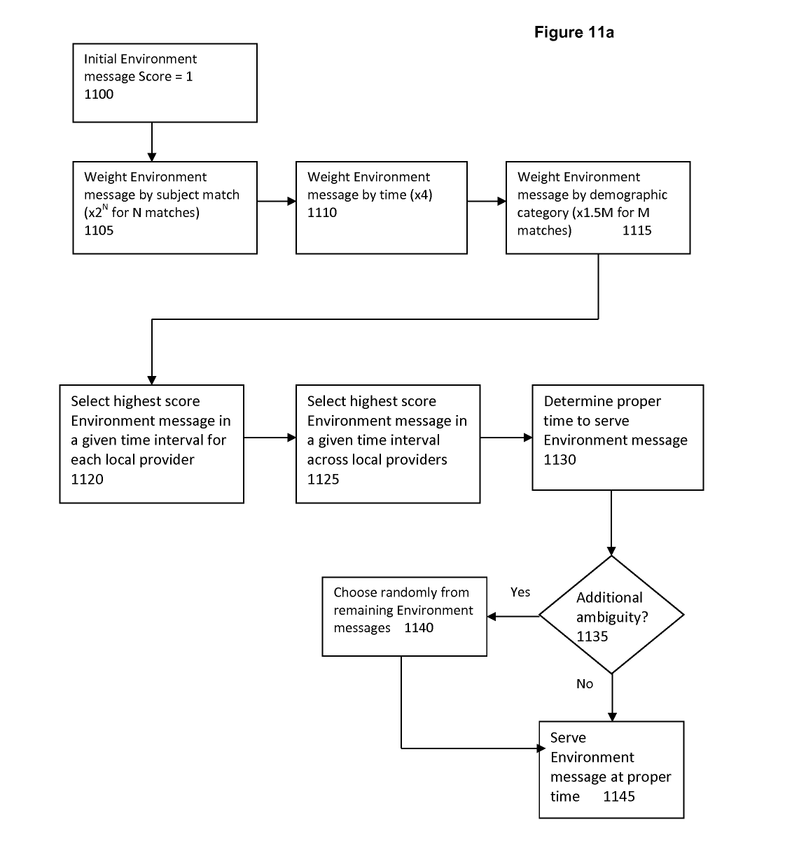

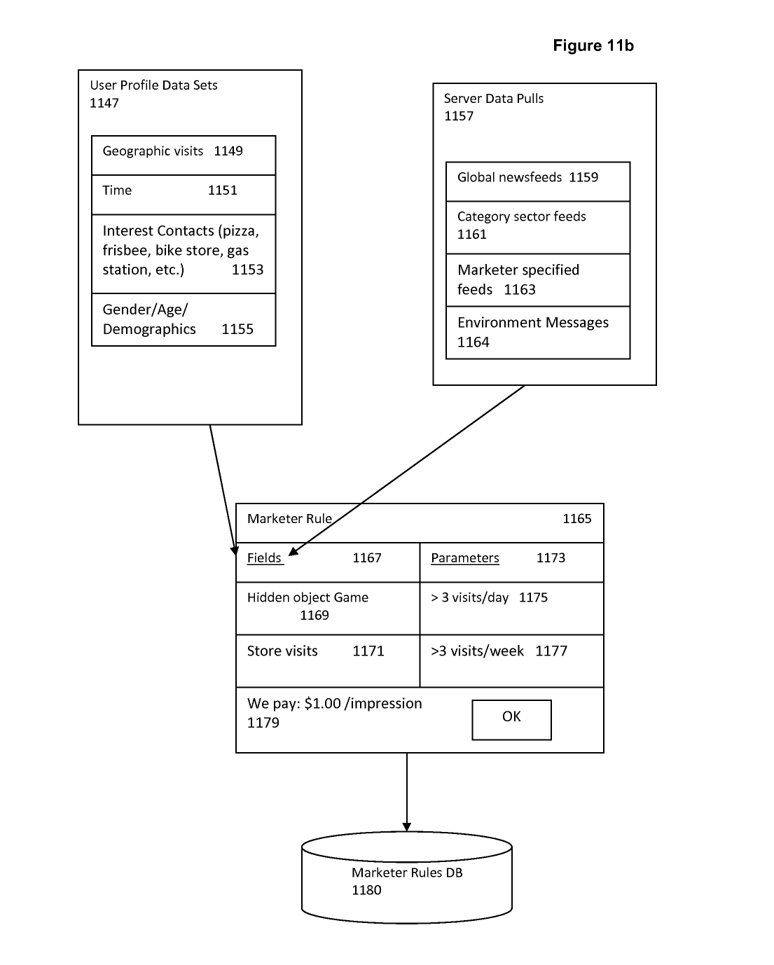

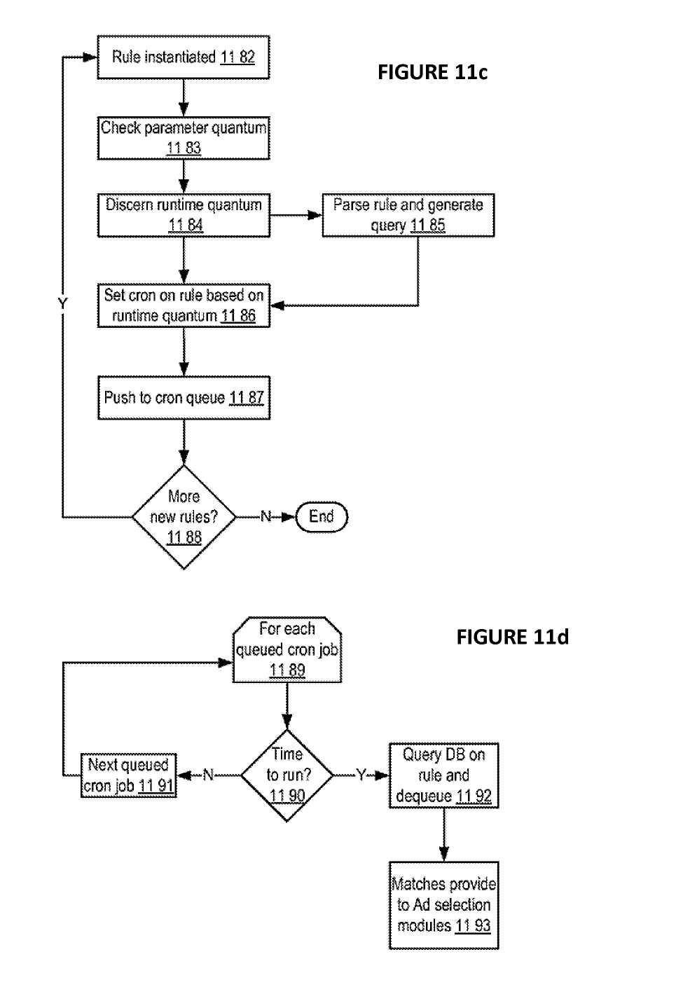

Selecting the proper Environment message to serve to the user in the non-triggered serving embodiment of the CTIS may be accomplished using a variety of heuristics that are best tailored to suit the specific use or application. Nevertheless, we present an example of a specific embodiment in FIG. 11a for illustrative purposes. In this embodiment, a weighting system may be employed to select among the Environment Messages or Ad Environments of a specific Environment Message or Ad Environment provider once it is established that an Environment Message or Ad Environment from this provider is to be served to the user based on the analysis of FIG. 10. This weighting system begins by assigning a score of 1 (1100) to all Environment Messages or Ad Environments in the Information Base corresponding to the provider. This score is multiplied by a subject coefficient (1105) for every match between the Environment Message or Ad Environment subject and the user specified subject interest or scan subject history. That coefficient is 2 in the present example, so N matches would yield a weighting factor of 2^{N}. The Environment Message or Ad Environment score may also be multiplied by a time coefficient (1110) if the serving time (1030 or 1035) falls within a time range specified for a particular Ad Environment. In the present example, the time coefficient is 4, expressing the greater importance of this factor compared to a single subject match. Finally, the Environment Message or Ad Environment score may be multiplied by a demographic coefficient (1115) for every match between the Environment Message or Ad Environment demographic category and that of the user. That coefficient is 1.5 in the present example, reflecting the diminished importance of this factor compared to the time and subject considerations. M demographic category matches will yield a weighting factor of 1.5^{M}. Once all of the 3^{rd} party or Ad Environment provider's Environment Messages or Ad Environments are scored in this fashion, those Environment Messages or Ad Environments with the highest scores for that provider may be selected over the rest (1120). Similarly, the highest scoring Environment Messages or Ad Environments from other providers are selected and the highest scoring Environment Messages or Ad Environments over all providers can be selected to serve for a particular time interval (1125). Finally, the proper time to serve the Environment Message or Ad Environment (e.g., 30 minutes prior to the expected average provider zone breach time) is established (1130) and, if there is no further ambiguity (1135), the proper Environment Message or Ad Environment is served at that time (1145). Any residual ambiguity may be resolved by selecting randomly from the remaining Ad Environments.

As a specific example of how this might work, we assume that the histogram (1000) of FIG. 10 represents provider zone breaches for a fast-food restaurant that a user passes on his way to and from work. An Environment Message or Ad Environment in the restaurant's base of provided Environment Messages or Ad Environments matches the user's stated interest in gourmet coffee, and this Environment Message or Ad Environment is further labeled by a time identifier indicating that it is best served between 8 AM and 10 AM. Consequently, at 30 minutes before the user's average breach time of the provider's zone, the server supplies the Environment Message or Ad Environment to the user's mobile device, touting this restaurant's new line of gourmet coffee drinks Alternatively, the user's profile may specify that he is married with two children. This matches the demographic category of an Environment Message or Ad Environment in the provider's base which is also labeled by a time identifier indicating that it is best served between 5 PM and 8 PM. As a result, 30 minutes before the user breaches the provider's zone on his way home from work, the server supplies the Environment Message or Ad Environment to the user's mobile device, touting their family-pack of hamburgers.

### Marketing Rules

In an alternative embodiment, the CTIS may be configured to receive and implement marketer rules for serving Ad Environments. FIG. 11b shows a schematic illustration of data structures related to establishment of a marketer rule for Environment Message or Ad Environment serving in one embodiment of CTIS operation. A user profile data sets (1147) may include a variety of data fields related to user activities, interests, characteristics, and/or the like, such as but not limited to: geographic visits (1149), as may be recorded by code scans; time (1151) associated with code scans; interest contacts (1153), such as may be reflect the user's interests and may be based on the context and/or associated content of scanned codes; gender, age, demographic, and/or other personal information (1155); and/or the like. Server data pulls (1157) may reference one or more data feeds to which the CTIS server has access in order to draw information that may be pertinent to marketer rules and/or Environment Message or Ad Environment serving procedures. A wide variety of different types of feeds may be accessible, including but not limited to: global newsfeeds (1159), such as associated press wire services, weather information, sports scores, political and social events, financial market data, and/or the like; category sector feeds (1161), such as more specific and/or special interest news feeds; marketer specified feeds (1163); Environment Messages or Ad Environments (1164) and/or the like. A marketer rule (1165) may be established by selecting one or more fields (1167) from the user profile data sets (1147) and/or the server data pulls (1157) and supplying associated parameters (1173) and/or parameter values associated with those fields. In the illustrated implementation, the rule associates a hidden object game field (1169) with a parameter specifying more than three website visits per day (1175). In addition, the rule associates a store visitation field (1171) with a parameter specifying more than three visits per week (1177). If both of these conditions are deemed true for a given CTIS user, then the CTIS may serve one or more Environment Messages or Ad Environments selected for and/or associated with the marketer rule. A price-per-impression (1179) may be charged for each time that the Environment Message or Ad Environment is served to a user under the circumstances specified by the rule. In one implementation, a marketer may propose a price-per-impression when he or she creates the rule, which is then submitted to the CTIS and/or a CTIS administrator for approval. In another implementation, the CTIS may automatically generate a price-per-impression based on the rule and/or the marketer. For example, a fixed charge may be applied for each additional field and associated parameter added to the rule, as this refines the specificity with which the associated Environment Messages or Ad Environments will be served and increases the likelihood of transactional consummation. Once a rule is complete, it may be entered for storage and subsequent use in a marketer rules database (1181). It should be understood that the functionality described for this embodiment of the CTIS may be integrated or employed within any of the other CTIS embodiments described herein.

In one embodiment, the XML for the above marketer rule may take a form similar to the following:

<Rule>
<Rule_ID>123</Rule_ID>
<Rule_name> Oil Rule </Rule_name>
<Rule_owner> Environment Message or Ad Environments R Us
</Rule_owner>
<Condition1>
<Field1> Hidden object game</Field1>
<Parameter1> 3 or more store website visits/day </Parameter1>
</Condition1>
<Condition2>
<Field2> Store</Field2>
<Parameter2> 3or more store visits per week </Parameter2>
</Condition2>
<Ad_database> Store related Environment Message or Ad
Environments </Ad_database>
<Price>
<Amount> $1.00 </Amount>
<Contingency> Impression </Contingency>
</Price>
</Rule>

In one implementation, the elements of FIG. 11b may form the basis of a user interface for marketer rule generation. A marketer and/or other CTIS user may be presented with lists of user profile data sets (1147) and server data pulls (1157) that may be dragged and dropped to the marketer rule box (1165) to generate a marketer rule. When the parameter values have been specified and the rule is complete, the user may click OK to submit the rule and/or drag and drop the rule to a marketer rules database icon (1181).

FIG. 11c shows an implementation of logic flow for generating a rule queue in one embodiment of CTIS operation. A rule is instantiated (1182), and the CTIS server checks parameter quanta associated with the rule (1183). A runtime quantum is discerned for the rule (1184) to determine the timing for applying the rule. The rule is subsequently parsed to generate the appropriate query structure (1185), and the cron schedule for the rule is established based on the runtime quantum (1186). The rule may then be pushed to the cron schedule queue (1187), and a determination made as to whether there are any additional new rules to process (1188).

FIG. 11d shows an implementation of logic flow for cron job queue management in one embodiment of CTIS operation. The CTIS may monitor the cron job queue and, for each queued cron job associated with a rule that is next in the queue (1189), the CTIS may determine whether or not it is time for that particular cron job to run (1190). If not, then the CTIS passes to the next cron job in the queue (1191). On the other hand, if it is time to run, then the appropriate databases specified in the rule are queried, and the particular cron job is dequeued (1192). If the results of the database query match the rule criteria so as to require serving an Environment Message or Ad Environment impression to a user, then that match indication may be passed to Environment Message or Ad Environment selection modules in order to choose an Environment Message or Ad Environment to supply to the user. In one implementation, the marketer rule itself may uniquely determine an Environment Message or Ad Environment to serve. In another implementation, the marketer rule may determine a set or class of Environment Messages or Ad Environments to serve, from which a unique Environment Message or Ad Environment may then be randomly selected. In yet another implementation, as Environment Messages or Ad Environments may be selected from the marketer rule determined set or class of Environment Messages or Ad Environments based on a user profile.

It must be emphasized again that this is but a single, specific embodiment of the non-triggered Environment Message or Ad Environment serving procedure intended for illustrative purposes. The procedure is highly flexible and can be finely tuned for the specific application at hand. Some other possible methods may include different relative weighting factors, alternative weighting considerations, categorical filtering, consideration of the number of provider zone breaches above the threshold level, graduated consideration of the distance from the provider location, modified provider zone shapes, pattern recognition algorithms, artificial intelligence facilitation, and/or the like.

### Virtual World Embodiments

In embodiments, a user profile is used to provide information querying and serving in a virtual world. Such virtual worlds may include, for example, massively multiplayer online games like The Sims Online, Everquest, World of Warcraft, Second Life, and/or the like. Information and/or advertisement providers may use a code triggered information server to serve context, demographic, and behavior targeted information to users in a virtual world. Users, in turn, trigger the provision of information by scanning or observing codes or information, or by making decisions within a virtual world such as attempting a mission within a game, and/or the like. The triggers, together with virtual world geographic, temporal, and user-specific information, are obtained by the server that receives, processes, and records the message. Based on these messages and a user profile—which may include continuously updated user-specific behavior information, situational and ambient information, an accumulated history of triggers, and integration with outside database information—the server selects information to serve to the user in a virtual world from an information base. For example, a user in Second Life who likes modern clothing for his/her avatar may be presented with Environment Messages or Ad Environments on virtual billboards from advertisers of virtual in-game clothing stores that are near his/her virtual position. In another example, an advertisement tailored to a user's particular interests or behavioral patterns may be placed at a location within a virtual world that the user is known to routinely pass.

In one embodiment, the CTIS allows advertisers to supply product information in a virtual world to the consumers who would be most interested in such Ad Environments or Environment messages; this may be achieved by the CTIS selecting advertising content based on a combination of the context of the code that the consumer scanned, the consumer's stated interests as recorded in his/her user profile, the consumer's demographic profile, a decision made within a virtual world, situational information, and a record of scanned codes and/or virtual world decisions; these factors can be analyzed and employed by the CTIS for both user tracking and behavioral profiling/targeting. For example, a player in The Sims Online who frequently acquires new furniture for his/her virtual apartment and has a stated interest in modern art may be served advertisements for an actual furniture store that sells modern furniture and is near the user's geographic location following one such virtual furniture acquisition. In another example, a user in Second Life that likes modern clothing for his/her character may be presented with Environment Messages or Ad Environments on virtual billboards from advertisers of virtual in-game clothing stores that are nearby the user's virtual position (or offer a virtual transportation link that will instantly move the user's avatar to the virtual in-game store).

The CTIS delivers targeted Environment Messages or Ad Environments to users in a virtual world while simultaneously providing detailed customer tracking information to Environment Message or Ad Environment providers. The CTIS supplies Environment Message or Ad Environment providers with greater precision and focus to provide consumers with the information that is most relevant to their interests, behavioral patterns, and space-time and/or virtual world trajectories to maximize the possibility of consummating a transaction. In one embodiment, the CTIS is designed to allow advertisers to place Environment Messages or Ad Environments at virtual world locations at specific times of the day such as to increase the likelihood of garnering the attention of prospective customers. In another embodiment, the CTIS yields time and virtual world location resolved records of scans for the determination of coded advertisement visibility. In another embodiment, the CTIS provides rapid and evolving virtual world geographic and historical statistical profiling of user interest and coded advertisement quality. In another embodiment, the CTIS provides an expanded platform to supply large quantities of information and content with a minimal amount of publication space.

From the user point of view, the CTIS provides a mechanism by which, in exchange for officially registering interest and providing basic information, he/she can receive the most targeted solicitations, enhanced content, sales offers/coupons, and/or the like within a virtual world. User benefits include: relevant and targeted advertising; mobile context specific information; contiguous location and/or immediate event information; coupons and/or offers for many types of goods and services; and/or the like.

At the same time, the system grants the advertiser a powerful tracking tool, to monitor behavioral patterns of consumers on individual, demographic, temporal, and virtual world geographic scales. This allows, among other things, the deployment of anticipatory advertising: serving advertisements to users in anticipation of their locations and/or potential interests based on an accumulated history of user tracking data. Other Environment Message or Ad Environment provider benefits include: compilation of highly specific customer tracking information, including customer virtual world trajectories; virtual world location and/or time specific advertising; highly flexible coded advertising placement; quick and updated determination of coded advertisement visibility; and/or the like.

Of benefit to both users and Environment Message or Ad Environment providers is the fact that users improve the specificity of their Environment Messages with each successive scan, since each scan further refines the contents of the user profile. Users thus have a motivation to scan as many codes as possible related to subjects of interest and will thereby be exposed to more advertisements than in more traditional, passive advertising and marketing schemes.

Ad providers participate by contributing content to an Information Base that categorizes and labels that content under a number of considerations, such as subject matter, virtual world geographic and temporal identity, demographic specificity, and/or the like. Elements of the Information Base can then be compared via these labels with comparable labels found in a database of user profiles in order to match content with users via subject, virtual world location, time, demographic category, and/or the like. As such, the CTIS efficiently facilitates commerce by providing advertising to consumers with highly tailored specificity.

### Querying and Serving Information on the Internet

In an embodiment, the CTIS delivers information on the internet based on user activities, such as may be registered by codes scanned by mobile devices or website links selected on a computer, as well as user characteristics and an accumulated history of user activities. For example, information and/or advertisement providers may use CTIS to serve context, demographic, and behavior targeted information to users on the internet. In particular, information and/or advertisements are served on the internet that is targeted to the individual based on the individual's characteristic profile, behavioral patterns, and present contextual surroundings, either in real space of cyberspace. For example, a web-based advertisement may be provided on an internet enabled mobile device for goods and services located near a mobile user, which advertisement is selected based on the user's behavioral patterns and stated interests.

In one embodiment, the CTIS allows advertisers to supply product information on websites to the consumers who would be most interested in such ads; this may be achieved by the CTIS selecting advertising content based on a combination of the context of the code that the consumer scanned or the web link that the user selected, the consumer's stated interests as recorded in his or her user profile, the consumer's demographic profile, situational information, and a record of scanned codes or web links; these factors can be analyzed and employed by the CTIS for both user tracking and behavioral profiling/targeting. For example, a user with a stated interest in running and a recent pattern of scanning codes related to shoes may be served a web-based advertisement on his/her internet-enabled mobile device for a new running shoe being sold at a nearby shoe store. In another example, a user profiled to be a teenager and having a pattern of browsing websites related to comic books may be served a web-based Environment Message or Ad Environment for the newest comic book themed movie when he/she visits a movie-listings website

Users, in turn, trigger the provision of information by scanning or observing codes or information, or by selecting web links. The triggers, together with geographic, temporal, and user-specific information, are obtained by the server that receives, processes, and records the message. Based on these messages and a user profile—which may include continuously updated user-specific behavior information, situational and ambient information, an accumulated history of trigger messages, and integration with outside database information—the server selects information to serve to a user on the internet from an information base.

For example, a user with a recorded history of interest in coffee products may be served an advertisement for a nearby coffee shop while browsing the web on his/her PDA. In one embodiment, information may also be served to users on the internet based solely on the user profiles, and without any initiating trigger. This is based on user trajectories or web-surfing habits deduced from the accumulated history of triggers. For example, a user known to routinely visit a music vendor website near the same time each day may be served an advertisement for the latest top-selling CD shortly before that time.

### Reward Content Sharing

In another embodiment, the CTIS provides targeted rewards to consumers. By interacting with a game-like advertisement environment, a user may be provided with a coupon code for a store or establishment near the location where the advertisement environment was provided, thereby increasing the likelihood that the coupon would be used. Choosing the coupon based on the contents of the user profile may further increase the likelihood of a consummated transaction.

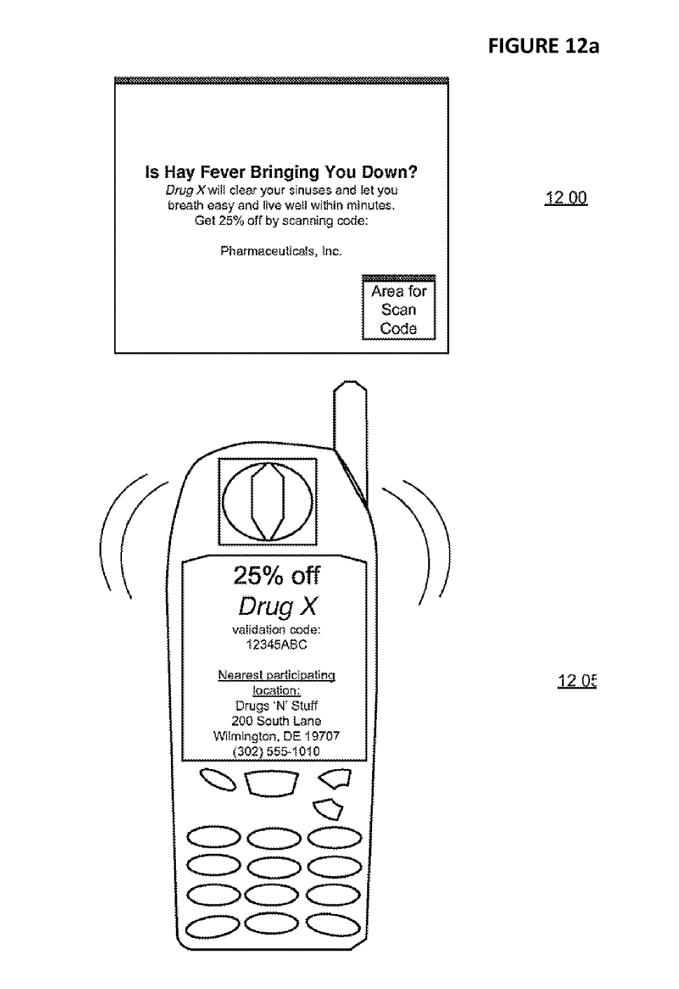

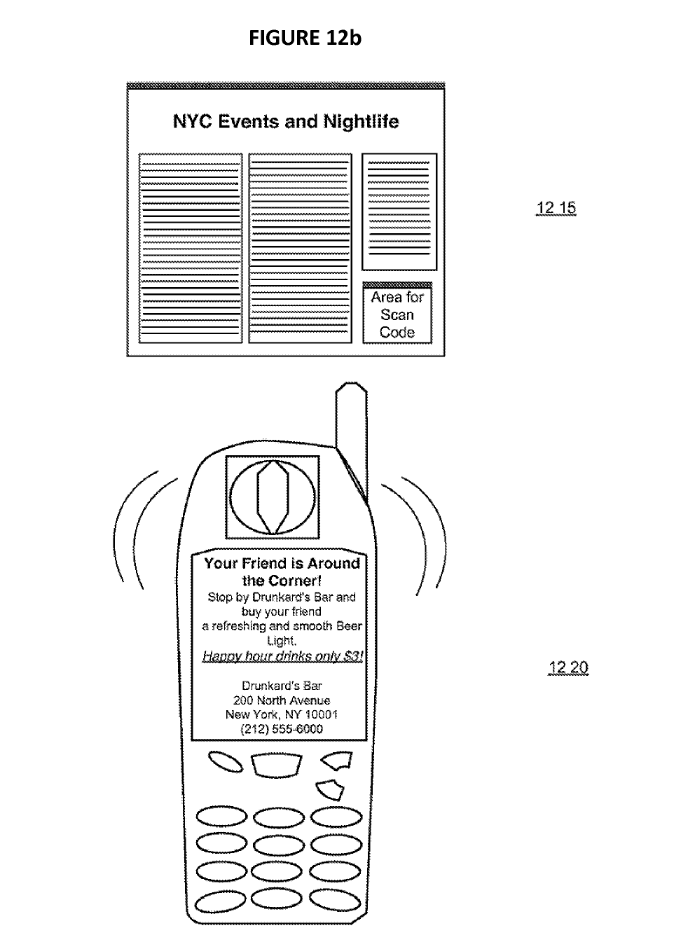

FIGS. 12a-b show two examples wherein the CTIS supplies coupons and/or discount info to a user. FIG. 12a shows an advertisement 1205 for hay fever medication that contains a scan code, which may be embedded in a 2D, 3D, or 3D-VR environment. Upon scanning or clicking the code, the user's cell phone is supplied with a coupon 1210 for 25% off the advertised medication, along with a nearby store at which to redeem the coupon. FIG. 12b shows an article related to events and nightlife in New York City 1215 that contains a scan code, which may be embedded in a 2D, 3D, or 3D-VR environment. Upon scanning or clicking the code to obtain additional content, the user may also be provided with a contextual SMS message or advertisement for a local bar 1220, including an announcement of happy hour discount prices based on the time of the scan. In an alternative embodiment, the coupon could be provided to the user based on an anticipated provider zone breach rather than a contiguous, causal code scan.

### Information Querying and Serving on Mobile Devices Based on Profiles

In an embodiment, information querying and serving are triggered by codes that are scanned by a user. The information is selected based on the profile of the user. In an illustrative example, a user who is profiled as a teenager with a stated interest in comic books and a record of scanning codes related to movies may be served an advertisement for the latest comic book themed movie playing in the next hour near his/her present geographic position the next time he/she scans a code from the entertainment section of the newspaper.

### Anticipatory Information Querying and Serving on Mobile Devices Based on Profiles

In one embodiment, information may also be served to users based solely on the user profiles, and without any initiating code scan. This may be based on predicted space-time trajectories derived from the accumulated history of scanned codes.

The CTIS delivers information based on user activities, such as may be registered by codes scanned by mobile devices, as well as user characteristics and an accumulated history of user activities (e.g., code scans). The scans, together with geographic, temporal, and user-specific information, are obtained by the server that receives, processes, and records the message. Based on these messages and a user profile—which may include continuously updated user-specific behavior information, situational and ambient information, an accumulated history of scanned code messages, and integration with outside database information—the server selects information to serve to the users' mobile devices from an information base. In one embodiment, the code triggered information server allows advertisers to supply product information to the consumers who would be most interested in such ads; this may be achieved by the CTIS selecting advertising content based on a combination of the context of the code that the consumer scanned, the consumer's stated interests as recorded in his or her user profile, the consumer's demographic profile, situational information, and a record of scanned codes. These factors may be analyzed and employed by the CTIS for both user tracking and behavioral profiling/targeting. This information can then be supplied to a user based on anticipated user trajectories and/or interests, as may be determined from the record of scanned codes.

For example, the space-time trajectories of a user who has scanned barcodes in magazines using his/her cell phone over a period of time may be determined, and future likely trajectories determined. Then, advertisements could be served to the user based on where the user is expected to be at a given time, his/her demographic profile, his/her stated interests, and the types of advertisements or articles from which he/she has scanned codes in the past. As an illustrative example, a user may have a history of scanning codes related to fast food, a stated interest in sweets, and a project path passing near a particular fast food restaurant at a particular time. This user may be served an advertisement for the latest dessert product at that restaurant on his/her cell phone shortly before he/she is expected to pass the restaurant.

### Determining and Announcing Proximity Between Trajectories

The present disclosure is directed to apparatuses, methods and systems for determining and announcing proximity between trajectories. Existing schemes fail to take full advantage of the tracking and context targeting possibilities enabled by the present disclosure. In particular, they do not allow tracking and proximity notification that is targeted to the individual consumer's characteristic profile, behavioral patterns, and present contextual surroundings. As such, this disclosure details a code triggered information server (CTIS) that tracks users and notifies them of proximity with other users based on user activities, such as may be registered by codes scanned by mobile devices, web links selected on a computer, or decisions made in a virtual world. For example, a recorded history of scanned barcodes, as well as the time and location of each scan, may be analyzed to determine where a user has been and what they were interested in scanning at the time. Based on such a record, a prediction of a user's likely location may be made. Then, intersections or near-misses for such predicted trajectories between different users may be determined and reported. The CTIS may also incorporate user characteristics and interests.

As the first proximity notification system with geographic, context, and behavioral specificity based on user profiles, the CTIS is designed to analyze user behavioral patterns in order to statistically derive user trajectories and tracking information. In one embodiment, the CTIS is designed to compare expected user space-time trajectories to determine when two or more users are likely to be within a specified distance of each other at a given time. In another embodiment, the CTIS is designed to compare expected user web-surfing habits to determine when two or more users are likely to be on the same website, or within a specified number of links from each other, at a given time. In another embodiment, the CTIS is designed to compare expected user trajectories within a virtual world to determine when two or more users are likely to be within a specified virtual distance from each other within the virtual world. In another embodiment, the CTIS provides rapid and evolving geographic and historical statistical profiling of user activity.

### A Graphical Code-Serving Interface

In an embodiment, information is displayed in an electronic system by displaying a first visual token and animating the first visual token to reveal a second visual token comprising a coded symbol, which may be in a 2D, 3D, or 3D-VR environment. The animation of the first visual token may be in response to a user action. In an embodiment, the user action is a selection response that uses a user pointer. The animation may include, for example rotating the first visual token to reveal a coding symbol on a proximate side of the first visual token.

The encoding symbologies for example, matrix codes, may be placed proximate to graphical elements in a wide variety of digital display contexts and media, including portable display devices, mp3 players, cell phones, digital paper, animated billboards, websites, internet or television broadcasts, software interfaces, and/or the like. Users may capture images of information encoding symbologies from such displays, for example using a cell phone camera, and decode them with software applets to receive additional information, multimedia content, offers, coupons, notifications, and/or the like.

Serving codes to users may be accomplished by a variety of different means and in a variety of different contexts. FIGS. 24-26 illustrate some implementations of graphical code serving interfaces (GCSIs) in embodiments of the GCSI/CTIS system. In these implementations, a graphical display and/or interface initially presents a first visual token for display. This first visual token may comprise virtually any image, picture, drawing, emblem, icon, logo, animation, and/or the like. This first visual token may then be animated to reveal a second visual token comprising encoded information, such as a QR code, matrix code, bar code, and/or the like. Animation of the first visual token may, for example, comprise rotation of the first visual token to reveal the second visual token on a proximate side of the first visual token. For example, a two-dimensional picture in the graphical display may rotate in the third dimension to reveal a matrix code on the back of the picture. Other forms of animation may also be employed within different implementations. For example, the first visual token may dissolve, morph, disassemble and reassemble, and/or the like to reveal the second visual token. In some implementations, the animation of the first visual token to reveal the second visual token may occur only in response to some user interaction with the first visual token. For example, a computer screen may display a first visual token persistently until a user clicks on the first visual token with a mouse pointer, at which time the first visual token may rotate to reveal the second visual token on its back. In another example, an electronic billboard may persistently show an advertisement until a motion sensor detects someone walking by, at which time the advertisement dissolves to reveal a matrix code underneath. In still another example, an electronic sign may display a particular image until a detector coupled to the sign detects a signal and/or an authorization code from a compatible, portable electronic device near the detector, at which time the image may morph into a barcode. In still another example, the first visual token displayed on a touch-sensitive display may flip over to reveal a code when a user touches it with a finger or runs a finger over it to simulate a flipping motion.

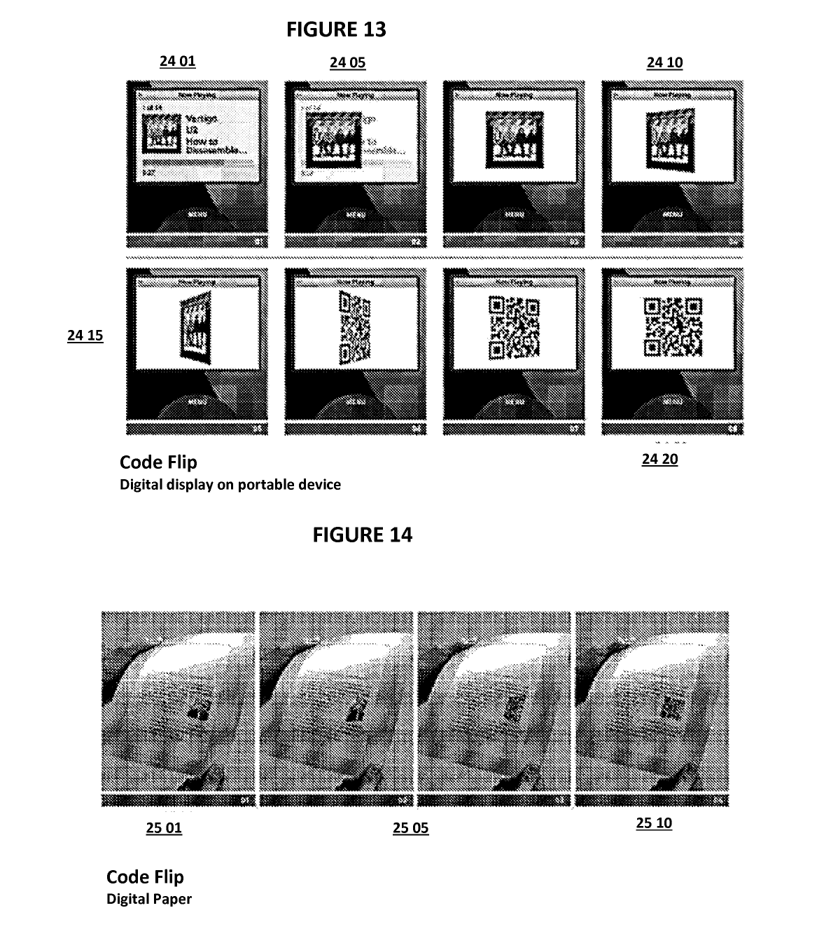

FIG. 13 shows an implementation of a user interface manifesting GCSI/CTIS functionality on a portable electronic device in one embodiment of GCSI/CTIS operation. A wide variety of different portable devices may execute and/or coordinate with GCSI/CTIS functionality, such as but not limited to portable media players, cellular telephones, BlackBerries, PDAs, and/or the like. In the illustrated implementation, a portable media player displays album information, including an image of the album cover, on a graphical display, where the displayed information corresponds to music being played on the player 2401. A user may click on or otherwise select the album cover image, causing it to increase in size 2405 and rotate 2410-2415 to reveal a matrix code on the image 2420.

FIG. 14 shows an implementation of a user interface manifesting GCSI/CTIS functionality on digital paper in one embodiment of GCSI/CTIS operation. Here, an image is included in one area of an article displayed on the paper 2501. Either by itself or in response to some user action, the image flips 2505 to reveal the code on its other side 2510.

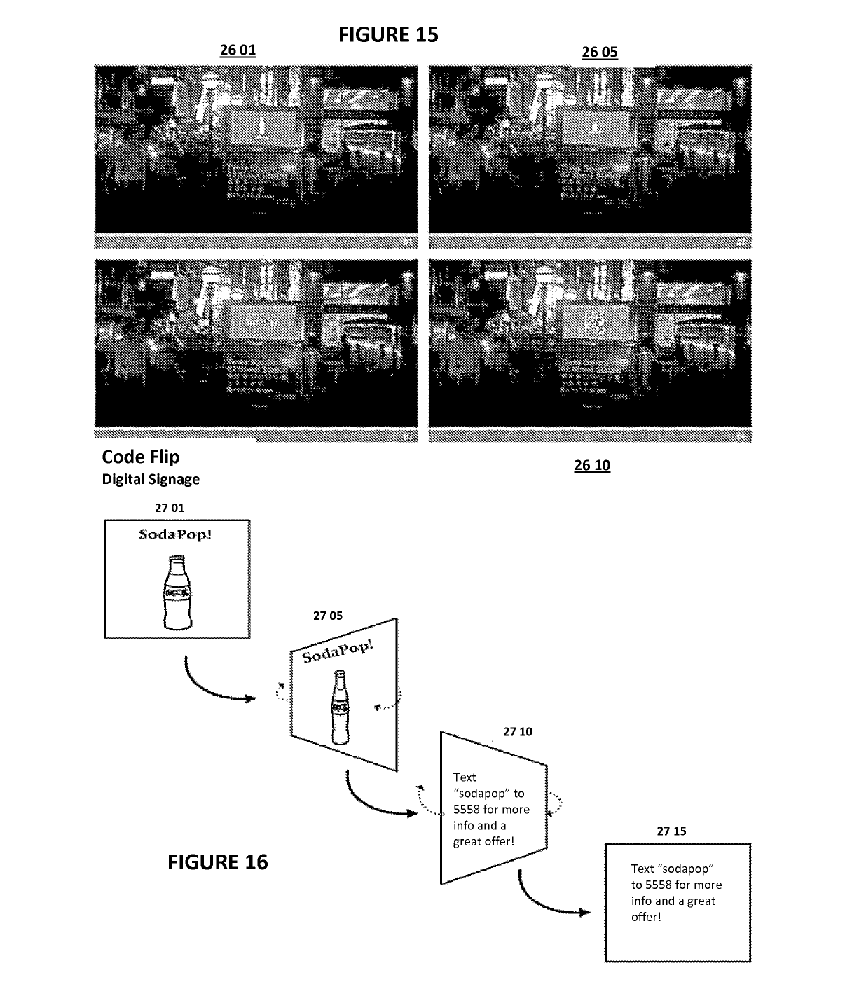

FIG. 15 shows an implementation of a user interface manifesting GCSI functionality on a digital billboard in one embodiment of GCSI/CTIS operation. A public, electronic billboard display shows an advertisement comprising a product logo 2601. The product logo rotates 2605 to reveal a matrix code on its opposite side 2610. Flipping of the logo may occur periodically or aperiodically, upon detection of a nearby viewer, upon detection of a portable device capable of decoding the matrix code, and/or the like.

### Code-Mediated Content Delivery Platform

Embodiments are directed to apparatuses, methods, and systems for a code-mediated content delivery platform comprising a Graphical Code-Serving Interface and a Code Triggered Information Server (“GCSI/CTIS”). The GCSI/CTIS connects information encoding symbologies, and by proxy the underlying information content, to graphical display elements, to graphical interface elements and facilitates generation of encoding symbologies, error-correction, media sampling and purchasing, social networking, and sales promotion programs.

In an embodiment, active display elements provide access to information, particularly information that is targeted to an individual's profile, interests, and/or contextual surroundings and that is portable and/or made available in unexpected physical locations. The active display elements facilitate the serving of such information via placement of information encoding symbologies, such as matrix codes, proximate to graphical elements in a wide variety of digital display contexts and media, including portable display devices, mp3 players, cell phones, digital paper, animated billboards, websites, internet or television broadcasts, software interfaces, and/or the like. Users may capture images of information encoding symbologies from such displays, for example using a cell phone camera, and decode them with software applets to receive additional information, multimedia content, offers, coupons, notifications, and/or the like.

In one embodiment, a code sent via a communications network from a mobile communications device from a user is received. The code is based on a scan of an optically-readable coding symbol. A code database is queried to discern a multimedia content data identifier corresponding to the received code. Multimedia content data is retrieved from a multimedia database based on the multimedia content data identifier. A sample of the multimedia content data is sent to the mobile communications device via a communications network. A sample acceptability message is received from the user. The multimedia content data is sent to a data repository associated with the user provided that the sample acceptability message indicates that the user wishes to receive the multimedia content data.

In another embodiment, an alphanumeric string comprising a plurality of characters and representing a location of multimedia content data is received from a first data source. Each of the plurality of characters of the alphanumeric string is converted into a corresponding binary number to yield a plurality of binary numbers based on a character correspondence table. The plurality of binary numbers are concatenated to yield a bitwise array. An optically-readable encoding symbol comprising a plurality of disconnected solid shapes is drawn in which the presence of a solid shape at a position in the symbol indicates presence of a 1 in a corresponding position of the bitwise array.

In another embodiment, an incomplete code associated with an optically-readable encoding symbol is received. A code database is queried based on the incomplete code to determine a plurality of possible matching codes. The code records associated with the plurality of possible matching codes are queried to retrieve code presentation conditions associated with each of the plurality of possible matching codes. A plurality of code repair schemes are retrieved from a code repair database based on code presentation conditions. Each of the plurality of code repair schemes are applied to the incomplete code to yield a plurality of repaired codes. A repaired code is selected from the plurality of repaired codes based on at least one pre-designated code fidelity rule. The repaired code is designated as a correct code corresponding to the optically-readable encoding symbol.

In another embodiment, a scan indicator comprising an indication that a user has scanned an optically-readable encoding symbol with a mobile scanning device is received. The optically-readable encoding symbol is associated with a good or service. A retailer at which the user scanned the optically-readable encoding symbol is identified. A retailer record is queried to determine whether the retailer is subscribed to a sales promotion program. The retailer is charged a first retailer fee based on the received scan indicator if the retailer is subscribed.

In another embodiment, an online social network is provided. A user identifier is received and stored. User profile information is received and stored in association with the user identifier. A plurality of user scan indicators indicating that a user has scanned a plurality of optically-readable encoding symbols are received. The plurality of user scan indicators are stored in association with the user identifier. At least one friend designation indicating an association with at least one other user is received and stored in association with the user profile.

Users may scan codes found in media publications, on billboards or signs, on consumer products or packages, on websites or television screens, on movie screens, on clothing or accessories, on mobile device displays, and/or the like.

In an alternative implementation, content associated with a captured code or other user interest registration may be sent to a data repository other than a user's mobile device. For example, a user may scan a code corresponding to media content. Rather than triggering the GCSI/CTIS to send the media content to the mobile device with which the code was scanned, the code scan may trigger the GCSI/CTIS to send the media content to a user's computer, an online data repository, and/or the like for storage and later retrieval by the user. For example, the GCSI/CTIS may discern a user identity from the Scan Message, query user access and/or authorization information, and use that access and/or authorization information to access an online data repository corresponding to the user to store requested media content thereon for later retrieval and/or use by the user.

FIG. 5d shows an implementation of logic flow for customized repair and/or decoding of obscure or ambiguous scanned codes. An ambiguous code may be received at a GCSI/CTIS system at 581, such as may be sent via a communications network from a user's mobile scanning device. In one implementation, a scanned code may be qualified as an ambiguous code if an attempt to decode the code does not yield a single result. In one implementation, the system may also receive code scanning conditions 582 describing any of a variety of circumstances of the code scan which may affect the quality and/or fidelity of the scanned code. For example, some relevant circumstances may include the time of day, light levels, use of flash, mobile scanning device type and/or characteristics, code size, contrast, brightness, sharpness, skew, rotation, and/or the like. The ambiguous code and scan conditions may then be passed to a repair queue 583, whereby the system may analyze the ambiguous code and attempt to discern the correct decoded content. A plurality of possible matching codes are determined at 584, and a code database is queried at 585 to extract code presentation conditions corresponding to each of the plurality of matching codes. Code presentation conditions may describe how and where the code was displayed and may comprise a wide variety of factors, such as but not limited to medium (e.g., newspaper, glossy paper, product packaging, television display, website, billboard, and/or the like), likely obscuring factors (e.g., glass covering, tears, distance, and/or the like), and/or the like. The GCSI/CTIS system may then generate a code repair database query based on the presentation conditions and/or scan conditions 586 and query the repair database to extract repair schemes corresponding to the particular presentation and/or scan conditions. For example, a particular code repair scheme may be tailored for and/or correspond to codes displayed on billboards that are scanned after dark by Nokia mobile phones. Extracted repair schemes corresponding to each of the possible matching codes are applied to the ambiguous code at 588, and a determination is made at 589 as to whether any one of the possible matches is now more likely to be correct than the others. This determination may be made, for example, by measuring the fidelity of codes with various repair schemes applied and selecting as the correct code that which has the highest resulting fidelity. If no remaining ambiguity exists as to the correct code, then the favored code is registered with the GCSI/CTIS system at 592. Otherwise, the GCSI/CTIS may generate a custom recommendation message 590 and send the message to a user and/or a user's mobile device 591. The custom message may, for example, provide tailored recommendations on how the user may improve the fidelity of the code scan based on the possible matching codes and the associated presentation conditions and/or scan conditions. Tailored recommendations, as well as the repair schemes themselves, may be adjusted based on feedback received from users about which codes they were actually trying to scan. In one implementation, the GCSI/CTIS may provide a query message to a user presenting a summary of content associated with alternative matching codes in order to determine which content the user was actually trying to access. It should be noted that code analysis and/or repair may be undertaken on a code image level, alphanumeric string level, binary string level, and/or the like basis. Combinations of such bases may also be undertaken, such as by first analyzing the ambiguous code in its alphanumeric string form and then, if ambiguity remains, analyzing the code in its binary form. Further discussion on such an analysis is provided below.

In an illustrative example of partial decoding, a given matrix code may encode the string ABC123. In multiple processes, it may be determined that the code contains A_{—}1_{—}3 (where the blanks represent unknown values), _C1_, and AB_.

Through these multiple processes, the GCSI/CTIS system now knows that the code contains ABC1_{—}3 and may check this against codes in a code database to determine how many matches exist. If it finds two matching codes (e.g., ABC123 and ABC143), it may consider ancillary factors, including code presentation and/or code scan conditions, user profile information, and/or the like. For example, ABC123 may correspond to an advertisement for a new action movie while ABC143 corresponds to a coupon for women's cosmetics. If the user supplying the code is determined, based on a supplied user ID, to be a man with a history of scanning movie-related codes, then the GCSI/CTIS system may infer that ABC123 is the matching code and serve the corresponding content. In one implementation, the GCSI/CTIS server may further supply a confirmation request for partially matched codes, requesting the user to affirm or deny that the supplied content is, in fact, the content that he/she was seeking

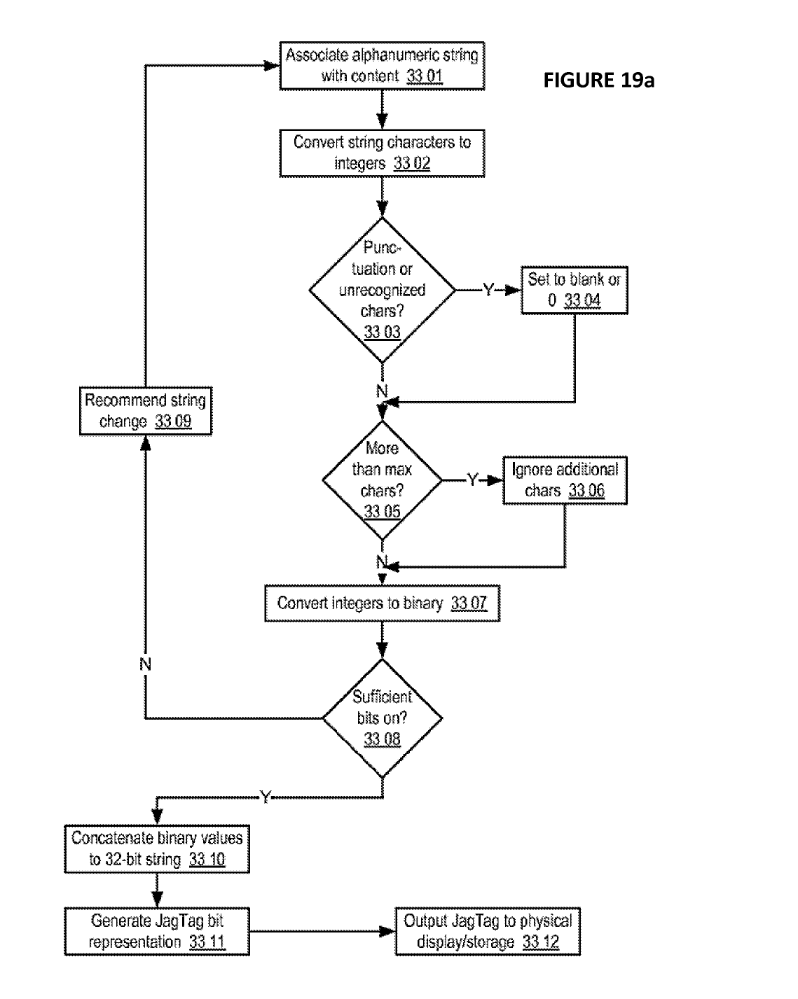

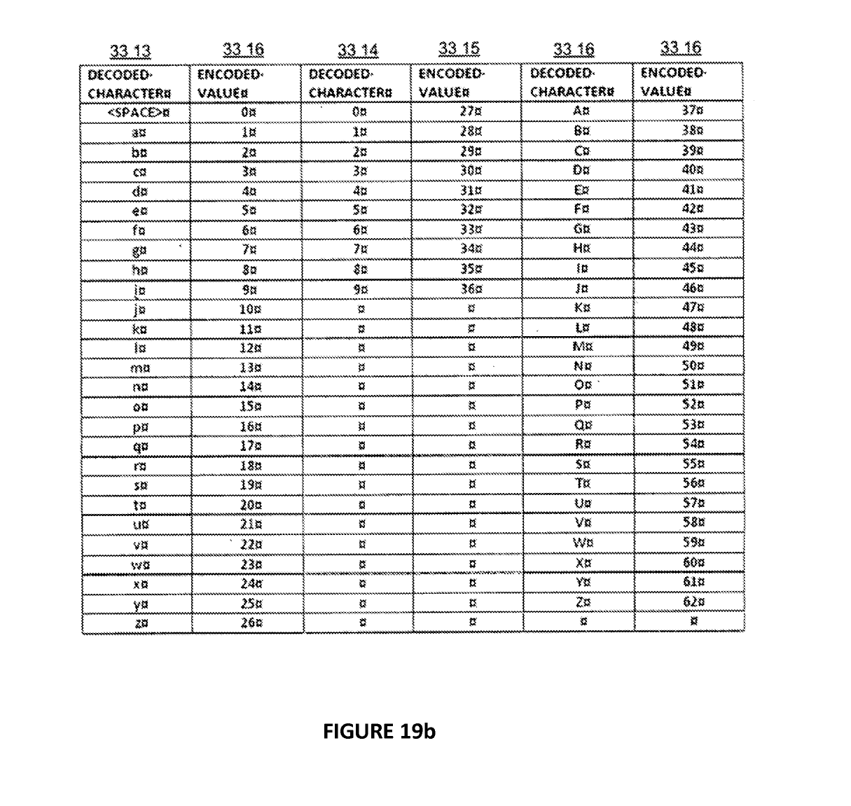

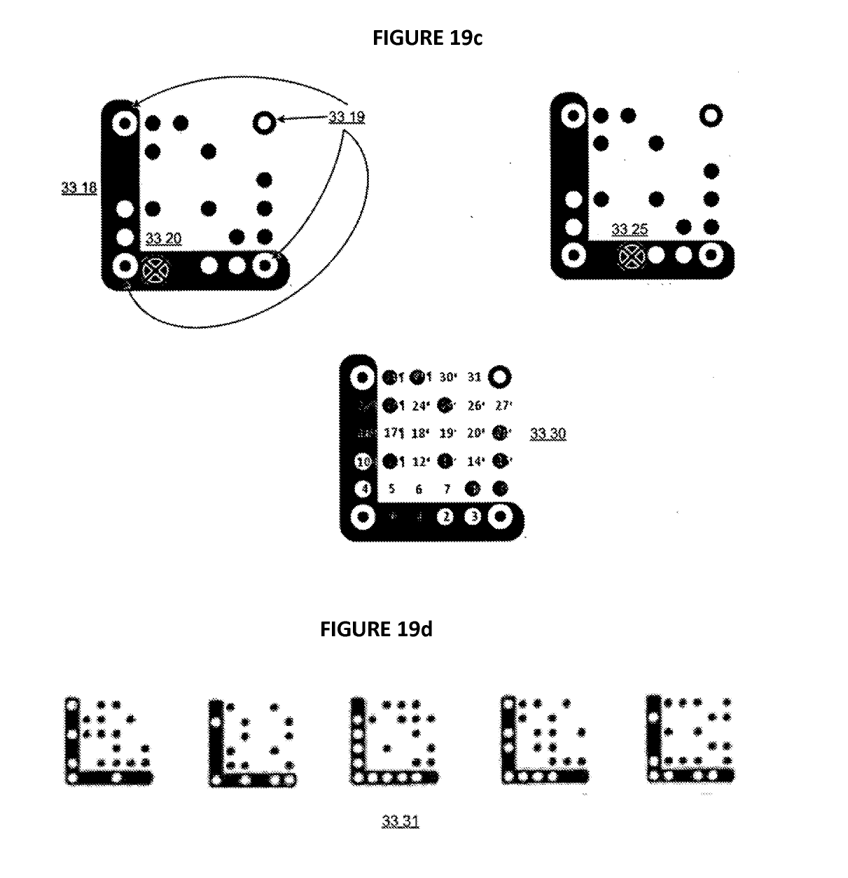

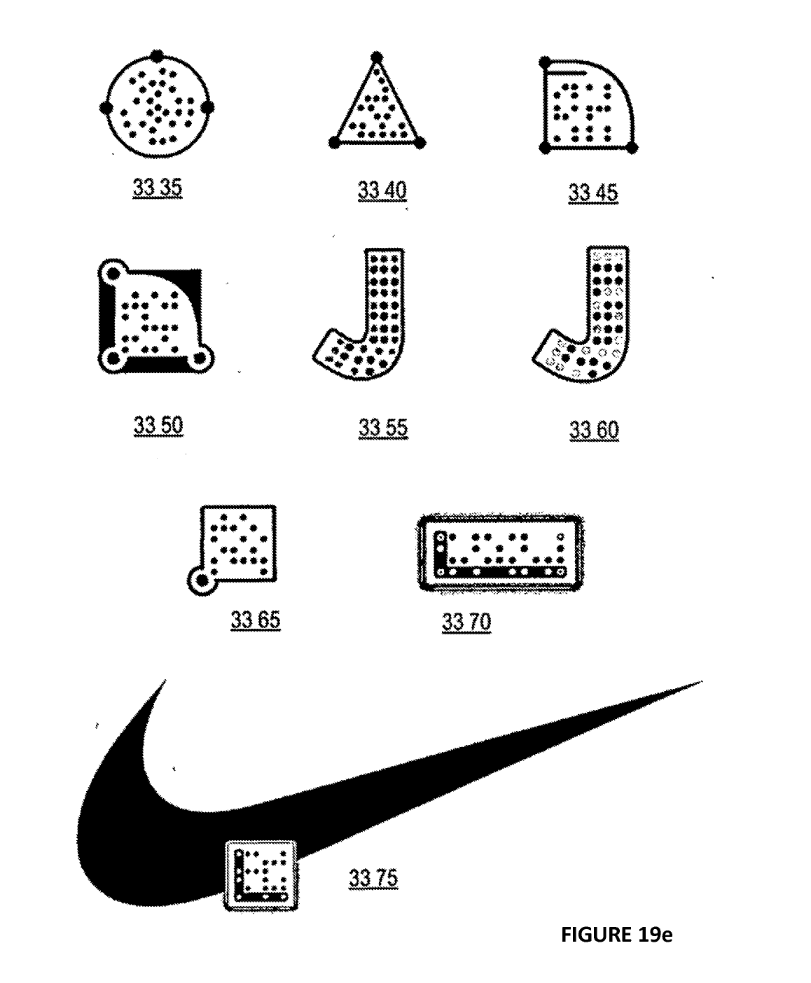

In one implementation, analysis of ambiguous codes may comprise a two-stage process. In a first stage, an encoded string comprising a number of alphanumeric characters, one or more of which may be unclear, may be compared to a database of alphanumeric strings to determine which, if any, match. In one implementation, a Levenshtein distance metric may be employed to determine the similarity of an input string to strings existing in the database. In one implementation, the input string may only be compared against “live” strings in the database (i.e., strings that are currently engaged in active use and/or tied to actual content). If ambiguity remains about which code has been scanned after this character-based analysis, a GCSI/CTIS system may apply a second stage of analysis, whereby the input alphanumeric string is converted into a corresponding binary bitset array (see, e.g., FIGS. 19a-b and associated discussion below) and a comparison is performed between binary values of the input string and the strings stored in the code database. The most significant bits come first in the bitset array while the least significant bits come last, so priority weighting may be applied against potential value matches based on which bits match between the input and stored strings.

### User Interface

FIG. 7b shows an implementation of a user profile user interface in one embodiment of GCSI/CTIS operation. The profile page 760 may include a display of basic user information 763 and/or a user picture 766, and may provide a wide variety of other user information, including demographic information, interests, media libraries, friend lists, code scanning activities, and/or the like. The displayed implementation further includes a plurality of tabs 769 allowing the user to view profile information, edit his or her profile, view photos, groups to which the user may belong, and/or edit settings, including sharing and/or privacy settings 772. Privacy settings may, for example, control access of other individuals to a user's personal information, code scanning activity, and/or the like. In some implementations, certain information about a user, in particular regarding codes that a user has scanned and/or the content associated with those scans, may be shared with other users. For example, a user may be able to inquire, via a GCSI/CTIS affiliated system, as to what codes have been recently scanned by other users that are within a particular geographic radius of the user. In another example, a user scanning a code to receive a song may also be provided with information about the code scanning activities of other users whose codes also corresponded to songs.

In one implementation, a user may be allowed to restrict which information of theirs is sent to other users and/or to restrict which information of other users is sent to them. For example, a user may have a “friends” list that has a different level of access than the general public.

In one implementation, a user may have a personal code that is associated with the user and/or a user profile. In one implementation, other users can scan the personal code to automatically join the first user's friend list. In another implementation, a personal code my comprise a short-link to the user's profile 760, and/or to other profile pages or webpages associated with the user, such as a Facebook page, Myspace page, and/or the like. In one implementation, the user can set a forwarding instruction on his or her GCSI/CTIS page to forward inquiries corresponding to scans of the user's personal code to another page. In another implementation, the user may provide the personal code on other pages as a link back to the user's GCSI/CTIS profile page.

In one implementation, a user may be provided recommendations in response to a code scan. For example, the user may scan a code corresponding to a particular song by a particular musical artist. The user may then be provided a listing of other songs, artists, and/or the like having codes recently scanned by the members of the user's friends list and/or that may be further related to the song and/or artist whose code the user scanned.

In one implementation, a user's code scans may be integrated with an instant messaging, blogging, micro-blogging, and/or the like service, whereby the user's code scans are automatically rendered as descriptive summaries and displayed to other users, such as on a webpage, via SMS text messages, emails, and/or the like. For example, each code scan may have a pre-set text description associated therewith that, upon scanning of the code, is displayed on a user's Twitter.com page. In one implementation, a user may receive an incentive payment for particular types of content that are provided to the user's friends, associates, blog subscribers, and/or the like as a result of the user's code scans. For example, a reward may be provided to the user every time the user scans a code corresponding to a particular brand of products and a message associated with those products is supplied to subscribers to the user's profile and/or blog. A further reward may be provided to the user if it can be determined that one of the user's associates made a purchase based on the provided message.

The privacy settings in the displayed implementation include permissions for displaying “twitters,” songs, videos, and purchases 775 associated with the user's code scans to various security levels for other people 778, including the general public, private/friends, and “snaps” (i.e., those who may have scanned a user's personal code and/or a code corresponding to the user's profile). Selection of a particular privacy setting may generate a sharing rule that is stored in association with the user and consulted each time a user scans a code corresponding to one of the categories shown at 775 to determine whether or not code-associated information should be provided and/or sent to any of the categories of people shown at 778.

The profile page 760 further includes a field 779 wherein a user may specify the location of a data storage facility to which some or all media and/or other content that the user acquires via code scans are to be sent and/or stored. For example, the user may specify an online storage facility (e.g., Apple's iDisk service) in which the user's code scan-acquired content is to be stored.

The profile page 760 further includes interface components configured to generate a personal code, in this case a JagTag 780. Selection of the button at 780 causes the GCSI/CTIS system to associate a code with the user and/or the user's profile and generate a corresponding code, which is displayed for the user. The user may then elect to save an image of the code to his or her computer desktop, send the code in an email, send the code in an MMS message, and/or the like via the interface elements at 781.

In one implementation, coupons may be supplied to a user's mobile device with digital rights management (DRM) software included to prevent or discourage coupon copying, sharing, and/or the like. In another implementation, no DRM software is included with the coupon.

In one implementation, a GCSI/CTIS server may query, store, and/or consider data pertaining to media demographics associated with a particular medium in which a code is published; the subject content associated with a code; the type of information requested by scanning a code; and/or the like. For example, a user scanning a code associated with a product review for a hybrid sports utility vehicle (SUV) in a men's magazine may trigger a GCSI/CTIS system to draw and/or analyze data pertaining to media demographics associated with the men's magazine, subject content associated with hybrid vehicles (i.e., environmentally conscious consumers), subject content associated with SUVs (i.e., outdoor activity or families), and product reviews. Thus, the GCSI/CTIS may be configured to consider both the subject of a user's inquiry, the source of the inquiry, the type of inquiry, and/or the like.

In another embodiment, the GCSI/CTIS may allow users to instantly subscribe to and/or enroll in services, loyalty programs, discount programs, and/or the like by scanning codes associated therewith. For example, a user may subscribe to receive weather updates by scanning a weather-linked code. In another example, a user may enroll in a brand-affiliated coupon program by scanning a code associated with that program. Selection of a subscription and/or enrollment code may cause the GCSI/CTIS to submit a user's personal information to an integrated subsystem and/or third-party system for subscription registration. In some implementations, the GCSI/CTIS may require verification from the user, separate from the code scan itself that the user wishes to enroll and/or subscribe to the associated service. In some implementations, a user may submit trigger specifications and/or conditions for enrolled service notifications. For example, a user may specify that he or she only wishes to receive weather updates associated with heavy rain or thunderstorms. In another example, a user may specify that he or she only wishes to receive coupons for products from a particular grocery store and not from other grocery stores. Scanning of a code associated with a subscription program wherein specification of triggers and/or conditions is permitted may cause a GCSI/CTIS system to retrieve and display a user interface screen to the user that is tailored to the particular subscription and/or enrollment service and configured to receive trigger and/or condition specifications.

In another embodiment, the GCSI/CTIS may be configured to track and/or implement a rewards program. For example, in a single-tiered rewards program implementation, a user may scan a code every time he or she purchases a particular item (e.g., a sandwich from the local sandwich shop) in order to register each purchase and store a record thereof in association with the user. The user may then receive a discount, free item, and/or the like after a pre-designated number of purchases and associated scans are registered, after which the record of scans is reset to start anew. In another example, in a multi-tiered rewards program implementation, a user may continue to register additional purchases and associated code scans to receive larger and/or more significant benefits, discounts, and/or the like.

In another embodiment, the GCSI/CTIS may be configured to implement contests and/or prize awards. For example, a user may enroll in a contest by scanning a code associated with the contest, causing personal information, user identifiers, and/or the like to be submitted to a contest subsystem. Such contests may comprise instant-win and/or other types of lotteries, auctions, raffles, and/or the like and/or may enroll the user in a contest program through which they may receive further instructions, possibly including additional codes for scanning, in the future.

In another embodiment, the GCSI/CTIS may be configured as a voting facility. A user may register a vote for a particular candidate, ballot initiative, viewpoint, survey result, and/or anything else for which a vote may be registered by scanning a code associated with the user's choice. In one implementation, a user identifier may be discerned and submitted with the vote in order to prevent repeat voting, to correlate with voter registration, and/or the like. In one implementation, voter identifying information may be stripped from a scan message prior to the message being provided to particular agencies or individuals, in order to preserve a secret-ballot style of voting.

In another embodiment, the GCSI/CTIS may be configured as a facility to effectuate purchases of goods and/or services. By scanning a code associated with a particular good or service, a message may be sent to a GCSI/CTIS system identifying the good or service associated with the code as well as identifying the user, such as based on a mobile device identifier. The GCSI/CTIS system may then automatically generate a bill for the user, charge a specified credit account, deduct a payment from a debit account, and/or the like to effectuate payment for the good or service. In one implementation, the GCSI/CTIS may return a payment confirmation, such as to the user's mobile device and/or a retailer's point-of-sale device to confirm that the user has provided adequate payment.

In another embodiment, the GCSI/CTIS may be configured to facilitate communications. For example, a code may correspond to a particular telephone number, IP address, and/or the like. Scanning of the code by a communications-enabled mobile device may cause the mobile device to automatically establish a connection with the address to which the code corresponds. In one implementation, the connection may be established directly by an on-board applet loaded on the mobile device. In another implementation, the connection may be established by an instruction sent to the mobile device by a GCSI/CTIS subsystem in response to a received code scan.

FIG. 16 shows an implementation of a user interface manifesting GCSI/CTIS functionality for serving an SMS text message prompt in one embodiment of GCSI/CTIS operation. A first visual token 2701 shows an image and text, such as may correspond to an advertisement, logo, and/or the like. The token may appear in a wide variety of contexts, such as on a website, in a virtual world, on a cell phone or other portable communications and/or media device (e.g., BlackBerry, iPhone, iPod, and/or the like), on an electronic billboard, on broadcast television or recorded video content, and/or the like. The first visual token may be animated, such as by flipping, rotating, revolving, and/or the like (2705, 2710), to reveal encoded content on a proximate side thereof. In the implementation illustrated in FIG. 16, a message appears along with an SMS code that a user may key in to an SMS enabled communication device to receive associated content. In alternative implementations, other types of codes and/or code communication protocols may be displayed and/or employed for communication with GCSI/CTIS systems, such as but not limited to: MMS, instant messaging, web browser based messaging, email, Enhanced Messaging System (EMS), TCP/IP, WAP, and/or the like. For example, a first visual token may be animated to reveal an email address, website address, instant message nickname, and/or the like on a proximate side to enable a user to connect to and/or communicate with a GCSI/CTIS system and/or affiliated entity for the receipt of information, coupons, offers, advertisements, media, and/or the like.

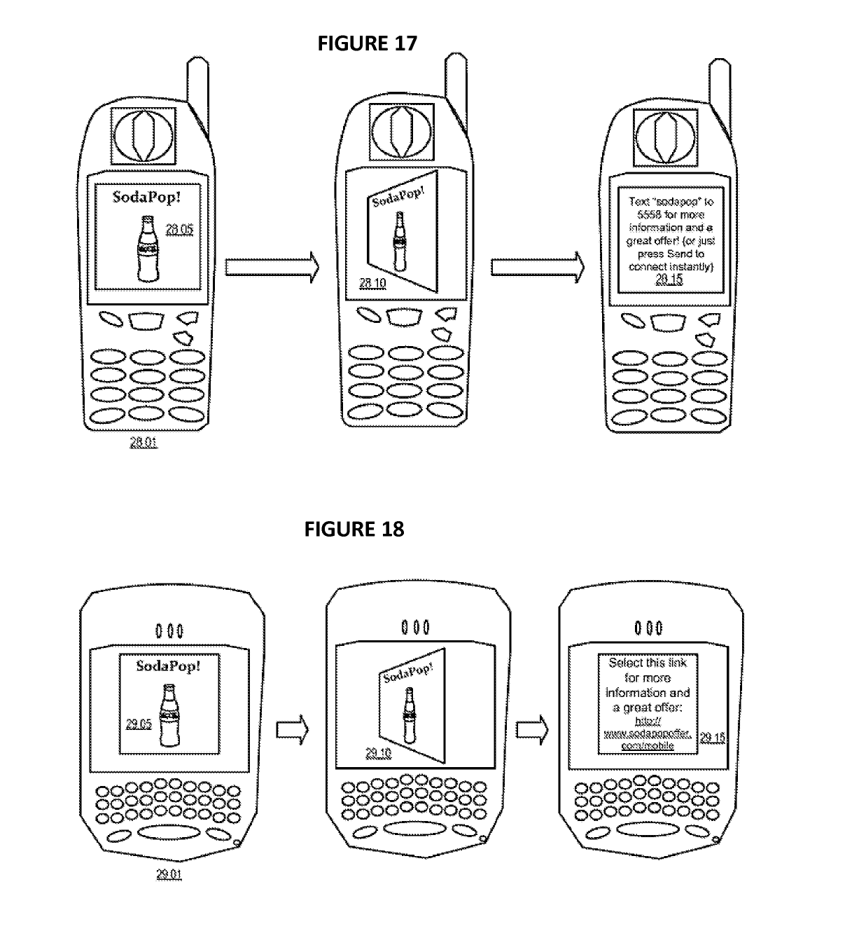

FIG. 17 shows an implementation of a user interface manifesting GCSI/CTIS functionality on a mobile phone 2801 in one embodiment of GCSI/CTIS operation. A first visual token comprising an image, advertisement, logo, and/or the like 2805 is displayed on a mobile phone display screen. The first visual token may be animated 2810, such as in response to a user interaction (e.g., pressing a button on the mobile telephone, clicking on the first visual token with a pointer widget, and/or the like). In an alternative implementation, the first visual token may be automatically animated and/or animate without the need for any user interaction. In the illustrated implementation, the animated first visual token flips to reveal a second visual token comprising a message and an SMS text message prompt on a proximate side 2815. In one implementation, the user may manually key in the text message and/or destination address to receive the associated content. In another implementation, the GCSI/CTIS interface may supply a selectable link that, when selected, will automatically generate an SMS text message to retrieve the associated content. In still another implementation, such as the example illustrated at 2815, the user may be allowed to automatically generate and/or send the SMS text message from the second visual token by pressing a “Send” button on the mobile phone, clicking and/or otherwise interacting with the second visual token, and/or the like.

In one implementation, a user may receive a coupon and/or coupon code in response to an interaction with the second visual token, sending of an SMS text and/or other message in response to the second visual token, and/or the like. For example, in one implementation, a user may receive a numerical coupon code in response to a sent SMS text message, wherein the numerical coupon code may be presented to a retailer, entered into a website, and/or the like to receive discounts, free items, special offers, and/or the like. In another implementation, the user may receive a scannable code, such as a QR code, matrix code, and/or the like in response to a sent SMS text message, wherein the scannable code may be scanned by a retailer in order for the user to receive the associated benefits, discounts, and/or the like. For example, the scannable code may appear on a user's mobile phone display screen and may be scannable therefrom to provide the user with the benefits associated thereto. In another implementation, the user may receive an e-mail message in response to interaction with a graphical code-serving interface, the message containing requested content and/or links thereto, scannable codes, coupon codes, and/or the like.

In another implementation, a first visual token may comprise a “poster” image corresponding to a full-length movie, movie preview, video clip, television show, and/or the like. The second visual token revealed on a proximate side of the first visual token may then enable a user to retrieve the full video content associated with the poster image. For example, a user may scroll through a series of poster images corresponding to a series of full-length movies. When the user finds a movie he or she desires to retrieve, watch, download, and/or the like, he or she may select the corresponding poster image, which may then be animated to reveal a second visual token, such as an SMS instruction, message, delivery address, phone number, and/or the like, whereby the user may interact with a GCSI/CTIS system and/or affiliated entity to retrieve the desired movie content.

In one implementation, a series of first visual tokens may be displayed as scrollable thumbnails, within a cinematic presentation, as an immersive slideshow, and/or the like.

FIG. 18 shows an implementation of a user interface manifesting GCSI/CTIS functionality on a portable communication device in one embodiment of GCSI/CTIS operation. The portable communication device 2901 shown in the illustrated implementation may represent a BlackBerry, iPhone, PDA, and/or the like. A first visual token 2905 is animated 2910 to reveal a message and a selectable hyperlink on a proximate side 2915, in this case a URL connecting to content, information, offers, coupons, and/or the like. In one implementation, a user may be permitted to directly select the hyperlink from the displayed image using interface elements of the device in order to retrieve content, view a webpage, interact with a GCSI/CTIS and/or affiliated system, and/or the like.

A variety of operational models may be employed to provide code-serving interface capabilities to users and content providers alike in accordance with the embodiments and/or implementations described herein. In one implementation, a central GCSI/CTIS server may enable content providers to supply first and/or second visual tokens, associated SMS and/or MMS codes, and/or any other information necessary to connect users to supplied content. The central GCSI/CTIS server may then outfit the supplied tokens and/or other information with HTML markup information allowing the code-serving interface to be embedded in any webpage or other display media. In one implementation, the HTML markup information may further include a link to one or more downloadable applets that may be required to enable a user to view and/or interact with the code-serving interface. Having provided the data corresponding to a first and/or second visual token, SMS and/or MMS code, and/or other information, a content provider may be provided with an embeddable link, URL, and/or the like that may be cut and pasted into a web page HTML to embed the code-serving interface therein.

In another implementation, a content provider may submit just a first visual token and response content and/or a means of addressing said content, and a GCSI/CTIS server may generate a corresponding code-serving interface, a dial-in code and/or SMS and/or MMS address, hyperlink, and/or the like to allow users to interact with the first visual token to receive the response content. In one implementation, the generated code-serving interface may include HTML markup information enabling it to be embeddable on any webpage. A fee may be charged to the content provider, such as on a pay-per-click basis, for user interactions with the generated code-serving interface.

In still another implementation, a webpage or other display area may include a generic placeholder for code-serving interfaces that may be filled by code-serving interfaces and/or associated content supplied from one or more advertisement servers and/or GCSI/CTIS servers. The supplied code-serving interfaces may be selected based on webpage content, contextual cues, and/or the like and/or based on the goals of content providers and/or code-serving interface creators. For example, an advertiser may wish to place a particular code-serving interface associated with a new action movie on any webpage having a generic placeholder that mentions extreme sports. A fee may be charged to an advertiser for such targeted and/or contextual placement, such as on a bid-per-keyword basis. Fees may also be charged on a pay-per-click basis (i.e., levying a charge whenever a user clicks a code-serving interface to reveal the code, communication address, and/or the like on a proximate side).

FIGS. 19a-e show aspects of implementations of JagTag encoding and codes in some embodiments of GCSI/CTIS operation. FIG. 19a shows an implementation of logic flow for JagTag encoding in one embodiment of GCSI/CTIS operation. An alphanumeric string may be associated with content to which a JagTag code is ultimately to be associated 3301. In one implementation, a five character string is employed. Each character of the alphanumeric string may then be converted into a corresponding integer, such as may be based on a correspondence table 3302. FIG. 19b shows an implementation of such a corresponding table relating decoded characters, including lowercase letters 3313, numbers 3314, and uppercase letters 3315, to encoded values 3316 comprising integers between 0 and 62. To convert the alphanumeric string into a JagTag code, each character in the string is converted into a corresponding integer between 0 and 62 using the table in FIG. 19b. A determination may then be made as to whether any of the characters comprise punctuation marks or other unrecognizable or uncovertable characters 3303. If so, those characters are set to blanks or zeros in the resulting string of integers 3304. A determination may also be made as to whether the number of characters in the alphanumeric string exceeds a pre-designated maximum number 3305 (e.g., 5 characters). If so, additional characters are ignored 3306.

Each resulting integer may then be converted to a corresponding binary value 3307, and a determination may be made as to whether there are a sufficient number of “on” bits (i.e., bits equal to 1) 3308. For example, the GCSI/CTIS may require the existence of at least some minimum number (e.g., 9) of on bits. If not, then the system may return an error message and/or recommend that the user try a different initial alphanumeric string 3309. Otherwise, the GCSI/CTIS system may concatenate the string of binary numbers to yield a single 32-bit long bitset array 3310. The system may then generate a JagTag bit representation 3311, as described below, and output the resulting JagTag to a physical display and/or storage (e.g., storing an image formatted JagTag in a database, printing the JagTag, displaying the JagTag on a display screen, and/or the like) 3312.

The first bit of the bitset array may be considered a most-significant bit and the last bit of the bitset array may be considered a least-significant bit. Once complete, the 32-bit binary bitset array may be converted into a JagTag code representation. FIG. 19c further illustrates JagTag encoding in one implementation. The JagTag may include an L-shaped component 3318 that may, in one implementation, promote orientational and/or size discrimination of the JagTag, such as by a scanning or analyzing device. The JagTag may further include four circular elements 3319 that may also serve to promote orientational and/or size discrimination. The most significant bit of the bitset array may be encoded as a circle at the position indicated by the crossed circle at 3320, with a white circle (owing to the dark background of the L-shaped component 3318) indicating a 1 and no circle indicating a 0. The next most significant bit of the bitset array, then, may be encoded as a circle at the position indicated by the crossed circle at 3325. The numbering scheme indicated at 3330 shows how the circles (or lack of circles) at positions numbered from 0 to 31 correspond to the bits in the 32-bit bitset array, with 0 the most significant bit and 31 the least significant bit. If the bit falls on the L-shaped component 3318, a white circle is drawn for a bit value of 1, and otherwise a dark circle is drawn for a bit value of 1.

In one implementation, a shell script may be configured to accept an alphanumeric string comprising characters to be encoded and to return a JagTag in an image format, such as a PNG, JPG, GIF, BMP, and/or the like file format. In one implementation, the shell script may be further configured to receive a color specification (e.g., an HTML-style RGB triplet).

Configuring a JagTag for optimal recognition may be accomplished in a variety of different ways within different implementations. For example, a color for the JagTag code may be selected to as to have high contrast with the background color. A high number of “on” bits (i.e., bits equal to 1) may also improve code recognition, as discussed above. Accordingly, in one implementation, resulting JagTag codes having less than a minimum number of on bits may be rejected. Other measures that may be taken in various implementations to improve JagTag recognition may include maximizing code dimensions, ensuring that the code is surrounded by a substantial margin (e.g., at least 25% of the code's width and height), and ensuring fidelity of the code by eliminating any obscuring interferences. JagTag codes may be configured for a wide variety of physical manifestations, including printing on magazine pages, billboards, newspapers, and/or the like, displaying on video display screens, television broadcasts, websites, and/or the like. JagTags may also be configured into different shapes or display configurations in various implementations.

FIG. 19d shows one non-limiting embodiment of data loss resilient codes 3331, with characteristics that include: reducing errors based on “bleeding” of encoded data points by using circles/dots rather than squares that touch each other (this combats fuzziness of image as well as reduced light conditions); using a stronger identifier to discover processing directionality (rotation, skew, slant)—this is the black line with white dots shown in the figure; including data points within the identifier in order to maximize encoded data as well as allow for reduction in size of code; using equidistant lengths on identifier to process for skew and slant; using constant data points within the directional identifier to process for skew and slant—this may be top left, bottom right and bottom left white dots (not indicated in FIG. 19d); reducing the amount of data encoded in the code—most likely 5-8 characters—in order to allow for size reduction of the code; developing code characteristics so partial decoding allows for matching code to correct data on the server—for example, if only 70% of the characters from a code are discernible, the GCSI/CTIS can use server logic to extrapolate what the code is as well as the campaign/client it is associated with, i.e., information about the exact publication the code is in may be lost, but the GCSI/CTIS system can figure out the campaign and return an appropriate message; with regard to partial decode matching, server side and database logic focuses both on creating codes for clients and campaigns that are unique sets in order to enable partial decode matching as well as providing a set of rules around time, mobile number, and likelihood in order to determine the best potential match for partial decodes.

In the embodiment of the basic codes 3331 shown in FIG. 19d, design wrapped around the code does not impact the effectiveness of the decoding. High tone color differentials are allowed, so rather than black, dark blue or red could be used. The white dots in the identifiers are less likely to allow for color changes although a very light yellow or gray may be allowed.

In a further embodiment, the dots most likely to be lost in an image may be assessed and the least useful information encoded appropriately based on that assessment. An interesting opportunity for this code is that it allows for some logos to potentially replace the dots. For example, an Alltel logo can be used nearly as well as the dots, or a Nike logo is decodable with some server side code modifications.

The codes have an additional benefit in that they are in and of themselves, aesthetically pleasing, and as such offer significant advantages over previous codes. The ability in one embodiment, to vary the colors of the code, allows it to better integrate and look better in marketing contexts.

FIG. 19e shows some implementations of alternative JagTag display configurations, including circular 3335, triangular 3340, modified squares (3345, 3350, 3365), rectangular 3370, letter shaped (J shapes shown at 3355 and 3360), and/or the like. JagTags may also be displayed in proximity to and/or integrated with other codes, logos, insignias, and/or the like, such as shown at 3375.

### Ambiguous Codes

In an embodiment, a processor-implemented method is disclosed for processing and responding to ambiguous content requests. A scanned code image and a user ID are received and analyzed to determine if the information encoded therein is fully decodable. A scanned code disambiguation process is selected and applied to the ambiguous scanned code images to determine a most likely code. Accumulated user information in a user profile associated with the user ID is queried. A content database is queried to extract requested content based on the most likely code and the accumulated user information. The requested content is sent to the user.

### Connecting Users

### Forming Groups

In another embodiment, the CTIS is configured to connect users based on user profiles. For example, in analogy to the “provider zone” breaches discussed above, the CTIS may also track the intersection of user space-time trajectories. In particular, if one user is within a specified distance of the projected space-time trajectory of another user with whom the first user is associated, a message may be sent to one or both users notifying them of their potential proximity. Further consideration of user profiles may also be utilized in such notifications.

As previously described and illustrated in FIG. 7b, a user program interface provides a user to access semi-static profile information and add new information or edit existing information. The user may also establish a friends list and regulate which elements of the semi-static and dynamic portions of the user profile may be shared with “friends.”

Alternatively, in embodiments utilizing a high score table, the user may be able to connect with other users listed in the table.

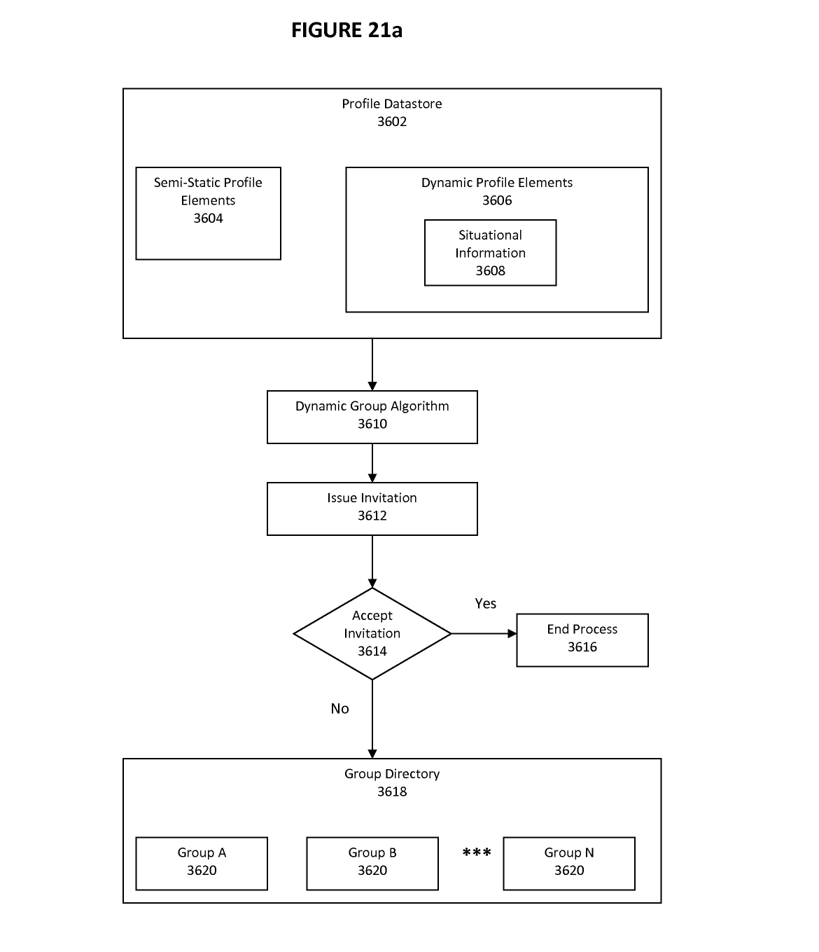

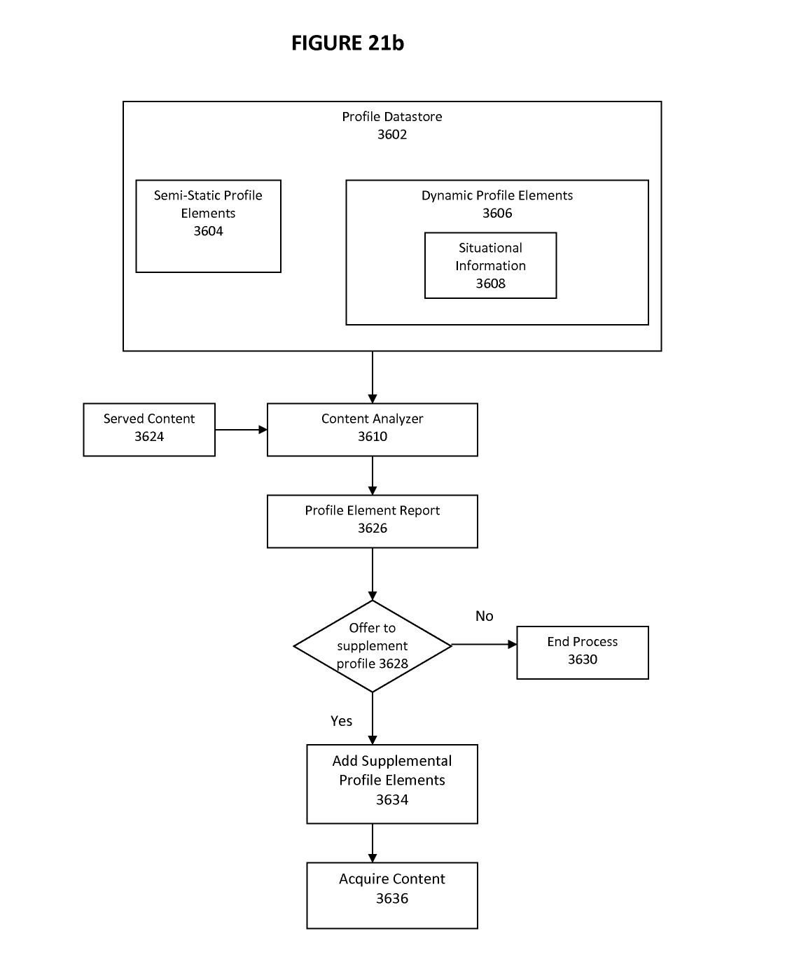

FIG. 21A is a block diagram illustrating a CTIS configured to assign users having similar interests and situational information into dynamic groups according to an embodiment.

In an embodiment, the semi-static elements (Block 3604) and the dynamic elements (Block 3606) in a profile datastore (Block 3602) are accessed by a dynamic group algorithm (Block 3610) operating on a CTIS. The dynamic group algorithm (Block 3610) identifies groups appropriate for a particular user of the CTIS. An invitation to join a group is issued to the particular user. (Block 3612.) A determination is made whether the particular user accepts the invitation to join a particular group. (Block 3614.) If the user declines the invitation, that is, the result of Block 3614 is “NO,” the process ends. (Block 3616). If the user accepts the invitation, that is, the result of Block 3614 is “YES,” the user is assigned to a group and a record is made in a group directory. (Block 3618). By way of illustration and not by way of limitation, a user may accept and invitation to join Group A but not Group B, may join both Group A and Group B, or reject the invitation to join any of the Groups identified by the dynamic group algorithm (Block 3610).

In an embodiment, the logic of Block 3614 is reversed. That is, the user must affirmatively opt-out of the group assignment made by the CTIS.

As illustrated in FIG. 21A, the dynamic group algorithm (Block 3610) evaluates both semi-static elements (Block 3604) and dynamic elements (Block 3606) of a user profile to determine what groups are appropriate for a particular user. The dynamic profile elements (Block 3606) may include situational information (Block 3608). Situation information may include a location of a user and a trajectory of a user. Using this information, the dynamic group algorithm may group users of the CTIS with similar profiles who are in geographic proximity to each. The geographic proximity may be as large as a city and as small as a bar, a trade show, and a concert venue.

Group members typically share core information, such as a user name. In an embodiment, a group member may specify the personal information he or she is will to share with other group members. A group member may also specify which group members it prefers to be “invisible” to. In an embodiment, the sharing of the user name allows the group members to communicate via the CTIS but does not provide direct communication to between group members. Thus, the CTIS operates a communication proxy to allow group member to be restrict communications from particular members of the group or all members of the group.

In an embodiment, the core information for a particular group may be determined by the group's purpose. The group purpose may also be associated with a particular rule set that determines how the core personal information is shared. For example, in group whose purpose is facilitate social interactions, age, religious preferences, music preferences and other personal interest details may be part of the core information. In a group whose purpose is to facilitate business interactions, the core information may be limited to professional information and information relating to products and services.

In another embodiment, the situational information (Block 3608) may identify users the CTIS with similar profiles who are participating in a common virtual world. Users with these attributes may be assigned to a group for that particular virtual world. In this example, the core information may be specific to the virtual world and the particular user's historical interaction with that world.

Users of the CTIS with similar profiles, who are skiing, albeit in different locations, may be assigned to yet another group that utilizes a core information rule set that is specific to skiing. Users at the same ski resort may be assigned to a group specific to that resort. The shared information rule set for this group may include an option that allows members to provide identifying information to facilitate in-person meetings.

The membership of a group may be constantly in flux as the situational information (Block 3608) of the group members changes. In an embodiment, members of a dynamic group may make the group permanent by adding some or all of the members to a friends list associated with a group name.

FIG. 21B is a block diagram illustrating a CTIS configured to identify profile elements that are related to specific content according to an embodiment.

As previously described, users with substantially similar semi-static profile elements (Block 3604) who scan a particular code may receive different content based on differences in their dynamic profile elements.

In an embodiment, a second user who has not received particular content may request the CTIS to compare the profile of the first user with the profile of the second user to determine what factors in the dynamic elements of the first user's profile caused the content to be served to the first user but not the second user. A content analyzer (Block 3622) receives content or a content identifier that was received by a first user of the CTIS. The content analyzer also receives the semi-static profile elements (Block 3604) the dynamic profile elements (Block 3606) of a second user of the CTIS from the profile datastore (Block 3602). The content analyzer (Block 3622) evaluates the served content and the profile data to determine what profile elements could be added to the second user's profile for the second user to receive the served content. The content analyzer generates a profile report. (Block 3626.)

For example, a first user may receive a coupon for a free beverage from a vendor in response to the user passing the vendor's physical location or browsing to the vendor's website. In order to obtain the coupon, the second user may be required to travel to the physical site or navigate to the vendor's website. Note that this process differs from embodiments in which a coupon may be shared in that the second user is compelled to engage the vendor at some level to obtain the coupon. From the vendor's perspective, the value of the coupon is used to incentivize the second user to engage the vendor.

In many cases, the reasons for serving the content to the first user may be more complex than suggested in the example. For example, a coupon may have been served to the first user based on the first user's history of interest in beverages and purchases made from the vendor or establishments similar to the vendor. Even if second user were to visit the physical or virtual location of the vendor, the second user may not meet the requirements for receiving the coupon.

In an embodiment, the CTIS may optionally offer to supplement the second user's profile to include elements that would qualify the second user for the served content. (Block 3628.) If the CTIS does not makes an offer to supplement the second user's profile, that is, if the result of Block 3628 is “NO,” the process ends. (Block 3630). If the CTIS makes an offer to supplement the second user's profile invitation, that is, the result of Block 3630 is “YES,” then a determination is made whether the second user accepts the offer. (Block 3632). If the second user rejects the offer, that is, the result of Block 3632 is “NO,” the process ends. (Block 3630). If the second user accepts the invitation, that is, the result of Block 3632 is “YES,” the second user's profile is assigned supplemental profile elements. (Block 3634). The “supplemental” profile elements may be stored separately from other elements and may be temporary with a defined “time-to-live” or may be permanently stored in association with the user's identifier. The served content is acquired using the supplemental profile elements. (Block 3636.)

In an embodiment, a code or token may be provided to the second user that could be presented by the second user to the physical or virtual location of the vendor that would cause the coupon to be served to the second user without regard to the second user's profile. In an embodiment, the token or code may be provided only with the vendor's consent.

### Product Information

In another embodiment, the CTIS can be used to provide information regarding consumer products that cannot be included on the product packaging. By scanning a code printed on a consumer product package, the user could be provided with nutritional information, ingredients, website links, coupons, etc. Additional advertisements could also be served based on the nature of the product scanned and the user profile. For example, a user who scans a container of mustard and has “grilling” listed among his/her interests may be served an advertisement and/or coupon for hot dogs in addition to the mustard information.

The CTIS provides a targeted information serving system that may be applied to a wide variety of marketing and information dispensation applications. In one embodiment, the CTIS creates enhanced Reply/SMS Message or Ads with content that cannot be included in a print ad. For example, a user who scans a code related to an automobile Reply/SMS Message or Ad is provided additional content pertaining to the automobile such as detailed images, video, audio, reviews, and links to additional information. Based on the geocode provided in the Scan Message, the CTIS may provide a list of local dealerships and pricing. Based on the user profile, the CTIS may suggest other automobiles by the same manufacturer that are popular with customers that share the same income bracket, geographic address, number of children, etc. as the user.

### Reduced Printing

In another embodiment, the CTIS allows for reduced use of printed space in media publications. For example, an ordinary printed article or advertisement may be supplanted by a 2D matrix code that supplies the content directly to the user's mobile display device. Furthermore, the supplied content may be dressed with additional content that is specifically chosen for the user based on his/her profile or current location, thus increasing the value and utility of the content while still utilizing significantly reduced print space. This increased content value, coupled with the reduction in print space, may translate to significantly increase advertising revenue for media publications. In another embodiment, scan codes may be placed in web-based Ads so that users may scan those Ads with their mobile device. In another embodiment, scan codes may be placed in television-based ads.

A method of implementing an interactive mobile advertisement, comprising: receiving a request for an interactive advertisement from a user; providing an interactive advertisement environment to the user, wherein the environment comprises a game-like format; prompting the user to interact with the environment; communicating at least some outcome data related to the user's interaction with the environment to a data repository; and delivering a “reward” to the user, based upon the communicated outcome data. The step of receiving a request for an interactive advertisement further comprises: receiving from a user, via a Scan Message, at least some code scan data; processing the at least some code scan data at a scan data repository; and preparing a particular interactive advertisement environment for presentation to the user, wherein the environment is selected based on the processed code scan data. The step of providing an interactive advertisement environment to a user further comprises: preparing a particular interactive advertisement environment for presentation to the user; and communicating an Environment Message to the user, wherein the Environment Message comprises either a link to the environment or the environment itself. The step of communicating at least some outcome data to a data repository further comprises communicating an Outcome Message from the user to the data repository. The step of delivering a reward to the user further comprises communicating a Rewards Message from the data repository to the user.

What is claimed is:

1. A method of implementing an interactive mobile advertisement, comprising:
Providing an interactive advertisement environment to a user, wherein the interactive advertisement environment has a game-like format;
Prompting the user to interact with the environment; and
Delivering a “reward” to the user based upon an outcome of the user's interaction with the environment.

2. The method of claim 1, wherein the user's interaction with the environment comprises playing a game operable within the environment.

3. The method of claim 2, wherein the game comprises a seek and find type game, wherein the seek and find type game prompts the user to locate a special coupon or promotion within the environment, the coupon or promotion being offered by an advertiser associated with the advertisement.

4. The method of claim 2, further comprising the step of selecting a reward to be delivered to the user based upon the number of levels completed by the user.

5. The method of claim 2, further comprising the step of prompting the user to submit an outcome of the user's playing the game to an information database.

6. The method of claim 5, wherein the information database comprises a high score/outcome table.

7. The method of claim 6, further comprising the step of selecting a second reward to be delivered to the user based upon the relative ranking of the user's outcome in the high score/outcome table within a specified time period.

8. The method of claim 1, wherein the reward comprises at least one of a coupon or promotion; a badge or other signifier that is capable of being shared on a social network; a promotional credit; a gift card; and/or the like.

9. The method of claim 2, further comprising delivering a plurality of rewards to the user, based upon the number of levels completed by the user.

10. The method of claim 2, further comprising the step of utilizing a game emulator to reduce the memory needed for secondary downloads during the user's playing of the game.

11. The method of claim 1, wherein the reward is retrieved from a rewards database.

12. A method of implementing an interactive mobile advertisement, comprising:
Providing an interactive advertisement environment to a user's digital device, wherein the environment comprises a game-like format;
Prompting the user to interact with the environment via the digital device;
Communicating at least some data related to an outcome of the user's interaction with the environment from the digital device to a data repository; and
Delivering a “reward” to the user based upon the communicated outcome data.

13. The method of claim 12, wherein the data repository comprises a code triggered information server database.

14. The method of claim 13, wherein the code triggered information server communicates with a third party provider.

15. The method of claim 12, wherein the communicated outcome data further comprises a user ID, a hardware ID, a geocode, a timestamp, a subject code, a source code, a content code, and/or an environment code.

16. The method of claim 12, wherein the at least some outcome data is communicated to the data repository by SMS protocol, MMS protocol, instant messaging, web browser based messaging, email, Enhanced Messaging System, TCP/IP, WAP, and/or the like.

17. The method of claim 12, wherein the reward comprises at least one of a coupon or promotion; a badge or other signifier that is capable of being shared on a social network; a promotional credit; a gift card; and/or the like.

18. A system for providing interactive mobile advertisements to a user, comprising:
A digital device;
A data repository containing stored interactive mobile advertisement environments for delivery to the digital device
A communication circuit capable of communicating the advertisement environments from the data repository to the digital device; and
A display system capable of displaying information corresponding to the advertisement environments received from the data repository.

19. The system of claim 18, wherein the advertisement environment is communicated from the data repository to the digital device by SMS protocol, MMS protocol, instant messaging, web browser based messaging, email, Enhanced Messaging System, TCP/IP, WAP, and/or the like.

20. The system of claim 18, further comprising a second data repository containing data corresponding to rewards, coupons, promotions, offers, badges, signifiers, and/or the like, associated with specified outcomes of user interactions with the advertisement environments.
